(19) United States
(12) Patent Application Publication
(10) Pub. No.: US 2014/0163900 A1
(43) Pub. Date: Jun. 12, 2014

(54) ANALYZING SHORT TANDEM REPEATS FROM HIGH THROUGHPUT SEQUENCING DATA FOR GENETIC APPLICATIONS

(71) Applicant: Whitehead Institute for Biomedical Research, Cambridge, MA (US)

(72) Inventors: Yaniv Erlich, Cambridge, MA (US); Melissa Gymrek, Cambridge, MA (US)

(73) Assignee: Whitehead Institute for Biomedical Research, Cambridge, MA (US)

(21) Appl. No.: 13/908,938

(22) Filed: Jun. 3, 2013

Related U.S. Application Data
(60) Provisional application No. 61/654,867, filed on Jun. 2, 2012.

(51) Int. Cl. G06F 19/22

(52) U.S. Cl. CPC G06F 19/22
USPC 702/20

(57) ABSTRACT

Provided herein are methods and related compositions using short tandem repeat (STR) regions for genetic applications.

### RELATED APPLICATIONS

This application claims priority the benefit under 35 U.S.C. §119 of U.S. provisional application 61/654,867, filed Jun. 2, 2012, the entire contents of which are herein incorporated by reference.

### FIELD OF INVENTION

Provided herein are methods and related compositions using short tandem repeat (STR) regions for genetic applications.

### BACKGROUND OF INVENTION

Short tandem repeats (STRs), also known as microsatellites, are genetic variations in a genome that may comprise several repetitive elements, typically from two to six nucleotides each. A human genome includes about a quarter million of STR loci. STRs are used for a wide range of genetic applications, including DNA fingerprinting, medical genetics, forensics, and genetic genealogy.

As DNA sequencing techniques, such as high throughput sequencing (HTS) and others, evolve, it becomes feasible to analyze a large number of STR loci from genome sequences. However, existing approaches to computational processing of genome sequences may be inadequate to accurately and efficiently identify an STR region in a genome.

### SUMMARY OF INVENTION

In some embodiments, a method is provided for extracting genomic DNA sequences from a sample obtained or derived from a subject and identifying short tandem repeat (STR) regions in the genomic DNA sequences. The identified STR regions may be used for any suitable applications, such as genetic applications. For example, in some embodiments, the STR regions may be used to associate the sample with one or more characteristics, such as a particular surname. Any other information about the sample or subject from which it is obtained or derived may be identified based on STRs as provided herein. In other embodiments, the method provided herein can be used to identify a subject, such as a human.

In one aspect, embodiments of the invention relate to a method of operating a computing device comprising at least one processor to assign one or more characteristics, such as a surname, to a sample from a subject. In some embodiments, the one or more characteristics identify a subject. The method comprises, with the at least one processor, obtaining a plurality of deoxyribonucleic acid (DNA) sequences from the sample; analyzing the plurality of DNA sequences to identify at least one DNA sequence of the plurality of DNA sequences comprising at least one short tandem repeat (STR) region, the at least one STR region comprising at least two repeat units; determining a length and an identity of a repeat unit of the at least two repeat units of the at least one STR region; determining a length and an identity of the at least one STR region, based on an alignment of at least a portion of the at least one DNA sequence to at least one reference DNA sequence. In some embodiments, the method further comprises determining an allele of the at least one STR region. In some embodiments, the method further comprises comparing the determined allele to a database comprising a plurality of alleles to identify at least one matching allele of the plurality of alleles that matches the determined allele. In other embodiments, the at least one matching allele is associated with information, such as one or more characteristics, relating to a subject, and the method further comprises assigning at least one characteristic to the sample or the subject from which the sample is obtained or derived based on the information relating to the subject associated with the at least one matching allele.

In another aspect, embodiments of the invention relate to at least one computer-readable medium storing computer-executable instructions that, when executed by at least one processor, perform a method of identifying short tandem repeat (STR) regions, for example, in a genome from a sample, and assigning characteristics to the sample or subject from which the sample is obtained or derived based on the identification. In some embodiments, the method comprises: obtaining a plurality of deoxyribonucleic acid (DNA) sequences from the sample from a subject; analyzing the plurality of DNA sequences to identify at least one DNA sequence of the plurality of DNA sequences comprising at least one short tandem repeat (STR) region, the at least one STR region comprising at least two repeat units; determining a length and an identity of a repeat unit of the at least two repeat units of the at least one STR region; determining a length and an identity of the at least one STR region, based on an alignment of at least a portion of the at least one DNA sequence to at least one reference DNA sequence. In some embodiments, the method further comprises determining an allele of the at least one STR region. In some embodiments, the method further comprises comparing the determined allele to a database comprising a plurality of alleles to identify at least one matching allele of the plurality of alleles that matches the determined allele. In other embodiments, the at least one matching allele is associated with information, such as one or more characteristics, relating to a subject, and the method further comprises assigning at least one characteristic to the sample or the subject from which the sample is obtained or derived based on the information relating to the subject associated with the at least one matching allele.

In another aspect, embodiments of the invention relate to a system comprising: at least one storage medium storing computer-executable instructions for performing, when executed by at least one processor, a method for recovering characteristics of a sample from a subject based on identification of short tandem repeat (STR) regions; and at least one processor configured to execute the computer-executable instructions to perform a method provided herein. In some embodiments, the method comprises, obtaining a plurality of deoxyribonucleic acid (DNA) sequences from the sample from a subject; analyzing the plurality of DNA sequences to identify at least one DNA sequence of the plurality of DNA sequences comprising at least one short tandem repeat (STR) region, the at least one STR region comprising at least two repeat units; determining a length and an identity of a repeat unit of the at least two repeat units of the at least one STR region; determining a length and an identity of the at least one STR region, based on an alignment of at least a portion of the at least one DNA sequence to at least one reference DNA sequence. In some embodiments, the at least one processor is configured to execute the computer-executable instructions to perform the method further comprising determining an allele of the at least one STR region. In some embodiments, the at least one processor is configured to execute the computer-executable instructions to perform the method further comprising comparing the determined allele to a database comprising a plurality of alleles to identify at least one matching allele of the plurality of alleles that matches the determined allele. In other embodiments, the at least one matching allele is associated with information relating to a subject, such as one or more characteristics, and the at least one processor is configured to execute the computer-executable instructions to perform the method comprising assigning at least one characteristic to the sample or the subject from which the sample is obtained or derived based on the information, such as one or more characteristics, relating to a subject associated with the at least one matching allele.

In another aspect, embodiments of the invention relate to a method of operating a computing device comprising at least one processor to assign one or more characteristics, such as a surname, to a sample from a subject. The method comprises, with the at least one processor, sequencing a plurality of nucleic acids extracted from the sample to obtain a plurality of deoxyribonucleic acid (DNA) sequences; analyzing the plurality of DNA sequences to identify at least one DNA sequence of the plurality of DNA sequences comprising at least one short tandem repeat (STR) region, the at least one STR region comprising at least two repeat units; determining a length and an identity of a repeat unit of the at least two repeat units of the at least one STR region; determining a length and an identity of the at least one STR region, based on an alignment of at least a portion of the at least one DNA sequence to at least one reference DNA sequence. In some embodiments, the method further comprises determining an allele of the at least one STR region. In some embodiments, the method further comprises comparing the determined allele to a database comprising a plurality of alleles to identify at least one matching allele of the plurality of alleles that matches the determined allele. In other embodiments, the at least one matching allele is associated with information, such as one or more characteristics, relating to a subject, and the method further comprises assigning at least one characteristic to the sample or the subject from which the sample is obtained or derived based on the information relating to a subject associated with the at least one matching allele.

In another aspect, embodiments of the invention relate to a system for identifying short tandem repeat (STR) regions in a genome. The system may comprise a computing device comprising at least one processor and memory storing computer-executable instructions that, when executed by the at least one processor, perform a method comprising: obtaining a plurality of deoxyribonucleic acid (DNA) sequences from a sample from subject; analyzing the plurality of DNA sequences to identify at least one DNA sequence of the plurality of DNA sequences comprising at least one short tandem repeat (STR) region, the at least one STR region comprising at least two repeat units; determining a length and an identity of a repeat unit of the at least two repeat units of the at least one STR region; determining a length and an identity of the at least one STR region, based on an alignment of at least a portion of the at least one DNA sequence to at least one reference DNA sequence. In some embodiments, the computer-executable instructions, when executed by the at least one processor, perform the method further comprising determining an allele of the at least one STR region. In some embodiments, the computer-executable instructions, when executed by the at least one processor, perform the method further comprising comparing the determined allele to a database comprising a plurality of alleles to identify at least one matching allele of the plurality of alleles that matches the determined allele. In other embodiments, the at least one matching allele is associated with information, such as one or more characteristics, relating to a subject, the computer-executable instructions, when executed by the at least one processor, perform the method further comprising assigning at least one characteristic to the sample or the subject from which the sample is obtained or derived based on the information relating to a subject associated with the at least one matching allele.

In one aspect, embodiments of the invention relate to a device for identifying short tandem repeat (STR) regions in a genome. The device may comprise at least one processor; and memory for storing computer-executable instructions that, when executed by the at least one processor, perform any of the methods described herein. In some embodiments, the method comprises: receiving a plurality of deoxyribonucleic acid (DNA) sequences from a sample from subject; analyzing the plurality of DNA sequences to identify at least one short tandem repeat (STR) region of an allele; and assigning at least one characteristic to the sample or the subject from which the sample is obtained or derived based on the allele of the at least one identified STR region.

In the device, analyzing the plurality of DNA sequences may comprise identifying at least one DNA sequence of the plurality of DNA sequences comprising the at least one STR region, the at least one STR region comprising at least two repeat units; determining a length and an identity of a repeat unit of the at least two repeat units of the at least one STR region; determining a length and an identity of the at least one STR region, based on an alignment of at least a portion of the at least one DNA sequence to at least one reference DNA sequence. In some embodiments, analyzing the plurality of DNA sequences may further comprise determining the allele of the at least one STR region. In some embodiments, analyzing the plurality of DNA sequences may further comprise comparing the determined allele to a database comprising a plurality of alleles to identify at least one matching allele of the plurality of alleles that matches the determined allele. In other embodiments, the at least one matching allele is associated with information, such as one or more characteristics, relating to a subject, and analyzing the plurality of DNA sequences may further comprise assigning the at least one characteristic to the sample or the subject from which the sample is obtained or derived based on the information relating to a subject associated with the at least one matching allele.

In some embodiments of any of the foregoing or following, the device may be a handheld device.

In some embodiments of any of the foregoing or following, the plurality of DNA sequences are obtained from the sample using high throughout sequencing.

In other embodiments of any of the foregoing or following, the plurality of DNA sequences are obtained from the sample using hybrid capture sequencing.

In further embodiments of any of the foregoing or following, the plurality of DNA sequences are obtained from the sample using polymerase chain reaction (PCR)-free sequencing.

In some embodiments, any of the methods provided further comprises sequencing a plurality of nucleic acids extracted from the sample to obtain the plurality of DNA sequences. The sequencing the plurality of nucleic acids may be performed using high throughout sequencing, hybrid capture sequencing or polymerase chain reaction (PCR)-free sequencing.

In some embodiments, any of the devices provided may be configured to communicate with at least one second device, such as to transmit to the at least one second device one or more DNA sequences, or other information, wherein the at least one second device may be configured to, by at least one processor, identify at least one DNA sequence of the one or more DNA sequences comprising at least one STR region, the at least one STR region comprising at least two repeat units; determine a length and an identity of a repeat unit of the at least two repeat units of the at least one STR region; determine a length and an identity of the at least one STR region, based on an alignment of at least a portion of the at least one DNA sequence to at least one reference DNA sequence. In some embodiments, the at least one second device may be further configured to, by at least one processor, determine the allele of the at least one STR region. In some embodiments, the at least one second device may be further configured to, by at least one processor, compare the determined allele to a database comprising a plurality of alleles to identify at least one matching allele of the plurality of alleles that matches the determined allele. In other embodiments, wherein the at least one matching allele is associated with information, such as one or more characteristics, relating to a subject, and the at least one second device may be further configured to, by at least one processor, provide information relating to the subject to the device or other device or processor.

In some embodiments, any of the devices provided is configured to communicate with at least one second device over a communication medium. The communication medium may comprise a network.

In one aspect, embodiments of the invention relate to a device for identifying short tandem repeat (STR) regions in a genome, the device comprising at least one first processor configured to control at least one component to sequence a plurality of nucleic acids extracted from a sample from a subject to obtain a plurality of deoxyribonucleic acid (DNA) sequences; and provide the plurality of DNA sequences to at least one second processor. The device may also comprise the at least one second processor configured to receive the plurality of DNA sequences; analyze the plurality of DNA sequences to identify at least one DNA sequence of the plurality of DNA sequences comprising at least one STR region, the at least one STR region comprising at least two repeat units; determine a length and an identity of a repeat unit of the at least two repeat units of the at least one STR region; determine a length and an identity of the at least one STR region, based on an alignment of at least a portion of the at least one DNA sequence to at least one reference DNA sequence. In some embodiments, the at least one second processor may be further configured to determine an allele of the at least one STR region. In some embodiments, the at least one second processor may be further configured to compare the determined allele to a database comprising a plurality of alleles to identify at least one matching allele of the plurality of alleles that matches the determined allele. In other embodiments, the at least one matching allele is associated with information, such as one or more characteristics, relating to the subject, and the at least one second processor may be further configured to assign at least one characteristic to the sample or the subject from which the sample is obtained or derived based on the information relating to the subject associated with the at least one matching allele.

In some embodiments of any of the foregoing or following, the at least one first processor may be configured to control the at least one component to sequence the plurality of nucleic acids using high throughout sequencing.

In some embodiments of any of the foregoing or following, the at least one first processor may be configured to control the at least one component to sequence the plurality of nucleic acids using hybrid capture sequencing.

In some embodiments of any of the foregoing or following, the at least one first processor may be configured to control the at least one component to sequence the plurality of nucleic acids using polymerase chain reaction (PCR)-free sequencing.

In some embodiments of any of the foregoing or following, the at least one first processor may be configured to provide the plurality of DNA sequences to the at least one second processor over a communication medium. The communication medium may comprise a network.

In any of the methods, computer-readable media, systems or devices in some embodiments, the information relating to the subject associated with the at least one matching allele comprises a surname; and assigning the at least one characteristic to the sample comprises assigning a surname to the sample based on the surname associated with the at least one matching allele. In some embodiments of any of the foregoing or following, the at least one characteristic comprises assigning a surname and some other characteristic to the sample. In any of the methods, computer-readable media, systems or devices in some embodiments, assigning the at least one characteristic to the sample identifies the subject from which the sample is obtained or derived.

In some embodiments of any of the foregoing or following, the information relating to the subject or at least one other characteristic comprises a first name, a surname, geographical location, age, gender, a risk of developing a disease or disorder, or an actual occurrence of a disease or disorder, or some combination thereof.

In some embodiments, in any of the methods, computer-readable media, systems or devices as described herein, the analyzing of the plurality of DNA sequences comprises dividing each DNA sequence of the plurality of DNA sequences into a plurality of overlapping sequences; determining an entropy value for each of the plurality of overlapping sequences; and identifying the at least one DNA sequence from the plurality of DNA sequences that comprises the at least one STR region based on entropy values of the plurality of overlapping sequences.

In some embodiments of any of the foregoing or following, the entropy value for each of the plurality of overlapping sequences may be determined according to a formula:

$$E ( {S}_{j} ) = - {\sum }_{i ∈ Σ} {f}_{i} {log}_{2} {f}_{i} ,$$

wherein E comprises the entropy value, Sⱼ comprises a j^{th} sequence of the plurality of overlapping sequences, Σ comprises an alphabet, i comprises a symbol in the alphabet, and fᵢ comprises a frequency of the symbol i. The alphabet may comprise a plurality of nucleotide sequences each comprising at least two nucleotides selected from an adenine, guanine, cytosine and thymine.

In any of the methods, computer-readable media, systems or devices, dividing each DNA sequence of the plurality of DNA sequences into the plurality of overlapping sequences comprises receiving input indicating a length of each sequence of the plurality of overlapping sequences and a length of an overlap between each two consecutive sequences of the plurality of overlapping sequences.

In some embodiments of any of the foregoing or following, analyzing of the plurality of DNA sequences to identify the at least one DNA sequence comprising the at least one STR region comprises identifying at least one sequence of the plurality of overlapping sequences that is flanked by an upstream sequence and by a downstream sequence, wherein the at least one sequence has a corresponding entropy value that is below a threshold, and each of the upstream sequence an the downstream sequence has a corresponding entropy value that is above the threshold.

In some embodiments, in any of the methods, computer-readable media, systems or devices, determining the length of the repeat unit of the at least two repeat units of the at least one STR region comprises representing the at least one STR region as a binary matrix; applying a Fourier transform along columns of the binary matrix, each representing an occurrence of a type of a nucleotide in the at least one STR region, to generate a plurality of frequency bins, the type of the nucleotide being selected from the group consisting of adenine, cytosine, guanine and thymine; analyzing the plurality of frequency bins to identify a frequency bin from the plurality of frequency bins having a signal strength above a threshold, the identified frequency bin corresponding to a repeat unit length; and determining the length of the repeat unit based on the identified frequency bin.

In some embodiments of any of the foregoing or following, determining the identity of the repeat unit of the at least two repeat units of the at least one STR region comprises determining a nucleotide sequence of the repeat unit by determining a frequency of occurrence of each of a plurality of repeat units of the length in the at least one STR region.

In some embodiments of any of the foregoing or following, determining the nucleotide sequence of the repeat unit comprises applying a rolling hash function to identify the plurality of repeat units of the length in the at least one STR region; and determining the nucleotide sequence as a nucleotide sequence of a repeat unit of the plurality of repeat units characterized by a frequency of occurrence that is above a frequency of occurrence of each of the other repeat units of the plurality of repeat units. Each of the at least two repeat units comprises at least two nucleotides.

In some embodiments of any of the foregoing or following, the alignment of at least a portion of the at least one DNA sequence to the at least one reference DNA sequence comprises alignment of upstream and/or downstream regions flanking the at least one STR region to the at least one reference DNA sequence.

In some embodiments of any of the foregoing or following, determining the length and the identity of the at least one STR region comprises aligning the upstream sequence to the at least one reference DNA sequence to identify a first matching sequence in the at least one reference DNA sequence; aligning the downstream sequence to the at least one reference DNA sequence to identify a second matching sequence in the at least one reference DNA sequence; and determining the length and the identity of the at least one STR region based at least on positions in the at least one DNA reference sequence of the first matching sequence and the second matching sequence.

In some embodiments, in any of the methods, computer-readable media, systems or devices, the at least one reference DNA sequence comprises a second STR region formed by at least two repeat units characterized by the same length and identity as the length and identity of the repeat unit of the at least two repeat units of the at least one STR region. The second STR region may be flanked by respective upstream and/or downstream sequences.

In some embodiments of any of the foregoing or following, the alignment of at least a portion of the at least one DNA sequence to the at least one reference DNA sequence comprises alignment of an upstream region flanking the at least one STR region and/or a downstream region flanking the at least one STR region to the at least one reference DNA sequence.

In some embodiments of any of the foregoing or following, the plurality of alleles may be stored in at least one database. In some embodiments of any of the foregoing or following, the at least one database may comprise a Y-chromosome database. In other embodiments of any of the foregoing or following, the at least one database may comprise an autosomal database. The method described herein may comprise accessing the at least one database over a network to access the plurality of alleles.

In some embodiments of any of the foregoing or following, determining the allele of the at least one STR region comprises for each repeat unit of a plurality of repeat units each having a corresponding length, determining a likelihood of identifying the repeat unit of a length given stutter noise.

In some embodiments of any of the foregoing or following, determining the allele of the at least one STR region may comprise identifying a chromosome including the at least one STR region, and a start and an end of the at least one STR region.

In some embodiments of any of the foregoing or following, the allele of the at least one STR region may be determined in accordance with a formula:

log P(\vec{R}|A,B,k)=Σ_{Lε\vec{R}}(L|A,B,k),

wherein \vec{R} comprises a plurality of lengths of a plurality of STR regions of the at least one STR region, A comprises a first length of the plurality of lengths, B comprises a second length of the plurality of lengths, k comprises a repeat unit length of a plurality of repeat unit lengths, and L comprises a length of an STR region.

In some embodiments of any of the foregoing or following, determining the allele of the at least one STR region comprises determining a likelihood of observing each of a plurality of alleles of the at least one STR region given noise; and identifying the allele of the at least one STR region as an allele of the plurality of alleles that is characterized by a likelihood that is higher than a likelihood of other alleles of the plurality of alleles.

In some embodiments of any of the foregoing or following, the plurality of DNA sequences are obtained from the sample using high throughout sequencing.

In some embodiments of any of the foregoing or following, the plurality of DNA sequences are obtained from the sample using hybrid capture sequencing.

In some embodiments of any of the foregoing or following, the plurality of DNA sequences are obtained from the sample using polymerase chain reaction (PCR)-free sequencing.

In some embodiments of any of the foregoing or following, the plurality of DNA sequences are obtained using a portable handheld sequencing device.

In some embodiments of any of the foregoing or following, the sample may be obtained or derived from a subject. The method may comprise obtaining the sample from the subject. In some embodiments of any of the foregoing or following, the subject is a human.

In some embodiments of any of the foregoing or following, the sample may be collected without the presence of the subject. The methods may comprise collecting the sample without the presence of the subject.

In some embodiments of any of the foregoing or following, the sample may be collected within the presence of the subject. The method may comprise collecting the sample within the presence of the subject.

In some embodiments of any of the foregoing or following, the at least one matching allele is associated with additional information, such as one or more characteristics; and the sample or a subject from which the sample is obtained or derived may be associated with the additional information. The method may comprise associating the sample or a subject from which the sample is obtained or derived with the additional information.

In some embodiments of any of the foregoing or following, the additional information comprises a geographical location, age or gender.

In some embodiments of any of the foregoing or following, the additional information comprises information on a risk of developing a disease or disorder. In some embodiments of any of the foregoing or following, the information on a risk of developing a disease or disorder is used to provide a therapy to the subject or information regarding a therapy to the subject. The methods provided herein may include the step of providing a therapy to the subject or information regarding a therapy to the subject.

In some embodiments of any of the foregoing or following, the at least one matching allele is identified to more accurately and unambiguously assign the at least one characteristic to the sample or a subject from which the sample is obtained or derived based on the information relating to the subject associated with the at least one matching allele.

In some embodiments of any of the foregoing or following, the at least one matching allele is identified to more accurately and unambiguously assign the at least one characteristic to the sample or a subject from which the sample is obtained or derived based on a probability that the determined allele(s) and the at least one matching allele share a recent common ancestor.

In some embodiments of any of the foregoing or following, the recent common ancestor comprises a most recent common ancestor, and the at least one matching allele is identified to more accurately and unambiguously assign the at least one characteristic to the sample by determining a time to the most recent common ancestor of the at least one matching allele and the determined allele.

In some embodiments of any of the foregoing or following, the at least one matching allele is identified to more accurately and unambiguously assign the at least one characteristic to the sample or a subject from which the sample is obtained or derived based on matching at least 2, 3, 4, 5, 6, 7, 8, 9, 10, 12, 15, 20, 25, 30, 35, 40, 45, 50, etc. of the determined allele(s).

In some embodiments of any of the foregoing or following, the determined allele of the at least one STR region in the DNA obtained from the sample or the subject from which the sample is obtained or derived may comprise a set of alleles, such as a haplotype. The haplotype determined using the described techniques may be used to query one or more databases comprising a plurality of sets of alleles (e.g., haplotypes) to identify at least one matching haplotype that matches the determined haplotype. The matching haplotype may be associated with information relating to the sample or the subject, such as one or more characteristics. At least one characteristic may be assigned to the sample or the subject from which the sample is obtained or derived based on the information associated with the matching haplotype. In some embodiments, the information may comprise a surname.

In some embodiments, each determined haplotype, which is referred to herein as a target haplotype, may be used to query one or more databases storing haplotypes to retrieve one or more matching haplotypes as a result of a database search. The database search may be based on determining a time to the most recent common ancestor (TMRCA) of the target haplotype and haplotypes in the database. Thus, one or more matching haplotypes with the shortest TMRCA with the target haplotype may be retrieved based on the database search.

Further, in some embodiments of any of the foregoing or following methods, a confidence score may be calculated. In some embodiments, the confidence score is retrieved for each matching haplotype to determine whether the matching haplotype is a significantly better match to the target haplotype than other matches and may thus be used to assign at least one characteristic to the target haplotype. In some embodiments, the confidence score may represent a probability that the TMRCA of the matching haplotype and target haplotype is shorter than another matching haplotype with a distinct characteristic (e.g., a surname) that has the second to shortest TMRCA and a random subject in a population. The random subject may be, for example, a random person in the U.S. population.

In some embodiments, a calculated confidence score, such as for each matching haplotype, may be compared to a confidence threshold. Any of the foregoing or following methods may also include a step of comparing a confidence score to a confidence threshold. For example, if a confidence score calculated for a matching haplotype is greater than the threshold, it may be determined that the matching haplotype is correctly identified as a haplotype with the shortest TMRCA with the target haplotype such that one or more characteristics, such as a surname, associated with the matching haplotype may be used to assign at least one characteristic to the target haplotype. In some embodiments, a surname associated with the matching haplotype having a confidence score greater than the confidence threshold may be assigned to the target haplotype thereby identifying the sample or the subject from which the sample is obtained.

In some embodiments, if a confidence score calculated for a matching haplotype is equal to or less than the confidence threshold, it may be determined that the matching haplotype is not a good match to the target haplotype and no characteristic can be assigned to the target haplotype based on the matching haplotype.

In some embodiments of any of the foregoing or following, the confidence threshold may be a user-defined threshold. Further, in some embodiments, a probability of successful identification of the sample or the subject from which the sample is obtained based on a determined haplotype may depend on a value of the confidence threshold.

In some embodiments, the methods, computer-readable media, systems or devices are any of the methods, computer-readable media, systems or devices described herein including those in the Examples and Figures.

### BRIEF DESCRIPTION OF DRAWINGS

FIG. 1A is a flowchart illustrating a method of identification of one or more STR regions in a plurality of DNA sequences obtained from a sample obtained from an individual, in accordance with some embodiments.

FIGS. 1B-D illustrate alignment of a DNA sequence comprising an STR region to a reference DNA sequence, in accordance with some embodiments.

FIG. 2 illustrates an overview of the lobSTR algorithm which includes a sensing, alignment and allelotyping steps (SEQ ID NO: 2). The sensing step detects informative STR reads and determines their repeat motif. The alignment step maps the STRs' flanking regions to the reference. The allelotyping step determines the STR alleles present at each locus.

FIG. 3 illustrates that lobSTR may provide an added value for STR profiling over mainstream techniques regarding: (A) Alignment speed (reads per second) of lobSTR, mainstream alignment and BLAT. lobSTR processes reads between 2.5 and 1000 times faster than alternative methods; (B) The sensitivity of detecting STR variations of different alignment strategies. Only BLAT detected more STR variations than lobSTR; and (C) lobSTR accurately detects pathogenic trinucleotide expansions that are discarded by mainstream aligners. The figure shows simulation results of the HOXD13 heterozygous locus with a normal and a pathogenic allele that contains 7 additional alanine insertions. BWA reports only the normal allele (SEQ ID NOs:3-43). Reads exhibiting a pathogenic STR expansion are not detected. lobSTR identifies both alleles present at the simulated locus (SEQ ID NOs:44-69). All positions are according to hg18.

FIG. 4 illustrates results of measuring lobSTR consistency from two samples of the same individual (A-C) (green-period 2, orange-period 3, red-period 4, blue-period 5, purple-period 6, black-all). (A) Loci covered in both samples at increasing coverage thresholds; (B) The genotype discordance rate as a function of coverage threshold; (C) The allelic discordance rate as a function of coverage threshold; and (D) Number of repeat differences at heterozygous loci: (0)—no difference; (1-8)—integer numbers of repeat differences; the rest—non-integer numbers of repeat differences. Most discordance calls consist of a single repeat unit difference between calls in the two samples. Distance was measured as the second minimum distance between alleles of the two samples. The y-axis is given in a square root scale.

FIG. 5 illustrates results of validating lobSTR by Mendelian inheritance in a HapMap trio. Mendelian inheritance (blue) rose to 99% above 17× coverage. The number of covered loci at each coverage threshold is shown in red. (A) Mendelian inheritance of all covered loci. (B) Mendelian inheritance of loci with discordant parental allelotypes.

FIG. 6 depicts a genome-wide STR profile of an individual. (A) Distribution of STRs with 20× coverage or more as a function of the allele size in hg18. (B) Distribution of allele size differences from reference in lobSTR calls. The average difference was 6.3 bp away from the reference. (C) STR polymorphism as function of period. The number of STR alleles matching the reference sequence increases with increasing repeat unit length (the colors in the entire panel are as follows: red—homozygous reference, blue—heterozygous non-reference/reference, green—homozygous non-reference/non-reference, orange—heterozygous non-reference/non-reference (D) Longer STR regions are more polymorphic. The median STR length (thick black line) increases with the number of variant alleles. * denotes a significant (p<0.05) difference according to a one-sided Mann-Whitney test. Boxes denote the interquartile range and whiskers denote 3 times the interquartile range. (E) lobSTR shows mutational trends at single base pair resolution. The number of base pairs difference from reference modulo the period size versus the number of alleles detected (in logarithmic scale) is shown for each period (green-period 2, orange-period 3, red-period 4, blue-period 5, purple-period 6). Incomplete STR unit differences tend to differ by a full unit +/−1 bp from the reference. (F) Fraction of trinucleotide STRs with non-reference alleles in introns versus exons. 95% confidence intervals are given by the error bars.

FIG. 7 depicts results of an analysis of feasibility of STR profiling with High Throughput Sequencing (HTS). (A) Shows SEQ ID NOs: 70-75. Long paired-end reads are not a sufficient condition for STR profiling. Each read end (gray box) only partially covers the STR locus (top). Although the ends overlap and together span the entire locus, the number of repeat units is ambiguous (middle), since the exact overlap length is unknown. Single-ends that span the entire STR are informative (bottom). The single-end read (gray box) encompasses the flanking regions outside the STR locus (blue lines). These allow the read to be anchored to obtain unambiguous information about the STR length. (B) Shows SEQ ID NOs: 76-77. Modest STR polymorphisms translate to large indels. Thus, detecting non-reference STR reads requires cumbersome processing times by mainstream aligners. (C) Shows SEQ ID NOs: 78-80. An example of stutter noise due to PCR slippage events. A series of sequence reads were obtained from the same allele. The last two reads have additional repeats due to PCR slippage events. This can confound a naïve STR calling strategy to report that the locus is heterozygous.

FIG. 8 depicts detection of DNA sequences containing STR. (A) Entropy scores discriminate between STR sequences and random genomic sequences. The receiver operating curve of the rate of STRs passing the threshold (sensitivity) versus the rate of random genomic sequences passing the threshold (1-specificity). The dinucleotide entropy (green) shows nearly perfect classification and outperforms the mononucleotide entropy (orange). The numbers on the curves denote the corresponding entropy threshold (B) Informative reads have a unique signature in entropy analysis. The dinucleotide entropy score is presented for sliding windows along the STR-containing sequence. The flanking regions (yellow) have a high entropy score, whereas the STR-containing region (pink) exhibits a low score. The dashed line depicts lobSTR's default entropy threshold (C) STR periods create distinct signals in the frequency domain. The normalized spectral response of STR repeats is characterized by distinct harmonics corresponding to the repeat unit size (blue-5mer, green-4mer, red-3mer, gray—random noise) (D) Spectral analysis determines the repeat unit length. The period whose first harmonic shows the maximum energy is chosen as the repeat length. The example displays the normalized energies of periods 2 through 6 of a dinucleotide STR.

FIG. 9 illustrates the allelotyping step of the described algorithm that models the likelihood of PCR stutter noise. (A) Stutter noise as a function of STR period. The probability of PCR stutter noise decreases with period length. Stutter noise (blue) was measured as the percentage of reads from a male sample aligned to sex chromosomes that did not exhibit the mode number of repeat units. For example, a logistic regression (red) may be fitted to model noise based on STR period. (B) Probability of PCR stutter noise as a function of STR number. There is no strong association between the STR region length and the stutter noise.

FIG. 10 depicts evaluation of the lobSTR sensing step versus Tandem Repeat Finder (TRF). (A) lobSTR senses reads 50 times faster than TRF. (B) lobSTR motif detection agrees with Tandem Repeat Finder. In reads where both lobSTR and TRF detect an STR, a comparison of the most represented motifs is shown. Each column is normalized to sum to one, so that values are given in the percentage of instances of a motif detected by lobSTR that were detected as a given motif in TRF. (orange=period 2, green=period 3, blue=period 4, red=period 5, purple=period 6). Overall, lobSTR and TRF agreed in 94% of the calls (C) lobSTR flagging rate for reads that were flagged by TRF as a function of STR purity. lobSTR flags about 75% of the reads that were detected from noisy STRs and 85% of the reads from pure STRs.

FIG. 11 illustrates an exemplary range of STR lengths that lobSTR may process. lobSTR can detect STRs with minimal repeat units. lobSTR can detect STR regions spanning as few as 12 base pairs.

FIG. 12 illustrates an example of coverage requirements for STR allelotyping. The number of STR loci at various STR coverage levels (blue—3×, red—5×, green—10×, purple—15×, orange—20×) is shown as a function of autosomal genomic coverage. Various coverage levels were simulated by sampling from the aligned reads file of the 126× genome under the assumption that number of aligned STR reads is approximately proportional to genome-wide coverage.

FIG. 13 illustrates an example of length distribution of STRs. Most periods have a median STR repeat length (thick black line) of around 40 bp. The repeat region total length and length variance increase slightly with increasing repeat period.

FIG. 14 illustrates that searching with Craig Venter's Y-chromosome haplotype in genealogical databases returns the surname ‘Venter’ as the top hit.

FIGS. 15A and 15B illustrate ancestral origins of Venter records in the Ysearch database. The ancestral origin of the top match is labeled with an arrow.

FIG. 16 illustrates TMRCA profiles of haplotype queries. Records that matched exactly the input surname (left) showed a geometric-like distribution. For most records with a minute spelling variant from the original surname (center), the MRCA was 10-15 generations ago. Wrong matches (right) mainly showed an ancient MRCA.

FIG. 17 shows expected performance of surname recovery. The probability of successful recovery (closed bars) and wrong recovery (open bars) is shown at different surname confidence thresholds. The star indicates a middle-range performance threshold 6=0.82.

FIG. 18 illustrates performance of surname recovery at different confidence thresholds. (A) A rate of successful recovery with exact matches (dark shading, top) and spelling variants (lighter shading, top) versus the wrong recovery rate (bottom) as a function of confidence threshold level. (B) A ratio of successful recoveries to wrong recoveries.

FIG. 19 provides a table of results.

### DETAILED DESCRIPTION OF INVENTION

The inventors have recognized and appreciated that performance of multiple applications utilizing short tandem repeats (STRs) may be improved if a method that allows an accurate and rapid STR profiling from a plurality of DNA sequences is provided. Accordingly, the inventors have developed a method of identifying one or more STR regions in DNA sequences. The identified STR regions may be used for any suitable applications, including genetic testing (e.g., carrier screening), DNA fingerprinting, forensics, genetic anthropology, newborn screening and other applications. Genotyping involves determining differences in a genetic make-up (genotype) of an individual by examining the individual's DNA sequence and comparing it to another individual's sequence or a reference sequence. It may reveal alleles that an individual has inherited from his or her parents.

Thus, an allelotype of an STR region may be determined and may then be used for identification of a biological sample, or subject from which it is obtained or derived, by associating the sample with one or more characteristics, such as a surname, which may be utilized in forensics and other applications. In some embodiments, STR regions identified in genomic DNA sequences extracted from a sample obtained or derived from a subject may be used to recover one or more characteristics of the subject.

Some embodiments described herein provide a method of assigning a surname to a sample obtained or derived from an individual by extracting DNA sequences from the sample, analyzing the DNA sequences to identify one or more STR regions and determining an allele of each of the STR regions. The surname may be assigned to the sample based on the determined allele of the STR region. It should be appreciated that assigning a surname to a sample obtained from an individual is only one example of an application of the STR identification method described herein, as the method may be utilized for other genetic applications.

Genomic DNA sequences may be obtained using various DNA sequencing techniques, which may be based on a polymerase chain reaction (PCR) or may involve other approaches. For example, high throughput sequencing and other DNA sequencing techniques that involve using PCR primers for amplifying STR regions may be utilized. Furthermore, techniques that allow performing DNA sequencing without PCR may be used to obtain genomic DNA sequences from a biological sample. An example of such a sequencing technique includes IIlumina® sequencing-by-synthesis platform developed by Illumina (San Diego, Calif.) This technology supports massively parallel sequencing using a reversible terminator-based method that enables detection of single bases as they are incorporated into growing DNA strands.

In some embodiments, sequencing may be performed using the SOLiD™ system (Applied Biosystems Corp.), pyrosequencing (e.g., a pyrosequencing platform by 454 Life Sciences, subsidiary of Roche Diagnostics), a sequencing technique that is based on semiconductor detectors (e.g., the Ion Torrent® platform), nanopore sequencing (e.g., the Oxford Nanopore sequencing platform), sequencing by hybridization and any other suitable technology.

In some embodiments, genomic DNA sequences may be obtained using hybrid capture technology that allows specific genomic regions to be enriched for downstream sequencing. This technique has been used for focused analysis of a plurality of genomic regions, such as exonic regions. However, in some embodiments, the hybrid capture technology may be applied for obtaining DNA sequences that are then used for STR identification in other regions such as introns or intergenic regions. Any suitable type of the hybrid capture approach may be utilized, such as, for example, in-solution hybrid capture, hybrid capture based on a custom designed array (also known as solid capture), or any other suitable type of hybrid capture.

It should be appreciated that embodiments of the invention are not limited to any particular high-throughput sequencing techniques used to obtain DNA sequences from a sample obtained from an individual, and any suitable techniques may be utilized, as known in the art or developed in the future. The DNA sequencing techniques may be implemented using any suitable sequencing platform.

A set of genomic DNA sequences obtained using a suitable sequencing platform comprises multiple sequences which may be referred to as “reads.” A read may be any fragment of a genomic DNA of the individual generated by DNA sequencing. The genomic DNA sequences may be whole genomic DNA sequences or may comprise any portion of a genome of an individual. For example, in some embodiments, the genomic DNA sequences may comprise Y-chromosomal DNA sequences. In other embodiments, the genomic DNA sequences may comprise autosomal DNA sequences. However, it should be appreciated that embodiments of the invention are not limited to any specific portion of a genome, and the analyzed DNA sequences may comprise any suitable sequences.

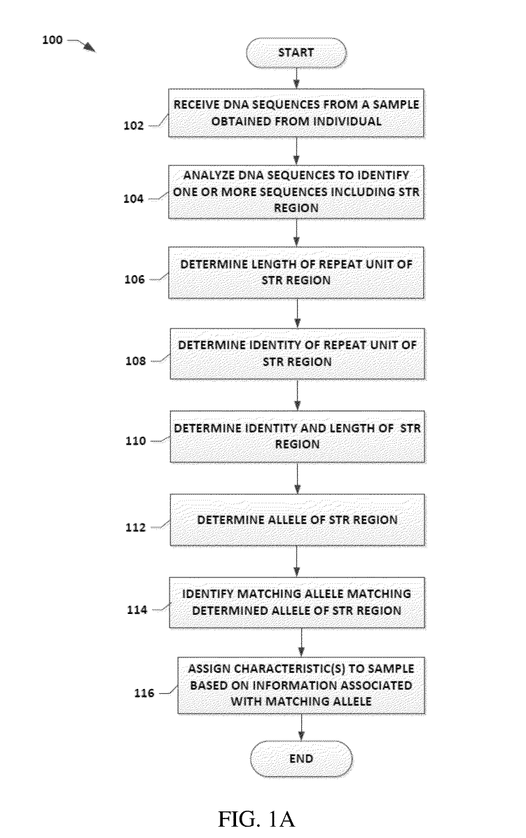

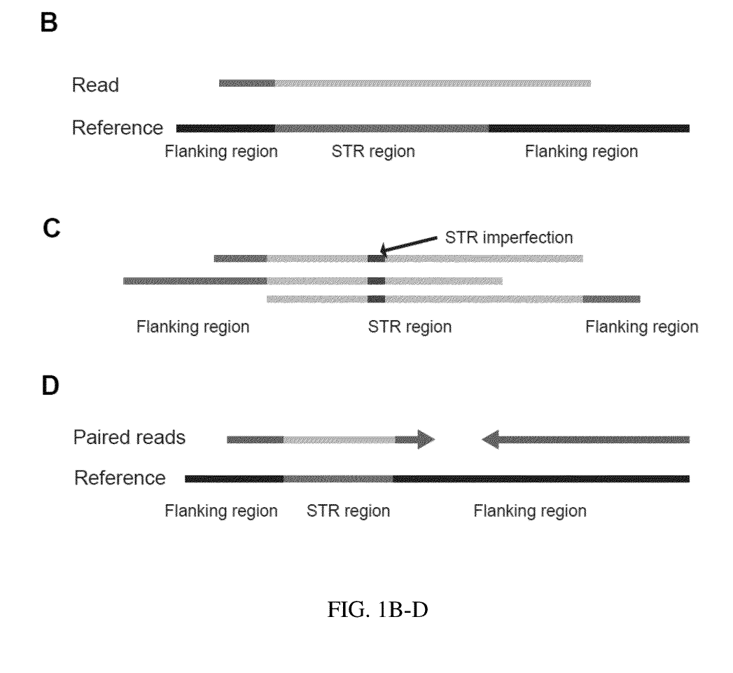

FIG. 1A illustrates a process 100 of identification of one or more STR regions in a plurality of DNA sequences obtained from a sample obtained from an individual, in accordance with some embodiments. Process 100 may be implemented by any suitable system which may comprise one or more devices. Process 100 may start at any suitable time. For example, process 100 may start when a biological sample from an individual is obtained. The sample may be obtained directly from the individual (e.g., from blood, saliva, plasma, other bodily fluids, tissues, or any sample comprising at least one DNA molecule) using any suitable technique of collecting a DNA sample from a person, as known in the art or developed in the future. Furthermore, in some embodiments, the sample may be collected in an environment where the individual to which it belongs is not present, such as, for example, a crime scene where, for example, blood or other bodily fluids or tissue samples comprising at least one DNA molecule may be collected.

When the sample is obtained or derived from the individual, as shown in FIG. 1A, at block 102, DNA sequences (which may also be referred to as “reads”) may be received that may be obtained from the sample using a suitable DNA sequencing technique. The sample preparation for sequencing technique may be any technique, either PCR-based or a technique that does not depend on PCR. Examples of sample preparation techniques for the DNA sequencing techniques that may be utilized may include PCR, hybrid capture technique, PCR-free technique or any other suitable techniques. The sequencing of nucleic acids from the sample may be performed using any suitable component.

In some embodiments, sequencing of nucleic acids extracted from the sample may be performed by the same device or system that performs analysis of DNA sequences obtained as a result of the sequencing. In other embodiments, sequencing of nucleic acids extracted from the sample is performed by a different device or system.

Thus, at block 102, process 100 may receive the DNA sequence reads that are obtained by sequencing of nucleic acids extracted from the sample by another device or system. The device or system may perform sequencing of the nucleic acids using any suitable sequencing technique and may be associated in a suitable manner with a computing device executing process 100. For example, the device or system may be separate from the computing device performing acts of process 100 and may communicate with the computing device over a network or other communication medium.

In some embodiments, processing at block 102 may be performed by a portable handheld device which may be brought to a suitable location (e.g., a crime scene, a location of an individual from which a sample is obtained or derived, a location where the sample is present, etc.).

Next, at block 104, the DNA sequences obtained at block 102 may be analyzed to identify one or more sequences including an STR region. The inventors have recognized and appreciated that the performance of the described method for identification of STRs may be improved if one or more sequences that include the entire STR region are identified from genomic DNA sequences. A DNA sequence that fully encompasses the entire STR region may be referred to as an “informative” read. Such DNA sequence may be more suited for identification of the STR region in a genome and determining an allele of the STR region.

Accordingly, once genomic DNA sequences are obtained from a biological sample using a suitable sequencing technique, at block 104, the DNA sequences may be analyzed to identify one or more DNA sequences that fully encompass an entire STR region. This step thus comprises identifying one or more DNA sequences that each include a repetitive sequence. The repetitive sequence may comprise two or more identical repeat units. Each of the repeat units may be a nucleotide sequence comprising two or more nucleotides. In some embodiments, a length of a repeat unit may vary from two to six nucleotides. However, it should be appreciated that embodiments of the invention are not limited to a particular length of a repeat unit or a number of repeat units in an STR region, and the described techniques may be used to identify an STR region comprising any number of repeat units of any suitable length.

In some embodiments, to identify a DNA sequence that includes a repetitive sequence, the method may involve dividing the DNA sequence into overlapping sequences and determining an entropy indicator for each of the overlapping sequences. The overlapping sequences may be of any suitable length and may overlap by any number of nucleotides. In one embodiment, a length of each of the overlapping sequences may be 24 nucleotides and each two consecutive overlapping sequences may overlap by 12 nucleotides. However, it should be appreciated that embodiments of the invention are not limited with respect to a particular length of each of the overlapping sequences and a number of nucleotides by which each two consecutive overlapping sequences overlap. Further, each of these parameters may be selected in any suitable manner and may be specified in any suitable way. For example, user input may be received specifying the parameters.

Regardless of a length of each of the overlapping sequences and a number of nucleotides by which each two consecutive overlapping sequences overlap, the method may comprise determining an entropy value of each of the overlapping sequences. Determining an entropy of each overlapping sequences may allow identifying an STR comprising two or more repeat units in a DNA sequence, or a read.

The entropy value may be determined in any suitable manner. In some embodiments, the entropy value for each of the plurality of overlapping sequences may be determined as follows:

$$E ( {S}_{j} ) = - {\sum }_{i ∈ Σ} {f}_{i} {log}_{2} {f}_{i} \qquad ( 1 )$$

wherein E comprises the entropy value, Sⱼ comprises a j^{th} sequence of the overlapping sequences, Σ comprises an alphabet, i comprises a symbol in the alphabet, and f, comprises a frequency of the symbol i. The alphabet may comprise an adenine, guanine, cytosine and thymine, and each symbol may comprise one or more nucleotides from the alphabet. In one embodiment, a symbol may comprise two nucleotides. It should be appreciated, however, that each symbol may comprise any other number of nucleotides.

Accordingly, the entropy value is based on a frequency of occurrence of each nucleotide in a sequence from the overlapping sequences. Using the above equation, a fully random sequence may thus have the highest entropy value that equals to log₂ |Σ|, whereas a repetitive sequence in which one or more nucleotides occur more often than other nucleotides may have a low entropy score. For example, a homopolymer sequence may have the entropy value equal to zero.

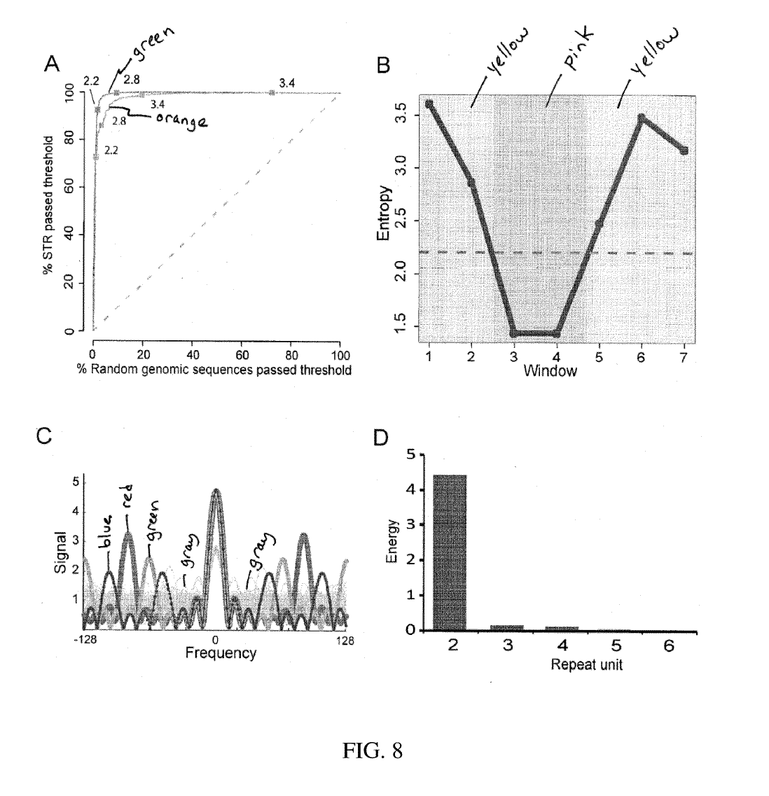

In some embodiments, when entropy values are identified for overlapping sequences generated from each DNA sequence, or read, the entropy values may be used to determine whether the DNA sequence is an informative sequence, meaning, as discussed above, that it includes an STR region in its entirety. In particular, an entropy value of the DNA sequence may be determined in a suitable manner based on entropy values of each of the overlapping sequences. For example, as shown in FIG. 8B, a relationship between the entropy values (referred to in FIG. 8B by way of example as “entropy scores”) and each of the overlapping sequences (referred to in FIG. 8B by way of example as “windows”) that together form the DNA sequence may be analyzed. In this example, such analysis may reveal that the DNA sequence comprises one or more overlapping sequences that each has a corresponding entropy value that is below a certain threshold (e.g., windows 3 and 4 in FIG. 8B), and that these one or more overlapping sequences are flanked by sequences (e.g., windows 1, 2, and 5-7 in FIG. 8B, that have corresponding entropy values above the threshold. The one or more overlapping sequences having entropy values below the threshold may correspond to an STR region, whereas the regions flanking these overlapping sequences may correspond to non-repetitive sequences flanking the STR region.

In the example illustrated, the threshold value may comprise an entropy value of approximately 2.2. However, it should be appreciated that any suitable threshold value may be utilized as embodiments of the invention are not limited in this respect.

Referring back to block 104 of FIG. 1A, regardless of a value of a threshold utilized to differentiate between one or more overlapping sequences representing an STR region and one or more non-repetitive sequences representing flanking regions, DNA sequences that are determined to have such a combination of a repetitive region flanked by non-repetitive regions may be selected from multiple genomic DNA sequences obtained from the biological sample. This may allow limiting a number of genomic DNA sequences being analyzed for the presence of STR regions to a smaller set of DNA sequences that are determined to be informative—including a nucleotide sequence pattern indicative of the presence of an STR region. In this way, the speed of the described method of identifying STR regions may be increased, because a large number of DNA sequences may be determined not to include an STR region and may be therefore excluded from a further analysis.

It should be appreciated that the determination of an entropy value for each of the overlapping sequences generated from a DNA sequence analyzed for a presence of an STR region as described above is only an example of determining an entropy of a sequence. Accordingly, other techniques may be utilized to determine an entropy of a sequence, as embodiments of the invention are not limited in this respect. Moreover, embodiments of the invention are not limited to determining whether a DNA sequence includes an STR region based on determining entropy of portions of the DNA sequence (e.g., overlapping sequences as described above), and other techniques may be utilized.

Referring back to FIG. 1A, next, once a DNA sequence including an STR region is identified, a length of a repeat unit of the STR region may be identified in a suitable manner, at block 106. Some STR loci may not contain a perfect sequence of the same repeat unit (Benson 1999). Accordingly, at block 106, a length of a repeat unit may be estimated by way of example as a length of a consensus repeat unit.

In some embodiments, a spectral analysis approach (Sharma et al., 2004) may be utilized to identify a length of a consensus repeat unit. The approach may involve representing the STR region as a binary matrix so that each column of the matrix represents an occurrence of a particular type of a nucleotide in the STR region. The binary matrix might be convoluted with one or more window functions, such as Tukey window or Hamming window functions to smooth the measured signal. A Fast Fourier transform may then be applied along the columns of the binary matrix to generate multiple frequency bins. The frequency bins may then be analyzed to identify a frequency bin having a signal strength above a suitable threshold. The length of the consensus repeat unit may then be identified based on that frequency bin. It should be appreciated that the method of spectral analysis used to identify a length of a repeat unit is described herein by way of example only, as embodiments of the invention are not limited with respect to a particular way of identifying a length of a repeat unit of the STR region.

The spectral analysis approach may utilize information on the STR region comprising entropy values determined for overlapping sequences. In particular, starting from an overlapping sequence with the lowest entropy value, consecutive overlapping sequences having entropy values less than the threshold may be merged. A nucleotide sequence of the STR region may be represented as a binary matrix M, which is an n×4 binary matrix, where n is the number of nucleotides in the STR region, the i-th row of the matrix corresponds to the i-th position of the sequence, and each column corresponds to a different nucleotide type (A,C,G,T).

The power spectrum of the binary matrix representing the STR region may be calculated by performing a Fast Fourier Transform along the columns of the matrix:

$$S ( f ) = {\sum }_{y = 1}^{4} {( {\sum }_{x = 1}^{n} {M}_{x , y} \cdot {e}^{- \frac{2 πi x f}{n}} )}^{2} \qquad ( 2 )$$

Where S(f) comprises a spectral response, M_{x,y} comprises an element in the x-th row and y-th column of M.

STRs have been shown to have a unique fingerprint in the frequency domain (Sharma et al., 2004; Zhou et al., 2009). Accordingly, a spectral response of an STR region may be characterized by a strong signal in recurrent frequency bins and a weak signal in other bins, as shown in FIG. 8C. Peaks of the spectral response for a repeat unit of length k may be revealed in the n*i/k mod n bins, where i={0, ±1, ±2, . . . }. For example, if n=24, a spectral response for a dinucleotide STR may generate a signal above a threshold in bins 0 and ±12. A spectral response for a trinucleotide STR may generate a strong signal in bins 0, ±8, and ±16. The algorithm may analyze spectral responses for multiple lengths of a repeat unit and a length of a consensus repeat unit may be selected that corresponds to a frequency bin having a signal strength above a threshold. It should be appreciated that the threshold may be selected in any suitable manner. For example, a frequency bin having a signal strength that is higher than a signal strength of the rest of the frequency bin may be selected as the frequency bin indicating a length of a consensus repeat unit, as shown by way of example in FIG. 8D.

In some embodiments, an analysis of a spectral response of an STR region may reveal a signal strength above a threshold in more than one frequency bin. Accordingly, more than one length of a repeat unit may be identified. A subsequent alignment step of the identification of an STR region in a genome, which is discussed below, may be first based on a length of the identified lengths that corresponds to a signal strength that is higher than a signal strength associated with other of the identified lengths. If the alignment based on this length does not achieve a desired performance, other of the identified lengths of a repeat unit may be used in the subsequent analysis. However, it should be appreciated that embodiments of the invention are not limited with respect to any particular way of analysis of the spectral response of an STR region.

After the length of the repeat unit of the STR region is identified, an identity of the repeat unit may be identified, at block 108. The identity of the STR region may be defined as an actual nucleotide sequence of the repeat unit of the STR region. For example, if it is identified at block 106 of FIG. 1A that the length of the repeat unit is two, at block 108 it may be identified that the actual nucleotide sequence of this dinucleotide repeat unit is TG. It should be appreciated that the described techniques may identify a repeat unit of any length and having any nucleotide sequence.

In the example illustrated, an identity of the repeat unit of the STR region may be identified by analyzing a frequency of occurrence in the STR region of each possible repeat unit of a length identified at block 106 of process 100 and identifying a repeat unit having a highest frequency of occurrence in the STR region. For example, a rolling hash function may be used to determine possible k-mers in the STR region, where k is the repeat unit length identified at block 106. A k-mer having a highest frequency of occurrence may be determined to be a nucleotide sequence of the repeat unit of the STR region.

Next, at block 110, the DNA sequence determined to include the STR region may be aligned to one or more reference DNA sequences, to determine a length and an identity of the STR region. The entire DNA sequence or any portion of the DNA sequence determined to include the STR region may be aligned to the one or more reference DNA sequences. For example, in some embodiments, one or both of upstream and downstream regions flanking the STR region may be aligned to the reference DNA sequence. As another example, the STR region may be aligned to the reference DNA sequence.

The reference DNA sequence may be any suitable DNA sequence. For example, the reference DNA sequence may comprise a fully sequenced and annotated DNA sequence of a human genome, which may be accessed from a suitable database. It should be appreciated that any suitable reference DNA sequence may be utilized, as embodiments of the invention are not limited in this respect.

In some embodiments, the upstream and downstream flanking regions of the STR region may be aligned to a reference DNA sequence. In such embodiments, the STR region itself may be not aligned to the reference DNA sequence. In this way, a genomic location of the STR region and a length of the region may be determined by measuring a distance between the upstream and downstream flanking regions. This approach may allow avoiding computation of a gapped alignment between the analyzed and reference DNA sequences, thus improving the speed of the STR identification.

The alignment of the upstream and downstream flanking regions of the STR region to the reference DNA sequence may include selecting from the reference DNA sequence STR loci formed of a repeat unit of the same length and identity as those identified at blocks 106 and 108 of FIG. 1A. For example, flanking regions may be selected from a database created by the inventors that comprises STR loci with repeat units having a length from two to six nucleotides in a human genome according to the Tandem Repeat Finder (Benson 1999). The flanking regions may be compressed using a Burrows Wheeler Transform (BWT) (Burrows and Wheeler, 1994), to improve the efficiency of alignment. The processing at block 110 may identify a location in the reference DNA sequence that includes regions aligning to the upstream and downstream flanking regions. Suitable scores may be used as measures of the alignment process.

The length of the STR region in the DNA sequence determined, at block 104, to include the STR region, may be determined in accordance with the following equation:

L=s−(d−u)+L_{ref} (3)

where L comprises an observed length of the STR region, s comprises a length of the DNA sequence determined to include the STR region, d comprises a genomic coordinate of the last nucleotide in the downstream flanking region, u comprises a genomic coordinate of the first nucleotide of the upstream flanking region, and L_{ref} comprises a length of an STR region in the reference DNA sequence.

In some embodiments, if the STR region being identified comprises insertions and/or deletions relative to the reference DNA sequence, the equation (3) may identify these insertions/deletions as differences in the STR region itself relative to the reference DNA sequence. Accordingly, once the upstream and downstream flanking regions have been aligned to the reference DNA sequence, a local realignment of the DNA sequence determined to include the STR region may be performed using the Needleman-Wunsch algorithm (Needleman and Wunsch 1970). Insertions/deletions that may be thus detected in the flanking regions may not be taken into account and removed from the equation (3), so that a length of the STR region may be determined. In some embodiments, the local realignment processing may generate a representation of the DNA sequence including the STR region in the Compact Idiosyncratic Gapped Alignment Report (CIGAR) format, which includes locations of the insertions/deletions in the sequence.

It should be appreciated that the alignment process performed at block 110 of FIG. 1A that comprises alignment of the flanking regions to the reference DNA sequence is shown by way of example only, as the alignment may be performed in other suitable manners. Thus, the entire DNA sequence determined to include the STR region may be aligned to the reference DNA sequence. Additionally or alternatively, an upstream or a downstream flanking region may be aligned to the reference DNA sequence.

In some embodiments, an upstream or a downstream flanking region may be aligned to the reference DNA sequence. This approach may be useful when some of the DNA sequences obtained from the sample may be relatively short—thus, a number of STRs that may be identified in such DNA sequences may be limited to those STRs that are each included in its entirety to a sequence from the DNA sequences. Thus, when a single flanking region may be aligned to a specific location in the reference DNA sequence, a lower bound on a number of repeat units in the STR region may be identified. This information may be useful in detecting that an expansion has occurred, as shown in FIG. 1B. Imperfections in the STR sequence may allow for inference of an exact number of repeat units in the STR region from a unique multiple alignment of two or more DNA sequences that partially span the STR region, as demonstrated in FIG. 1C.

In some embodiments, when the DNA sequences obtained from the sample are obtained from a paired-end sequencing, such as using the paired-end sequencing approach developed by Illumina® or any other suitable technology, a mate of the DNA sequence read determined to include the STR region may be used to refine the alignment of this DNA sequence to the reference DNA sequence. Because the DNA sequence read and its mate are sequenced from the same genomic locus which may span several hundred base pairs, the mate may align to the same region as the DNA sequence read including the STR region, as shown in FIG. 1D. This information may be used to determine a unique mapping when the STR-containing DNA sequence read is aligned to more than one STR locus in the reference DNA sequence, and to determine when the STR-containing DNA sequence is correctly aligned to the reference DNA sequence.

In some embodiments, an output of the processing at block 110 of FIG. 1A may be genomic coordinates of the DNA sequence comprising the STR region, a strand, a length of the STR region, the repeat unit of the STR region, a difference in a number of nucleotides between the STR region and a matching repetitive region in the reference DNA sequence, etc. In addition, the output may comprise the DNA sequence comprising the STR region in the CIGAR format, and a realignment score describing the performance of the realignment process discussed above. The alignment may be represented in a custom tab-delimited format, and in the BAM format (Li et al., 2009). Though, it should be appreciated that embodiments of the invention are not limited to any particular information that may be provided as an output of the processing at block 110 of FIG. 1A. Moreover, the alignment may be represented in any suitable format and may include any suitable indicators.

At block 112 of FIG. 1A, an allele of the STR region may be identified in a suitable manner. The processing at block 112 may determine the most likely allele of the STR region. In this example, information on the DNA sequence comprising the STR region and an expected stutter noise, which may result due to in vitro slippage events during sample preparation, may be utilized in the determination of the allele of the STR region.

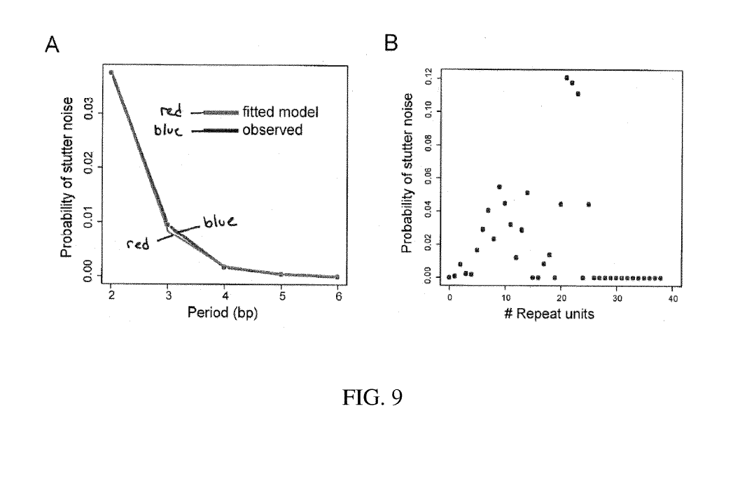

Based on analysis of sequencing data, the inventors have recognized and appreciated that a length of a repeat unit may effect a stutter noise distribution. In accordance with a previously reported mutation dynamics of STRs (Ellegren 2004), shorter repeat units may be associated with a higher stutter noise, while longer repeat units may be less sensitive to stutter noise, as shown in FIG. 9A.

In some embodiments, the processing at block 112 may utilize a generative model developed by the inventors for stutter noise. The generative model may assume that (a) with a probability π(k), a DNA sequence read is a product of stutter noise, where k denotes the repeat unit length; and (b) if the DNA sequence read is a product of stutter noise, then, with probability μ(s; λₖ), the noisy read deviates by s base pairs from the original allele, where μ(s; λₖ) is a Poisson distribution with parameter λₖ. The probabilities that the deviation is positive (repeat expansion) or negative (repeat contraction) may be equal.

Either of the model parameters π(k) and λₖ may be estimated. One or both of these parameters may be estimated based on user input or in any other suitable manner. In some embodiments, where the DNA sequences comprise Y-chromosome sequences (e.g., a male genome), a hemizygous sex chromosome may be scanned to accumulate data about stutter noise distribution. The described method may determine the stutter probability for each repeat unit length and use a logistic regression to infer π(k), as shown in FIG. 9A, and a Poisson regression to learn λₖ. In the case of a female genome, the stutter probability for each repeat unit length and π(k) may be pre-computed or determine otherwise in any suitable manner.

In some embodiments, the probability of generating a DNA sequence read with L nucleotides in the STR region from a hemizygous locus with an STR with a repeat length of a length of A nucleotides in the STR region may be determined in accordance with:

$$P ( L \vert A , k ) = \{ \begin{matrix}( 1 - π ( k ) ) & if L = A \\ \frac{π ( k )}{2} μ ( \vert A - L \vert - 1 , {λ}_{k} ) & otherwise\end{matrix} \qquad ( 4 )$$

In a diploid STR locus comprising a repeat length of a length of A nucleotides in one strand and a repeat length of a length of B nucleotides in a complementary strand, the following heuristic may be used approximate the likelihood of observing a DNA sequence read with the length of L nucleotides:

P(L|A,B,k)=max(P(L|A,k),P(L|B,k)) (5)

If it is assumed that \vec{R} is a set comprising the STR lengths of a DNA sequence read from the same locus after removing PCR duplicates, since each remaining DNA sequence read is a product of an independent series of PCR rounds, it may be assumed that the stutter noise of different entries in \vec{R} is independent. Accordingly:

log P(\vec{R}|A,B,k)=Σ_{Lε\vec{R}}log P(L|A,B,k). (6)

Accordingly, the most likely allele of the STR region may be determined by maximizing the equation (6) with respect to A and B. To determine the most likely allele of the STR region, multiple iterations may be performed over all possible pairs of STR lengths observed at the DNA sequence, and the likelihood of generating the observed data given the noise model may be determined. For example, if \vec{R}=(13,13,12,12,12), the log likelihood using the equation (6) may be calculated for the combinations of (A=12, B=12), (A=12, B=13), and (A=13, B=13). An (A, B) pair associated with the highest log likelihood may be determined as the allele of the STR region.

In some embodiments, in addition to a log likelihood score, a minimum threshold of the variant allele may be used to determine whether the STR region is heterozygous. For example, the threshold of 20% and a 50% minimum percentage of DNA reads supporting the resulting allele may be used to determine whether the STR region is heterozygous. Though, any other values of these or other parameters may be substituted.

In some embodiments, the processing at block 112 of FIG. 1A may output a chromosome, start, and end of the STR region, the repeat unit of the STR region and a length of the repeat unit, a reference repeat number from Tandem Repeat Finder (TRF), an allele the STR region which may be represented as a number of base pairs difference from the reference DNA sequence for each allele, coverage, a number of DNA sequence reads agreeing with the allele, a number of DNA reads disagreeing with the allele, the number of DNA reads supporting each observed allele, etc.

At block 114, process 100 may identify one or more matching alleles that match the determined allele of the STR region identified in the genomic DNA obtained from the sample, which is referred to herein as a target allele. The one or more matching alleles may be determined by comparing the target allele of the STR region determined at block 112 to known alleles of STR regions stored in a suitable database. The database may have multiple entries or records each associated with a corresponding allele. Thus, the database search may involve searching the database to identify an entry, or a record or a field of a record that matches the target allele. When multiple STR regions are identified in the sample, one or more corresponding matching alleles may be identified in the database for an allele of each of the STR regions.

The database may be a Y-chromosome database, autosomal database, mitochondrial database, or any other suitable database. Examples of the database may include, for example, the Ysearch database, the Ybase database, FBI's CODIS database, the Y Chromosome Haplotype Reference Database, the Sorenson Molecular Genealogy Foundation Y Chromosome Database, or any other genetic genealogy database as known in the art or developed in the future. It should be appreciated that known alleles may be stored in more than one database or any other storage.

The database may comprise alleles each associated with information relating to a subject, such as a surname. Additionally or alternatively, an allele of an STR in the database may be associated with information on an age, gender, geographical information, genetic predisposition to a disease or disorder, an actual occurrence of a disease or disorder, or any other suitable characteristic or information relating to a subject whose genome comprises the STR. “Subject” includes animals, including warm blooded mammals such as humans and primates; avians; domestic household or farm animals such as cats, dogs, sheep, goats, cattle, horses and pigs; laboratory animals such as mice, rats and guinea pigs; fish; reptiles; zoo and wild animals; and the like. The subject may comprise a human subject.

In some embodiments, the alleles in the database may comprise alleles of STR markers on the Y-chromosome. As another example, the database may comprise autosomal STR markers. However, it should be appreciated that embodiments of the invention are not limited to any specific database or to any particular information that may be stored in the database.

Searching a database of known alleles may result in identification of one or more alleles that match each of the target alleles of the STR regions identified in the sample. Some of these matching alleles, however, may be referred to as nonspecific matches, meaning that they have a low probability of truly sharing the same surname or other characteristic of the subject from which the sample is obtained or derived. Thus, matching alleles that have a high probability of truly sharing the same surname or other characteristic with the subject from which the sample is obtained or derived may be used to correctly and unambiguously identify the subject. It should be appreciated that the probability may be determined to be high or low using a threshold, which may be set in any suitable manner (e.g., based on a technique used), or in any other way.

Accordingly, processing at block 114 may comprise identifying a matching allele from the one or more matching alleles that correctly and unambiguously identify the sample, which may be performed in any suitable manner. Close patrilineal relatives may have a higher probability of sharing the same surname or other characteristics. Accordingly, in embodiments where a surname or other identifying information may be recovered based on one or more STR regions, the identification of matching alleles may involve determining a time to the most recent common ancestor (MRCA) of each of the matching alleles or a set of the matching alleles (e.g., a haplotype block) and the target allele(s) of the one or more STR regions.

Individuals that have an MRCA may have a higher probability of sharing the same surname or other characteristic. Thus, the processing at block 114 may comprise inferring surname sharing based on MRCA estimations of Y-chromosomes. The method may be based, for example, on an approach proposed by Walsh (Walsh, 2001), which is described in more detail in the Methods section. Though, any other suitable approach may be used to determine a MRCA, as embodiments of the invention are not limited in this respect.

Overall, the MRCA approach may be used to prioritize the matches in the database and to exclude matches, such as nonspecific matches, that have a low probability of truly sharing the same surname or other characteristics with the subject from which the sample is obtained or derived. When a matching allele is identified, one or more characteristics may be, with a high probability, accurately and unambiguously assigned to the sample or subject from which the sample is obtained or derived based on information relating to a subject that is associated with the matching allele.

In some embodiments, a time to the MRCA of a target set of alleles (e.g., a haplotype) of the STR regions identified in the DNA from the sample and one or more sets of matching alleles identified based on a database search may be determined. It may further be determined, based on the time to the MRCA, which of the one or more matching alleles, or sets of matching alleles, has a high probability (e.g., a probability above a certain threshold) of having the same characteristics as the set of the STR regions from the sample. When such matching alleles, or haplotypes, are identified, information associated with the matching alleles may be used to assign characteristic(s) to the sample or subject from which the sample is obtained or derived.

In some embodiments, one or more databases may be queried using a target haplotype to identify one or more matching haplotypes. Further, in some embodiments, a confidence score may be calculated for each matching haplotype to determine how close the matching haplotype is to the target haplotype. For example, the confidence score may represent a probability that the time to the MRCA (TMRCA) of the retrieved matching haplotype is shorter than that of (i) another matching haplotype having a distinct characteristic, such as a distinct surname, that has the second to shortest TMRCA, and (ii) a random person from a population.

The confidence score may be computed, such as for each matching haplotype, and may be then compared to a confidence threshold. If a confidence score calculated for a matching haplotype is greater than the confidence threshold, it may be determined that a valid surname associated with the matching allele, or haplotype, was recovered. Such valid surname may be assigned to the target haplotype. In this way, a sample or a subject, such as a human, from which the sample was obtained or derived may be identified. However, a confidence score calculated for a matching allele, or haplotype, that is equal to or less than the confidence threshold may be taken as an indication that no valid surname was recovered.

In some embodiments, the confidence threshold may be a user-defined threshold. Further, in some embodiments, a probability of successful identification of the sample or the subject from which the sample is obtained or derived based on a determined allele or haplotype may depend on a value of the confidence threshold.

Additionally or alternatively to the MRCA approach, in some embodiments, more than one allele may be required to, with a high probability, accurately and unambiguously identify the sample or subject from which the sample is obtained or derived. Thus, more than one STR regions may be identified in the DNA extracted from the sample and their respective alleles may be determined, as discussed above. One or more matching alleles from a database of known alleles may then be identified for each of the determined alleles. A probability that a characteristic, such as a surname, is accurately and unambiguously, with a high probability, assigned to a sample or subject from which the sample is obtained or derived may increase as the number of the determined alleles that are matched with known alleles increases, so that the probability is the highest when a certain number of the determined alleles is used. The number of the determined alleles may depend on an application, type(s) of STRs used, and other factors, and may comprise at least 2, 3, 4, 5, 6, 7, 8, 9, 10, 12, 15, 20, 25, 30, 35, 40, 45, 50, etc. Thus, it may be required to identify a certain number of STRs in the sample and match the alleles of the STRs to known alleles to correctly and unambiguously assign one or more characteristics to the sample or subject from which the sample is obtained or derived based on information associated with the matching alleles.

It should be appreciated that any suitable techniques may be used to identify alleles matching one or more alleles of STRs identified in the DNA extracted from the sample, as embodiments of the invention are not limited to any specific techniques.

Regardless of a way in which one or more matching allele matching the determined allele of the STR region are identified at block 114, one or more characteristics, such as a surname or other information, may be assigned to the sample based on information associated with the matching allele(s), at block 116. Process 100 may then end.

The information associated with matching allele(s) may comprise information relating to a subject (i.e., a human subject) whose DNA includes an STR of the matching allele(s). The information may comprise a surname, first name, social security number, geographical location, age, gender, a risk of developing a disease or disorder based on genetic predisposition, an actual occurrence of the disease or disorder, or any other suitable information.

One or more characteristics that may be unambiguously assigned to the sample based on the information relating to a subject associated with the matching allele(s) may comprise a surname, geographical location, age, gender, a risk of developing a disease or disorder, or any other information. For example, when a matching allele is associated with a surname, the same surname may be assigned to the sample. This identification of the sample may be used, for example, in forensics or genetic anthropology. As another example, in genetic testing applications, when the matching allele is associated with a risk of developing a disease or disorder, it may be determined that the individual from which the sample is obtained also has the risk of developing that disease or disorder. STRs may be linked to disorders, including HOXD13 STR expansions that cause synpolydactyly, PABPN1 STR expansions that are implicated in oculopharyngeal muscular dystrophy, etc.

It should be appreciated that the surname or any other characteristic may be assigned to the sample based on the identification of more than one STR regions in the DNA sequence reads obtained from the sample. Moreover, identification of a sample may require more than one alleles to unambiguously associate a specific surname and/or other information with the sample.

Accordingly, process 100 may provide an identification of an anonymous biological sample, which may be useful for a large number of applications. For example, in forensics, a sample collected at a crime scene may be associated with a surname using the techniques described herein. As another example, in genetic testing applications, one or more ancestors or relatives of a person from which the sample was obtained may be identified using the described techniques. Furthermore, the individual's susceptibility or predisposition to a certain disease or disorder may be determined based on the STR identification in the individual's genome.

It should be appreciated that process 100 may be performed by one or more of different devices. For example, process 100 may be performed by a system in which processing at block 102 is performed by a sequencing device and DNA sequences obtained from the sample using the sequencing device may be performed by one or more suitable computing devices. In some embodiments, the sequencing device may be a portable handheld device which may be brought to a suitable location (e.g., a crime scene) where a biological sample from an individual may be collected and analyzed. The DNA sequences obtained using such device may be provided in a suitable manner (e.g., over a network) to one or more computing devices that may analyze the DNA sequences to identify one or more STR regions and, based on the identification, assign a surname to the biological sample. This may decrease an amount of time required to identify the sample and may thus improve crime solution and prevent future crimes.

It should be appreciated that any suitable system may be used to implement the techniques for STR identification described herein. Thus, in some embodiments, the same system may be used to sequence DNA in a biological sample and to analyze the DNA for the presence of one or more STR regions.

Furthermore, it should be appreciated that information additional to a surname may be used to identify a biological sample. For example, in some applications, the sample may be not completely anonymous, and some information, such as a geographical location or origin of a person from which the sample is obtained, may be known. This information may therefore be used to identify the sample. Further, in some embodiments, a database of known alleles may comprise information additional to a surname associated with the allele(s). This information may also be used in a suitable manner to identify the sample and/or to identify one or more ancestors or relatives of a person from which the sample is collected.

Any other information may be used to identify a sample from the individual. STRs may be linked to certain diseases or disorders. For example, several genetic diseases, such as Huntington's disease, are associated with trinucleotide repeats. Accordingly, if one or more STRs identified in a sample from an individual match known makers for a specific disease or disorder, it may be determined that the individual has an increased risk of developing that disease or disorder. Furthermore, STRs may be used for prenatal DNA testing and for various other applications, as embodiments of the invention are not limited in this respect.

In one embodiment, the techniques described herein, such as some or all acts of the exemplary process 100 (FIG. 1A), may be performed by software referred to by way of example as lobSTR, which may be implemented using any suitable techniques. For example, it may be implemented on a suitable computer-readable medium that may be comprise computer-executable instructions that, when executed by one or more computing devices, may receive sequencing data and report alleles determined for an STR locus. The sequencing data may comprise one or more sequencing libraries in FASTA/FASTQ, BAM, or other format. The method may provide an output in a suitable format. For example, an alignment of STR reads in BAM format and an allele for each STR locus may be provided in a custom tab-delimited text format. The computer-executable instructions may be executed by one or more processors. The processors may have multi-threaded processing capability.

Having thus described several aspects of at least one embodiment of this invention, it is to be appreciated that various alterations, modifications, and improvements will readily occur to those skilled in the art. Thus, the identification of STRs in genomic sequences obtained from a biological sample and the identification of the biological sample by assigning a surname to it based on the identified STRs may be implemented in software, hardware or any combination thereof.

In some embodiments, as discussed above, the described techniques may be implemented in a system which may comprise or be otherwise associated with a device that may perform sequencing of genomic DNA from a sample. The device may be a portable handheld device which may perform DNA sequencing in accordance with a suitable DNA sequencing technique. After the genomic DNA from the sample is sequenced, one or more computing devices of the system may analyze the DNA for the presence of STRs and may further assign characteristic(s), such as a surname or any other characteristic, to the sample based on the identified STRs.

In some embodiments, the described techniques for the identification of STRs in DNA sequences may be implemented as a software tool. The tool may be implemented in any suitable manner and may be executed by one or more processors at one or more servers so that it is accessed by users over a network. For example, the tool may receive from a user multiple DNA sequence reads in a suitable format, analyze the DNA sequence reads to identify one or more STRs in the reads and assign a surname to the DNA sequence reads based on the identification of STRs, and provide the results of the analysis to the user. The results may be provided to the user in any suitable manner—for example, saved in a file of a suitable format and sent to a user via a suitable communication medium. Additionally or alternatively, the results may be displayed on a display of a computing device. The tool may be configured to receive user input relating to any parameters used by the tool.

In other embodiments, the software tool implementing the described techniques may be downloaded to a user's computer or otherwise obtained by the user. In such embodiments, the tool may be executed on the user's computer.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks. In some embodiments, a suitable cloud computing technology may be utilized to implement the described techniques for STR identification.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

### EXAMPLES

### Introduction

Short tandem repeats (STRs), also known as microsatellites, are a class of genetic variations with repetitive elements of 2 to 6 nucleotides that consists of approximately a quarter million loci in the human genome (Benson 1999). The repetitive structure of those loci creates unusual secondary DNA conformations that are prone to replication slippage events and result in high variability in the number of repeat elements (Mirkin 2007). The spontaneous mutation rate of STRs exceeds that of any other type of known genetic variation, and can reach 1/500 mutations per locus per generation (Walsh 2001; Ballantyne et al., 2010), 200 fold higher than the rate of spontaneous copy number variations (CNV) (Lupski 2007) and 200,000 fold higher than the rate of de novo SNPs (Conrad et al., 2011).

STR variations have been instrumental in wide-ranging areas of human genetics. STR expansions are implicated in the etiology of a variety of genetic disorders, such as Huntingon's Disease and Fragile-X Syndrome (Pearson et al., 2005; Mirkin 2007). Forensics DNA-fingerprinting relies on profiling autosomal STR markers and Y-chromosome STR (Y-STR) loci (Kayser and de Knijff 2011). STRs have been extensively used in genetic anthropology, where their high mutation rates create a unique capability to link recent historical events to DNA variations, including the well-known Cohen Modal Haplotype that segregates in patrilineal lines of Jewish priests (Skorecki et al., 1997; Zhivotovsky et al., 2004). Another relatively recent application of STR analysis is tracing cell lineages in cancer samples (Frumkin et al., 2008).

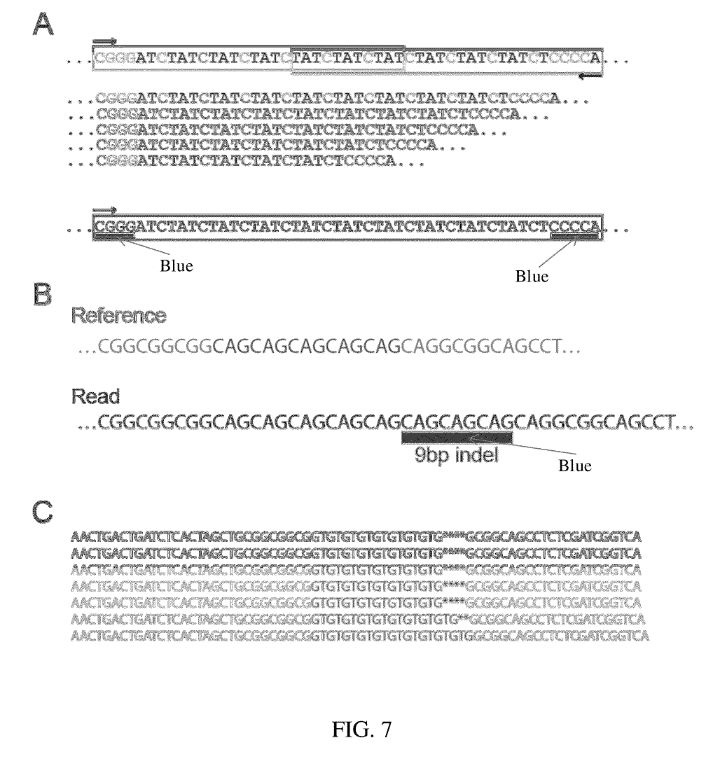

Despite the plurality of applications, STR variations are not routinely analyzed in whole genome sequencing studies, mainly due to a lack of adequate tools (Treangen and Salzberg 2011). STRs pose a remarkable challenge to mainstream HTS analysis pipelines. First, not all reads that align to an STR locus are informative (FIG. 7A). If a single or paired-end read partially encompasses an STR locus, it provides only a lower bound on the number of repeats. Only reads that fully encompass an STR can be used for exact STR allelotyping. Second, mainstream aligners, such as BWA, generally exhibit a trade-off between run time and tolerance to insertions/deletions (indels) (Li and Homer, 2010). Thus, profiling STR variations—even for an expansion of three repeats in a trinucleotide STR—would require a cumbersome gapped alignment step and lengthy processing times (FIG. 7B). Third, PCR amplification of an STR locus can create stutter noise, in which the DNA amplicons show false repeat lengths due to successive slippage events of DNA polymerase during amplification (Hauge and Litt, 1993; Ellegren 2004b) (FIG. 7C). Since PCR amplification is a standard step in library preparation for whole genome sequencing, an STR profiler should explicitly model and attempt to remove this noise to enhance accuracy.

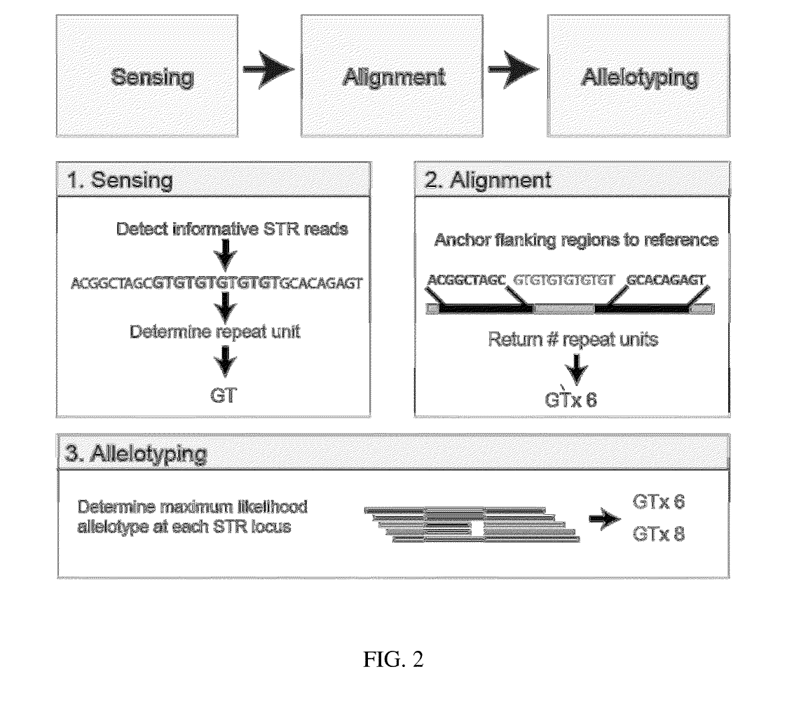

Some embodiments provide a rapid and accurate method for STR profiling in whole genome sequencing datasets, which is referred to in one embodiment as lobSTR (FIG. 2). The method may comprise three steps. The first step may be referred to as sensing during which lobSTR swiftly scans genomic libraries, flags informative reads that fully encompass STR loci, and characterizes their STR sequence. This ab initio procedure may rely on a signal processing approach that uses rapid entropy measurements to find informative STR reads followed by a Fast Fourier Transform to characterize the repeat sequence. The second step of the described method may involve alignment. Specifically, lobSTR may use a divide and conquer strategy that anchors the non-repetitive flanking regions of STR reads to the genome to reveal the STR position and length. Accordingly, a reference may be selected based on the information extracted from the sensing step to increase the alignment specificity. The alignment step allows avoids a cumbersome gapped alignment and may be indifferent to the magnitude of STR variations. The method may further comprise a step referred to as allelotyping which may be used to determine an allele of the identified STR regions. The allelotyping may use a statistical learning approach that models the stutter noise in order to enhance the signal of the true allelic configuration of the STR regions.

### Methods

lobSTR

Sensing

The aim of the sensing step is to find informative reads and characterize their STR sequence. The first task of the algorithm is to detect whether a read contains a repetitive sequence. The algorithm breaks the sequence read into overlapping windows with length of w nucleotides and r nucleotide overlap between consecutive windows. In practice, w=24 and r=12 may be used. Then, it measures the sequence entropy of each window, according to:

$$E ( {S}_{j} ) = - {\sum }_{i ∈ Σ} {f}_{i} {log}_{2} {f}_{i} \qquad ( 1 )$$

where E is the entropy, Sⱼ is the sequence of the j-th window, Σ is the alphabet set, i is a symbol in the alphabet, and fᵢ is the frequency of symbol i. A fully random sequence results in the maximal entropy score that equals to log₂ |Σ|, whereas a repetitive sequence overuses a few symbols and results in a low entropy score, ideally zero in the case of a perfect homopolymer run.

The entropy score proved extremely powerful in discriminating STR sequences from other genomic sequences (FIG. 8A). The entropy score of sliding windows of 24 bp from all documented human STR sequences of repeat unit length of 2-6 bp that span up to 100 bp was calculated. In parallel, entropy scores were determined for one million randomly sampled human genomic sequences of 24 bp. Then, the input sequences were classified according to their entropy score. The area under the receiver-operating curve (ROC) was 98.3% when the entropy measurement used the four nucleotides as the input alphabet. The classification performance was further boosted by calculating the entropy using dinucleotide symbols, meaning that “AA” maps to one symbol, “AC” maps to a different symbol, and so forth. In this case, the area under the ROC climbed to 99.4%, which renders it a nearly perfect classifier. Accordingly, lobSTR uses the dinucleotide symbols for the entropy measure, and it was empirically found that an entropy threshold of 2.2 bits provides the optimal performance in terms of speed and number of aligned STR reads.

lobSTR uses the pattern of entropy scores to identify informative reads that fully encompass STR regions. These reads display a series of windows with entropy score below-threshold (the STR region) that are flanked by one or more windows with entropy score above-threshold (the non-repetitive regions) (FIG. 8B). The algorithm only retains reads that follow this pattern. Approximately 97% of whole genome sequence reads are excluded by this rapid procedure. This significantly contributes to the algorithm's speed, since only a few simple entropy calculations are required to identify the informative STR reads in massive sequencing datasets.

The next task of the sensing step is to determine the length of the repeat unit. Most STR loci do not contain a perfect series of the same repeat unit (Benson 1999). A spectral analysis approach was utilized that quickly integrates information over the entire STR region to reliably identify the repeat consensus even in imperfect repeats (Sharma et al., 2004). Starting from the window with the lowest entropy score, consecutive windows scoring below the threshold are merged. The sequence of the merged repetitive region is represented as M, an n×4 binary matrix, where n is the number of nucleotides in the repetitive region, the i-th row of the matrix corresponds to the i-th position of the sequence, and each column corresponds to a different nucleotide type (A,C,G,T). For instance, the DNA sequence ACCGT is represented as:

$$[ \begin{matrix}1 & 0 & 0 & 0 \\ 0 & 1 & 0 & 0 \\ 0 & 1 & 0 & 0 \\ 0 & 0 & 1 & 0 \\ 0 & 0 & 0 & 1\end{matrix} ] \qquad ( 2 )$$

The power spectrum of the STR matrix is calculated by performing a Fast Fourier Transform along the columns of the matrix:

$$S ( f ) = {\sum }_{y = 1}^{4} {( {\sum }_{x = 1}^{n} {M}_{x , y} \cdot {e}^{- \frac{2 π i x f}{n}} )}^{2} \qquad ( 3 )$$

Where M_{x,y} is the element in the x-th row and y-th column of M.

STRs have a unique fingerprint in the frequency domain (Sharma et al., 2004; Zhou et al., 2009). Similar to repetitive signals in the time domain, the spectral response of STR elements is characterized by harmonics—a strong signal in recurrent frequency bins and a weak signal in other bins (FIG. 8C). The peaks of the harmonics for a repeat unit of length k dwell in the n*i/k mod n bins, i={0, ±1, ±2, . . . }. For instance, in a case of n=24, a dinucleotide STR generates a strong signal in bins 0 and ±12. A trinucleotide STR generates a strong signal in bins 0, ±8, and ±16. The algorithm integrates over the normalized energy of the first harmony (i.e. i=1) of each possible repeat unit between 2 to 6 bp. The consensus repeat unit length is selected according to the highest energy of the corresponding frequency bin (FIG. 8D). Some STR regions may show strong signals in more than one energy bin (i.e., repeats of period 4 show strong energy in both the second and fourth harmonics, and repeats with several insertions or deletions may have more than one strong harmonic). If the second highest harmonic has energy within 30% of the highest, lobSTR may attempt alignment using the second best period choice if alignment using the first choice fails.

Finally, the algorithm determines the actual STR sequence. It uses a rolling hash function to record all possible k-mers in the STR region, where k is the reported repeat unit length described above. The most frequently occurring k-mer is set to be the repeat unit of the STR. The output of the sensing step is (a) the consensus sequence of the STR's repeat unit in the canonical form, as discussed below; (b) the sequence read divided into three regions: the STR region, and upstream and downstream flanking regions that correspond to the location of the above threshold windows.

Alignment

The aim of the alignment step is to reveal the identity and the repeat length of an STR-containing read. Alignment of the entire sequence read to the genome was not performed, to avoid time-prohibitive gapped alignment. Instead, lobSTR employs a divide-and-conquer approach. It separately anchors the upstream and downstream flanking regions of STR-containing sequence reads, without mapping the STR region itself. This procedure identifies the genomic location of the STR and reveals the repeat length by measuring the distance between the flanking regions.

A major challenge of the divide-and-conquer approach is to specifically map the short flanking regions to the genome. To circumvent this problem, the alignment was restricted to STR loci with the same repeat sequence that was reported by the sensing step. A reference was built that holds the flanking regions of all the 240,351 STR loci with repeat unit 2-6 bp in the human genome according to the Tandem Repeat Finder table (Benson 1999). The flanking strings are compressed using a Burrows Wheeler Transform (Burrows and Wheeler, 1994) (BWT) to allow efficient searching. All flanking strings of STRs with the same repeat structure are organized under the same BWT structure. Thus, lobSTR only searches a single BWT data structure that corresponds to the repeat sequence, which typically holds up to a few thousand loci. Then, lobSTR intersects the potential mapping positions of the upstream and downstream regions to identify a single compatible location and excludes multiple mappers. This procedure not only speeds up the alignment, but enables higher rates of unique mapping even when the flanking regions are only a few nucleotides long.

To determine the length of the STR in the read, the algorithm uses the following equation:

L=s−(d−u)+L_{ref}, (4)

where L is the observed STR length, s is the length of the sequence read, d is the genomic coordinate of the last nucleotide in the downstream region, u is the genomic coordinate of the first nucleotide of the upstream region, and L_{ref} is the length of the STR region in the reference genome.

One important aspect of Eq. 4 is that inaccuracies in the sensing step regarding the exact boundaries of the STR do not affect the reported length of the STR. However, insertions or deletions in the flanking regions might be reported as STR differences, although they are not actual differences in the STR region itself. To mitigate this issue, lobSTR performs local realignment of the entire read once a match is found using the Needleman-Wunsch algorithm (Needleman and Wunsch 1970). Indels that are detected in the flanking regions are not taken into account and removed from Eq. 4, providing accurate length calling of the STR region. In addition, the local realignment is used to produce a CIGAR string with the locations of the indels in the read. Downstream genotype callers can use the output of lobSTR to call SNPs and indels in the STR region and its flanking regions.

The output of the alignment step is the genomic coordinates of the aligned read, the strand, the STR region extracted from the read, the STR motif, the nucleotide length difference compared to the reference genome as described above, the CIGAR string, and the realignment score. The alignments may be reported in a custom tab-delimited format, as well as in the BAM format (Li et al., 2009) to ensure compatibility with other downstream bioinformatics tools.

Allelotyping

The aim of the allelotyping step is to determine the most likely alleles of each STR locus by integrating information from all aligned reads and the expected stutter noise, which is created due to in vitro slippage events during sample preparation. This part of the program uses a BAM file as input and reports the allelotype calls.

By analyzing real sequencing data, it was found that the length of the repeat unit is a major determinant of the stutter noise distribution (Supplemental Methods). In accordance with the mutation dynamics of STRs previously reported (Ellegren 2004), short repeat units are associated with higher stutter noise and long repeat units are more immune to noise (FIG. 9A). No significant association between stutter noise and the length of the STR was found (FIG. 9B) as was observed in past studies (Hauge and Litt 1993).

A generative model was developed for stutter noise that consists of two steps: (a) with probability π(k), the read is a product of stutter noise, where k denotes the repeat unit length (b) if the read is a product of stutter noise, then with probability μ(s; λₖ), the noisy read deviates by s base pairs from the original allele, where μ(s; λₖ) is a Poisson distribution with parameter λₖ. The probabilities that the deviation is positive (repeat expansion) or negative (repeat contraction) are equal.

The user has two options to estimate the model parameters π(k) and λₖ. In the case of a male genome, the user can instruct lobSTR to scan the hemizygous sex chromosomes to accumulate unambiguous data about stutter noise distribution. The algorithm observes the stutter probability for each repeat unit length and uses a logistic regression to infer π(k) (FIG. 9A) and a Poission regression to learn λₖ. In the case of a female genome, users can use pre-computed values either from existing observations or analyze male data in their collection.

Overall, the probability of generating a read with L by in the STR region from a hemizygous locus with an STR with A by in the STR region is:

$$P ( L \vert A , k ) = \{ \begin{matrix}( 1 - π ( k ) ) & if L = A \\ \frac{π ( k )}{2} μ ( \vert A - L \vert - 1 , {λ}_{k} ) & otherwise\end{matrix} \qquad ( 4 )$$

In a diploid STR locus with A and B repeat lengths, the following heuristic to approximate the likelihood of observing a read with length L:

P(L|A,B,k)=max(P(L|A,k),P(L|B,k)) (6)

This heuristic was found to be more robust when the two STR alleles have large length differences.

Let \vec{R} be a vector that describes the STR lengths of sequence reads from the same locus after removing PCR duplicates, as discussed below. Since each remaining sequence read is a product of an independent series of PCR rounds, it may be assumed that the stutter noise of different entries in \vec{R} is independent. Accordingly:

log P(\vec{R}|A,B,k)=Σ_{Lε\vec{R}} log P(L|A,B,k) (7)

Thus, the most likely allelotype call is when Eq. (7) is maximized with respect to A and B. To find the best bi-allelic combination, the algorithm iterates over all possible pairs of STR lengths observed at the interrogated locus and compute the likelihood of generating the observed data given the noise model. For example, if \vec{R}=(13,13,12,12,12), the log likelihood in Eq. 7 may be calculated for the combinations: (A=12,B=12), (A=12,B=13), and (A=13,B=13). In addition to the log likelihood score, a minimum threshold of the variant allele may be used in order to call a locus as heterozygous, with a default threshold of 20% and a minimum percentage of reads supporting the resulting allelotype, which defaults to 50%. In the case of sex chromosome loci for a male sample, only homozygous allelotypes are considered. The most likely (A, B) combination is reported.

For each STR locus, the allelotyping step returns the chromosome, start, and end of the locus, the STR motif and period, the reference repeat number from TRF, the allelotype call given as the number of base pairs difference from reference for each allele, coverage, number of reads agreeing with the allelotype call, the number of reads disagreeing with the allelotype call, and the number of reads supporting each observed allele.

Building an STR reference

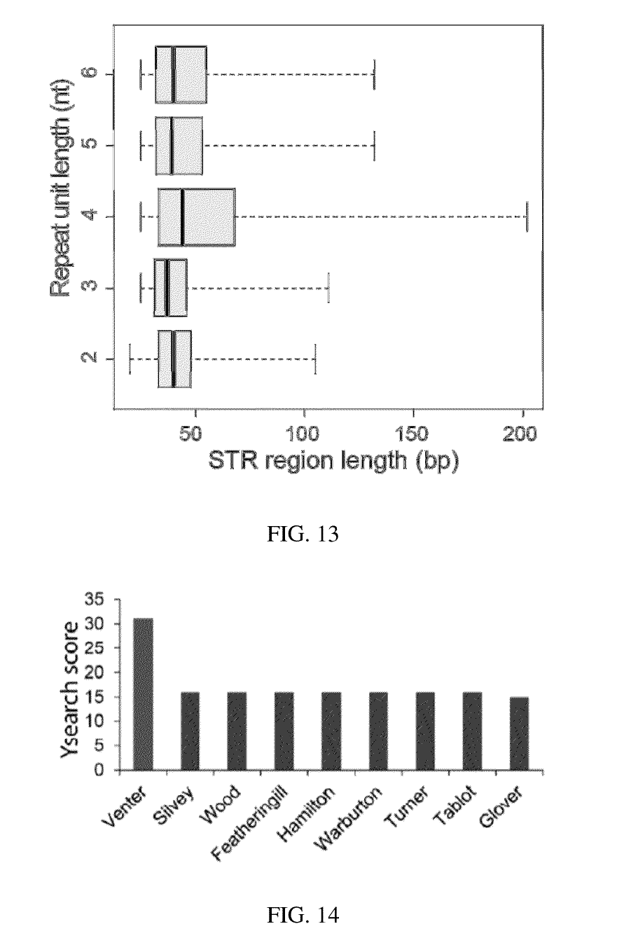

The STR reference was built according to the entries of the Simple Tandem Repeat Table for human reference genome build hg18, available from the UCSC genome browser (this reference was used for all other results as well) (Kent et al., 2002). The table was filtered to include STRs with repeat unit lengths of 2-6 bp. Nearly half of the loci are dinucleotide repeats. The number of STR loci with each repeat unit length is given in Supplemental Table 6. The 10 most common repeat units are given in Supplemental Table 7. The median length of STR regions is near 40 bp for each repeat unit length. The distribution of repeat region sizes increases slightly with the repeat period, and less than 6% of STR loci span more than 100 bp (FIG. 13). The majority of reference STRs lie in intergenic regions. 1,221 reference loci overlap exonic regions.

SUPPLEMENTAL TABLE 7
Most frequent reference STR repeat units.

| Repeat unit | # STR loci |
|---|---|
| AC | 66,992 |
| AT | 25,661 |
| AAAT | 20,319 |
| AG | 13,778 |
| AAAG | 12,553 |
| AAAAC | 10,015 |
| AAGG | 9,862 |
| AAAC | 8,842 |
| AGAT | 7,127 |
| AAAAT | 7,115 |

STRs display cyclic ambiguity. For example, consider the following STR: GACGACGACGACGAC (SEQ ID NO: 1). This STR can be described in three ways (GAC)5, (ACG)5, or (CGA)5, as well as by (GTC)5, (CGT)5, or (TCG)5 on the reverse strand. The sequence repeats in the TRF table are reported in a redundant format that does not distinguish between cyclic shifts. All repeat sequences in the table were converted to a canonical form in which the repeat sequence is the lexicographically highest among all possible cyclic representations of the sequence and their reverse complements. STRs whose repeat sequences contradicted the canonical repeat unit length, such as TTT listed as period 3 instead of 1, were removed from the reference. lobSTR reports the period of the STR according to the canonical form.

For mapping Illumina® reads, the reference consists of the ±150 bp flanking regions of each STR locus. The reference sequences from loci with the same canonical STR repeat unit were grouped into a single FASTA file, and a single BWT index was built using the BWA function “bwa index −a is” on each file.

PCR Duplicate Removal

By default, all reads with the same 5′ coordinate and length are flagged as PCR duplicates and collapsed into a single read. The user has the option to turn PCR duplicate removal off. If a group of PCR duplicate reads are associated with more than one STR length, lobSTR uses a majority vote to determine the STR length of the collapsed read. If the majority vote results in a tie, the STR length of the collapsed read is determined according to the read with the highest average quality score. All reported sequencing coverage numbers are given after removing PCR duplicates.

Building a Model for Stutter Noise

Illumina® reads from approximately 6,000 hemizygous loci on the sex chromosomes of a male individual were analyzed. It was assumed that the mode of the STR lengths in each locus was the true allele. All reads differing from the modal allele differed by either one (76% of noisy reads) or two (24% of noisy reads) repeats. Initial analysis of the stutter noise was done using R and was implemented in C++/R in the allelotyping script that is part of the lobSTR package.

lobSTR Implementation Details

lobSTR is written in C/C++ and calls on R for allelotyping step. Existing, highly optimized libraries for lobSTR implementation may be used to increase the speed of the program. The spectral analysis in the detection step was implemented using FFTW (Frigo and Johnson 1998) and the alignment step uses extensive parts of the BWA code (Li and Durbin 2009) for BWT-indexing and the BamTools library (Barnett et al., 2011) for reading and writing BAM files.

From the user's perspective, lobSTR consists of running two simple programs: one command for sensing and alignment, followed by a command for allelotyping aligned reads from a BAM file. In the simplest setting, the user just needs to specify the input files, the prefix name of the output files, and the location of the reference, which is provided with the software. However, options may be provided that include modification of the detection threshold, re-sizing the FFT windows, and increasing the tolerance to sequencing errors in the flanking regions (Supplemental Table 1). The user can also build a custom reference using a tool in the lobSTR package.

SUPPLEMENTAL TABLE 1
lobSTR program parameters.

| Parameter | Default | Description |
|---|---|---|
| -p, --threads | 1 | Number of threads to use for alignment |
| --fft-window-size | 24 | Size of the FFT sliding window in the |
| | | sensing step |
| --fft-window-step | 12 | Step size of the FFT sliding window in the |
| | | sensing step |
| --entropy-threshold | 0.45 | Percentage of maximum entropy score for a |
| | | read to pass the sensing step |
| --minperiod | 2 | Minimum period to detect |
| --maxperiod | 6 | Maximum period to detect |
| --minflank | 10 | Do not align reads that have either flanking |
| | | region with length less than this value |
| --maxflank | 25 | Trim flanking region ends to this maximum |
| | | value before alignment |
| --extend-flank | 6 | Extend the flanking regions this many bp |
| | | into the STR region |
| --max-diff-ref | 50 | Discard reads different from the reference |
| | | allele by more than this number of |
| | | nucleotides in length |
| -u | False | Discard reads differing by a non-integer |
| | | repeat number from reference |
| -m | −1 | Number of mismatches to allow in each |
| | | flanking region. If set, -r is ignored. |
| -r | 0.01 | Fraction of missing alignments given a |
| | | uniform 2% error rate (see BWA manual ) |
| | | parameter -n) |
| -g | 1 | Number of gap opens to allow in each |
| | | flanking region |
| -e | 1 | Number of gap extends to allow in each |
| | | flanking region |
| --no-rmdup | False | Specify to remove PCR duplicates |

lobSTR Comparison Across Sequencing Platforms

Raw reads for the Watson genome were downloaded from the NCBI short read archive with accession SRX000114. Reads for the Moore genome were downloaded from the Europe—a short read archive with accession ERS024569. Reads for the Venter genome were downloaded from TraceDB (Genbank accession ABBA00000000). For the Venter genome, the first 50 bp of every read were trimmed due to the high error rate at the beginning of Sanger sequence reads and discarded reads whose length after trimming was less than 100 bp.

Technical Evaluation of lobSTR

Comparison Between lobSTR Sensing Step and the TRF Tool

Tandem Repeat Finder was developed to find repetitive elements in large sequence contigs. Conceptually, it could also process short reads and replace the lobSTR sensing step in characterizing STR repeats. To compare the performance of the two lobSTR sensing step and TRF, both tools were applied to a set of 5 million 101 bp whole-genome Illumina® reads. To make a fair comparison, TRF was restricted to a maximum repeat unit period of six nucleotides and lobSTR ran on a single CPU.

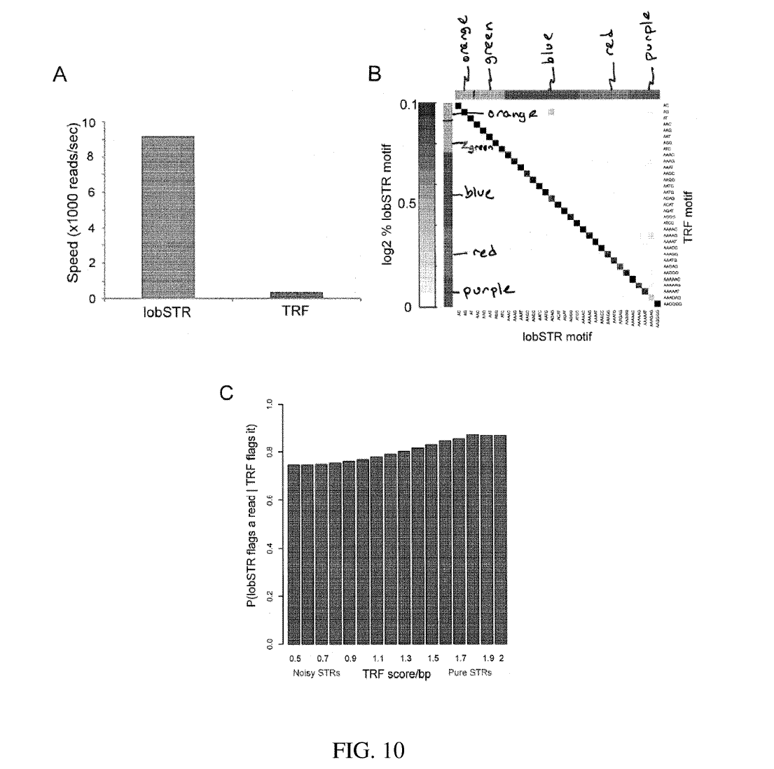

The results indicate that lobSTR's sensing step is significantly more adequate for high throughput sequencing data. lobSTR running time was just under 8 minutes compared to 6.5 hours for TRF (about 50 times slower, FIG. 10A). This means that analyzing personal genomes would take weeks instead of half a day of running time. Moreover, 94% percent of reads that were flagged as informative by both methods were reported with the same repeat sequence (FIG. 10B). Most of the discordant results occurred in STRs of period 5 or 6 where lobSTR and TRF could not reach a consensus regarding the repeat unit of imperfect repeats. Last, lobSTR flagged as informative 75%-85% of the reads that were flagged by TRF, with higher sensitivity with increasing STR purity (FIG. 10C). Thus, while lobSTR cannot detect every read that is detected by TRF, it does reach high sensitivity with 1/50 of the running time which is more suited to the ultra-exponential trajectory of high throughput sequencing datasets.

lobSTR Performance with Different Sizes of STRs

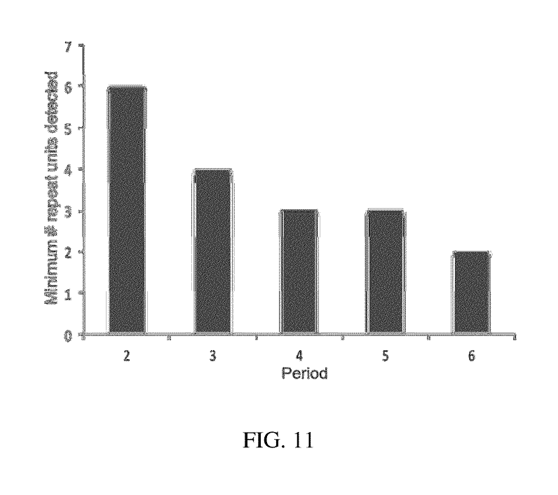

It was determined whether lobSTR can detect reads with very short STR regions due to strong repeat contraction. These reads have higher entropy and might not cross the threshold in the sensing step. To simulate this effect, TRF was applied to a set of 5 million input reads in a setting returning detected STRs as few as 12 bp long. The performance of lobSTR was then measured to detect reads from these short STR loci, and the results have shown that repetitive elements with 12 nt were well captured (FIG. 11). These results demonstrate that lobSTR can perform well in detecting STRs of 12-84 bp.

lobSTR Performance on Various Sequencing Platforms

To test lobSTR performance on other sequencing platforms than Illumina®, the method was applied to publicly available genomes from three different platforms: Sanger (Craig Venter genome) (Levy et al., 2007), 454 (Watson genome) (Wheeler et al., 2008), and IonTorrent (Moore genome) (Rothberg et al. 2011). In the absence of orthogonal information about STRs in these genomes, the performance of lobSTR was estimated using several parameters: (a) the ratio of aligned STR reads to the total input; (b) the fraction of reads with a non-integer number of repeat units different from reference; and (c) the coverage of STR loci (Supplemental Table 5).

SUPPLEMENTAL TABLE 5
lobSTR performance on four sequencing platforms.

| | | | | STR | | | |
|---|---|---|---|---|---|---|---|
| | | | | Aligned | | | |
| | | | Avg. | reads/ | % | | |
| Genome | | Input | Read | million | Non-unit | | |
| (platform) | Coverage | reads | length | bp input | Reads* | STRs ≧ 1× | STRs ≧ 3× |
| Venter | 7.5× | 12.5M | 996 | 24.78 | 7.3% | 127,017 | 41,261 |
| (Sanger) | | | | | | | |
| Watson | 7.4× | 75M | 183 | 10.41 | 25.0% | 83,079 | 25,488 |
| (454) | | | | | | | |
| Moore | 10.6× | 860M | 261 | 0.79 | 43.5% | 65,758 | 13,413 |
| (IonTorrent) | | | | | | | |
| Ajay, et al. | 126× | 14B | 100 | 4.36 | 8.0% | 180,309 | 167,175 |
| (Illumina ®, | | | | | | | |
| (100 bp) | | | | | | | |

*Reads differing by a non-integer number of copies of the STR motif from the reference. (M = million, B = billion).

As expected from its long read length and high accuracy, Sanger sequencing showed the best performance. It produced the best ratio of reads that aligned to STR loci and showed the lowest fraction (7.3%) of STR reads with a non-integer number of repeat units difference from reference. Importantly, the Sanger fraction of non-integer number of repeats was close to the Illumina® fraction (8.0%). 454 produced more STR aligned reads per amount of sequencing data than Illumina® but 25% of the STR reads showed a non-integer number of repeat units. IonTorrent showed the worst performance in both the ratio of STR reads and non-integer repeats. The high number of STR reads with non-integer repeat units is presumably because 454 and Ion Torrent exhibit insertion/deletion error when sequencing homopolymer runs that are abundant in many types of repeats (e.g., AAAAC).

The above results show that lobSTR can process sequencing files from other high throughput sequencing platforms and report STR reads. However, the accuracy of the STR identification may be lower than that determined for Illumina®. Improvement in homopolymer sequencing in 454 and Ion Torrent may make their datasets more amenable to STR profiling.

STR Coverage as a Function of Input Libraries

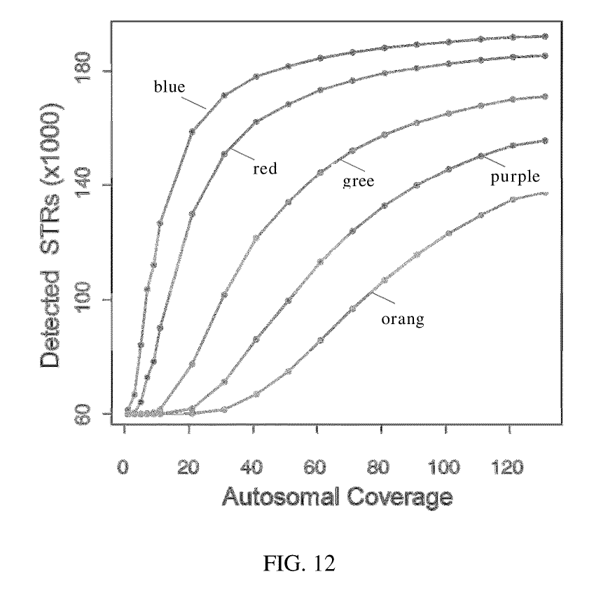

STR coverage by lobSTR to the genome-wide coverage of autosomal regions was determined. Using the genome sequenced to 126× coverage by Ajay, et al, he BAM file produced by lobSTR was sampled for a range of desired coverage levels. Allelotypes were then determined for only this subset of reads, and a number of STR loci that were covered by at least one informative read was determined (FIG. 12).

As a rule of thumb for 100 bp reads, it was found that STRs obtain an average coverage of approximately one-fifth the genome-wide autosomal coverage. In addition, it was found that around 60,000 to 80,000 STRs can be covered by at least a single sequence read even with a shallow genomic coverage of less than 5×. The number of STRs covered by at least 1 read rapidly plateaued to—180,000 loci after a genome-wide coverage of around 40×.

Certain STR loci in the TRF table cannot be detected regardless of the coverage. The main limitation is that 100 bp reads cannot span 16% of the STR entries in TRF. Other STR regions dwell in repetitive elements and generate non unique alignments, such as the Y-STR marker DYS464a/b/c/d/e/f, which has multiple locations (Kehdy and Pena 2010). Reads from these loci may be flagged as multi-mappers and may be removed from the analysis. Finally, some STR regions may not pass the entropy threshold due to their imperfect repeat structure and may not be detected using lobSTR default parameters. This may be circumvented by lowering the lobSTR entropy threshold but may require substantial running time.

Coverage Bias in Heterozygous Loci

The inventors have found a slight but statistically significant bias of 1:1.06 in the number of reads towards the shorter alleles in heterozygous loci (one sided Mann-Whitney test, p<0.05). For instance, there are on average—2 more reads that support the shorter allele when an STR is covered by 30 reads. This observation may be explained by a PCR bias as reported by a previous study (Wattier et al., 1998). Since this small effect only becomes visible in ultra-high coverage STRs, lobSTR may not currently correct for it.

Hardware Requirements

With the given TRF reference, lobSTR reaches a peak memory footprint of 0.3 Gb regardless of input size and can process about 0.6 million reads per minute on a single processor. On 25 processors, lobSTR took 26 hours to process the genome sequenced to 126× coverage described in the main text, rendering the hardware requirements of lobSTR well within the range of routinely performed bioinformatics tasks such as SNP calling and short read alignment. The processing times for several genomes analyzed in this paper are given in Supplemental Table 2.

SUPPLEMENTAL TABLE 2
Processing times of Illumina ® genomes at various coverage levels.
Processing times as a result of running lobSTR with 25 processors
(-p 25).

| Genome | Autosomal Coverage | Processing time |
|---|---|---|
| HGDP00778 | 5× | 1.3 hours |
| Male individual | 36× | 8.5 hours |
| Ajay, et al. | 126× | 26 hours |

Comparing lobSTR to Mainstream Aligners

All alignment strategies were tested in a Linux environment, on a server with 4 twelve-core AMD Opteron 6100 and 128 Gbyte of RAM. The following software versions were tested: BWA version 0.5.7, Bowtie version 0.12.7, and Novoalign freeware version 2.7.13, BLAT version 34, and GATK version 1.3-21.

The input was 5 million Illumina® reads of a sample obtained from a male. BLAT results were filtered to include only the top hit for each read. Multi-mappers in all other tools were suppressed. Informative STR reads were identified by the intersectBed tool of the Bedtools packages (Quinlan and Hall 2010). CIGAR scores were converted to the number of base pairs difference from the reference allele by counting any insertions or deletions falling within and directly adjacent to the STR region. Simulating reads from pathogenic STR loci was conducted using a simple Python script available by request from the authors.

Determining the Expected Number of Non-Reference Reads

A previous study by The Utah Marker Development Group (1995) has shown that 70% of thousands of randomly chosen tetranucleotide STR loci are polymorphic. Payseur et al. data was also analyzed to infer the polymorphism rate in STRs with length ≧25 bp in the assembled genome of Craig Venter using results reported in their Supplementary Tables 1-5. Concordant with the Utah study, this rate was 66%.

The rate of non-reference STR reads is bounded between two extreme cases. The lower bound is that all polymorphic STRs are heterozygous with a reference allele. Thus, only half of the reads from variable loci may show a non-reference allele, which gives 33% as a lower bound. The upper bound is that all polymorphic STRs are different from the reference in their two alleles. In this case, every read from a variable locus may show a non-reference allele, which gives 66% as an upper bound.

Biological Replicates Analysis

Raw reads for blood-derived and saliva-derived genomic DNA from the same individual were downloaded from the NCBI short read archive (ncbi.nlm.nih.gov/sra) with accessions SRX097307 and SRX097312, respectively. Loci in which (1) less than 75% of reads agreed with the allelotype call in both samples or (2) the locus was covered in either sample by more than three times the mean coverage level were removed from the analysis.

CEU Trio Data for Mendelian Inheritance

The HapMap CEU trio were NA12877 (father), NA12878 (mother), and NA12882 (son). Raw reads were downloaded from the European short read archive (ebi.ac.uk/ena/) with accessions ERP001228, ERP001229, and ERP001230, respectively. To determine if an STR followed Mendelian inheritance, it was required that the alleles detected in the son could be explained by inheriting one allele from each parent. Low quality loci were filtered as described in the Biological replicates analysis section above.

Validating lobSTR Accuracy Using Capillary Electrophoresis

Four Catch-All buccal swabs (Epicenter, QEC89100) were used to collect the DNA sample according to the manufacturer protocol. gDNA was extracted by QuickExtract (Epicentre), followed by phenol-chloroform purification and ethanol precipitation. Library preparation was performed according to the standard Illumina® protocol. Three runs of 101 bp paired-end with a GAIIx platform were used for sequencing. The study was approved by MIT's Committee on the Use of Humans as Experimental Subjects (COUHES). The general sequencing coverage was analyzed as previously reported (Erlich et al., 2011).

Capillary electrophoresis results were obtained from Sorenson Genomics laboratory using the commercial Promega PowerPlex 16 system. To find the genomic positions of these loci, corresponding primers that target these loci were downloaded from the Short Tandem Repeats Internet Database (STRBASE) website (cstl.nist.gov/strbase/) of the US National Institute of Standards and Technology (NIST) and used the In Silico PCR tool on the UCSC genome browser to reveal their location. Two loci had proprietary primers and their genomic location could not be identified. The STR repeats in the sequencing file were converted to the PowerPlex allele nomenclature using the NIST definitions.

Obtaining CEPH-HGDP STR Allelotypes

STR allelotypes along with a table of RefSeq reference alleles were downloaded from the Rosenberg lab site (stanford.edu/group/rosenberglab/repeatsDownload.html). The allelotypes were given as the number of repeats converted from PCR product size as described in Pemberton et al. (2009). The repeat number is given as reference repeat number plus the difference in product size from the reference divided by the motif size. Sequence data were downloaded from the NCBI Short Read Archive with accessions: ERX004003, ERX004002, ERX004001, ERX004000, ERX0039999, ERX004007, ERX007978, ERX007977, ERX007976, ERX007975, ERX007974, ERX007973, ERX007972.

Using the STS marker table available from the UCSC Genome Browser, markers described in Pemberton et al. were converted to hg18 genomic coordinates and annotated them using the TRF table. lobSTR calls that are supported by three or more reads were converted to the Pemberton results. Non-integer repeats reported by lobSTR were rounded to the smallest integer for compatibility with Pemberton data. Markers that could not be faithfully annotated were removed from the analysis.

Genome-Wide STR Profiling of a Deeply Sequenced Personal Genome

Raw sequencing reads for accession number ERP000765 were downloaded from the European Nucleotide Archive's Sequence Read Archive (ebi.ac.uk/ena/). The Mann-Whitney test was performed using the wilcox.test function in R. Confidence intervals were calculated using a normal approximation to the Poisson distribution, with a 95% confidence interval of λ±1.96√λ, where λ is the estimated mean of the distribution. Only loci with greater than 20-fold coverage were included in the analysis. Exon and intron coordinates were obtained from the UCSC table browser for human genome build hg18.

1000 Genomes Data Analysis for the McIver Study

The HapMap CEU trio were NA12878 (daughter), NA12891 (father), and NA12892 (mother). Raw sequencing reads for the CEU HapMap trios with length of at least 47 bp were downloaded from the 1000 genomes NCBI ftp site (ftp://ftp-trace.ncbi.nih.gov/1000 genomes/ftp/). 228, 274, and 214 files were included for individuals NA12878, NA12891, and NA12892. To accommodate the shorter read lengths, lobSTR was run with non-default parameters—fft-window-size 20—fft-window-step 10, —maxflank 100, and —extend-flank 5.

Profiling STRs from Exome Capture Sequencing

Exome sequencing datasets from 1,118 individuals were obtained that were sequenced with 100 bp paired end reads on the Illumina HiSeq 2000. On average, after filtering low quality loci, 357 of 594 exonic STRs were completely spanned by 10 or more reads in each individual. More than 3,000 STRs in regions adjacent to exons were captured at greater than 10× coverage in at least 50 individuals.

Profiling STRs from STR Capture Sequencing

For 48,508 target STR loci, probes were developed to capture the 75 bp upstream and downstream of each STR. The 244 k SureSelect DNA Capture Array (available from Agilent Technologies) was used to specifically capture STR-containing regions of a male genomic DNA sample. Sequencing was performed on one lane of the Illumina Genome Analyzer II with 100 bp paired end reads. 17,207 STR loci were completely spanned by 10 or more reads.

Surname Recovery Based on Most Recent Common Ancestor (MRCA)

The database search method relies on finding one or more records that share the closest Most Recent Common Ancestor (MRCA) with a searched allele, or haplotype. The rationale behind this strategy may be that close patrilineal relatives have a higher probability of sharing the same surname. For instance, one can imagine that monozygotic twins have a high probability of sharing the same surname, whereas a pair of Y chromosomes whose MRCA lived before the formation of the surname system would have a low probability of sharing the same surname.

Bayesian models were proposed (Walsh, 2001) for estimating the distribution of the time to MRCA in non-recombining haplotypes. The ‘infinite alleles model’ described in Walsh may be used because this model only requires the number of allelic matches versus mismatches regardless of the length of the alleles. Consider two Y chromosome haplotypes, denoted by \vec{v} and \vec{u}, and let k be the number of concordant markers, d the number of discordant markers, and define ndefk+d. For instance, consider the STR haplotypes: \vec{v}=(12, 23, 14, 10) and \vec{u}=(12, 23, 12, -), where the ‘-’ symbol denotes ‘no information about the marker’; in this case: k=2, d=1, and n=3. According to infinite alleles model, the probability distribution of time to MRCA between the two chromosomes is:

$$P ( t \vert n , k ) = \frac{{{e}^{- ( 2 μ k + \frac{1}{{N}_{e}} ) t} ( 1 - {e}^{- 2 μ t} )}^{n - k}}{I ( μ , k , n , {N}_{e} )} \qquad ( 8 )$$

and the median time to MRCA (mtMRCA) is the point where:

$${\sum }_{t = 0}^{mtMRCA} P ( t \vert n , k ) = 0.5 , \qquad ( 9 )$$

where μ is the mutation rate of STR markers, Nₑ is the effective male population size, and I is a normalization factor to ensure that Σₜ₌₀^{∞}P (t|n, k)=1. Following previous studies, μ was set to 1/500 mutation events per meiosis and Nₑ was set to 10,000 males (Walsh, 2001; Heyer et al., 1997; and Thomson et al., 2000).

The recovered surname was selected according to the record that has the minimal mtMRCA of the searched haplotype. The following procedure was utilized: (i) using the Ysearch database to identify a set of candidate records that have the highest number of matching markers to the queried haplotype, (ii) using a tool provided by the Sorenson Molecular Genealogy Foundation (SMGF) Y Chromosome Database to identify the top 10 candidates according to a proprietary algorithm; (iii) calculating the mtMRCA for top candidate and candidates identified using the Ysearch database and the SMGF database using the equations 8 and 9, and selecting one or more records with the minimal mtMRCA of the searched haplotype.

A threshold, θ, which denotes the maximal accepted mtMRCA, was set for a valid surname recovery. If the mtMRCA of the best hit was above this threshold, the search returned an empty set. This procedure filters non-specific matches due to ancient MRCAs that have a small probability of sharing the same surname.

A search may result in three mutually exclusive outcomes: (a) Success—the search returned a unique surname that correctly match to the true surname the input haplotype, (b) Misleading surname—the search returned a unique surname but not the correct one, or (c) Unknown—the search returned zero surnames (the minimal mtMRCA is above the threshold) or multiple surnames (ties between records). The following table provides examples for the three outcomes of a search:

| True | | |
|---|---|---|
| surname | Recovered surname/s: | Outcome |
| Smith | Smith | Success |
| Smith | Jackson | Misleading |
| Smith | Smith, Jackson | Unknown |
| Smith | (empty set) | Unknown |

### Surname Recovery Based on Time to Most Recent Common Ancestor (TMRCA)

Database Search

In some embodiments, a time to the MRCA (TMRCA) of a target set of alleles, such as a haplotype, of STR regions identified in the DNA from a sample and one or more sets of matching alleles, or haplotypes, identified based on a database search may be determined. A database search using the described technique involved finding a record that shares the closest TMRCA with a queried haplotype.

From the Bayesian models proposed by Walsh (Walsh, 2001) for estimating the distribution of the TMRCA in non-recombining haplotypes, the ‘infinite alleles model with differential mutation rates’ was utilized. Consider two Y chromosome haplotypes with n STR loci denoted by \vec{v}=(v₁, v₂, . . . , vₙ) and \vec{u}=(u₁, u₂, . . . , uₙ), with vector elements corresponding to the allele lengths. Let \vec{x}=(x₁, x₂, . . . , xₙ) be a binary vector with xᵢ=1 for a match at the i-th locus of \vec{v} and \vec{u}, and xᵢ=0 otherwise, and let \vec{μ}=(μ₁, μ₂, . . . , μₙ) be a vector, with elements of the vector denoting a probability of a mutation per meiosis in each marker. According to Walsh's model, the probability distribution function (PDF) of the TMRCA between the two haplotypes is:

$$P ( t \vert {x}^{->} , {μ}^{->} , {N}_{e} ) = \frac{{e}^{- t ( \frac{1}{{N}_{e}} + 2 {\sum }_{i = 1}^{n} {μ}_{i} {x}_{i} )} {\prod }_{i = 1}^{n} {( 1 - {e}^{- 2 t {μ}_{i}} )}^{1 - {x}_{i}}}{I ( {x}^{->} , {μ}^{->} , {N}_{e} )} \qquad ( 10 )$$

where Nₑ is the effective male population size, and I is a normalization factor to ensure that Σₜ₌₀^{∞}P(\vec{x}|,\vec{μ},Nₑ)=1. Following Thomson et al. (Thomson et al., 2000), Nₑ was set to 10,000 males. The mutation rates were obtained from a previous work (Ballantyne et al., 2010).

In this example, the expected TMRCA is denoted by T and may be defined as:

$$τ = {\sum }_{t = 0}^{∞} {t}_{i} P ( {t}_{i} \vert {x}^{->} , {μ}^{->} , {N}_{e} ) \qquad ( 11 )$$

The recovered surname was selected according to the record that has the minimal τ to the target haplotype. The following procedure was utilized: (i) using the Ysearch database to identify a set of candidate records that have the maximum number of matching markers to the queried haplotype; (ii) using the SMGF database to identify top 10 candidates; and (iii) calculating τ, expected TMRCA, for the top candidates extracted from the Ysearch and SMGF databases, using the equations 10 and 11, and selecting one or more records with the minimum τ to the target haplotype. It should be appreciated that other suitable parameters may be substituted—for example, a number of top candidates may be other than 10.

Retrieval Confidence Score

A retrieval confidence score may be used to determine a probability that the TMRCA of the retrieved record is shorter than that of (i) a record with a distinct surname that has the second TMRCA to the shortest TMRCA, and (ii) a random person from the population. Let P₁ and P₂ be the TMRCA probability distribution functions (PDFs) of the best record and second best record according to the equations 10 and 11, and let P₃ be a PDF of coalescent in a Fisher-Wright population: P₃ (t|Nₑ)=Nₑ⁻¹ e^{-N}^{ₑ}^{t}. In addition, let Fᵢ be a cumulative probability distribution function of Pᵢ. The retrieval confidence score, denoted in this example as δ, is given by:

$$\begin{matrix}δ ( {P}_{1} , {P}_{2} , {P}_{3} ) = {\sum }_{{j}_{2} = 1}^{T} {P}_{1} ( {j}_{1} ) ( {\sum }_{{j}_{2} > {j}_{1}}^{T} {P}_{2} ( {j}_{2} ) ( {\sum }_{{j}_{3} > {j}_{1}}^{T} {P}_{3} ( {j}_{3} ) ) ) \\ = {\sum }_{j = 1}^{T} {P}_{1} ( j ) ( 1 - {F}_{2} ( j ) ) ( 1 - {F}_{3} ( j ) )\end{matrix} \qquad ( 12 )$$

T is the number of generations that is practical for the patrilineal surname system and was set to 20 generations, corresponding to ˜1400 AD. Though, it should be appreciated that T may be set to a different number of generations. P₂ was obtained from record(s) generated in step (iii) above—by selecting one or more records with the minimum T to the target haplotype; in this example, candidate records with less than 20 matching markers were excluded as well as records with surnames that matched the top hit.

Surname Recovery

In this example, to test a probability of surname recovery, the Ysearch and the SMGF databases were queried with an orthogonal cohort of Y-STR haplotypes consisting of 34 markers (Table SS1) from 911 individuals, primarily with Caucasian ancestry, whose surnames are known.

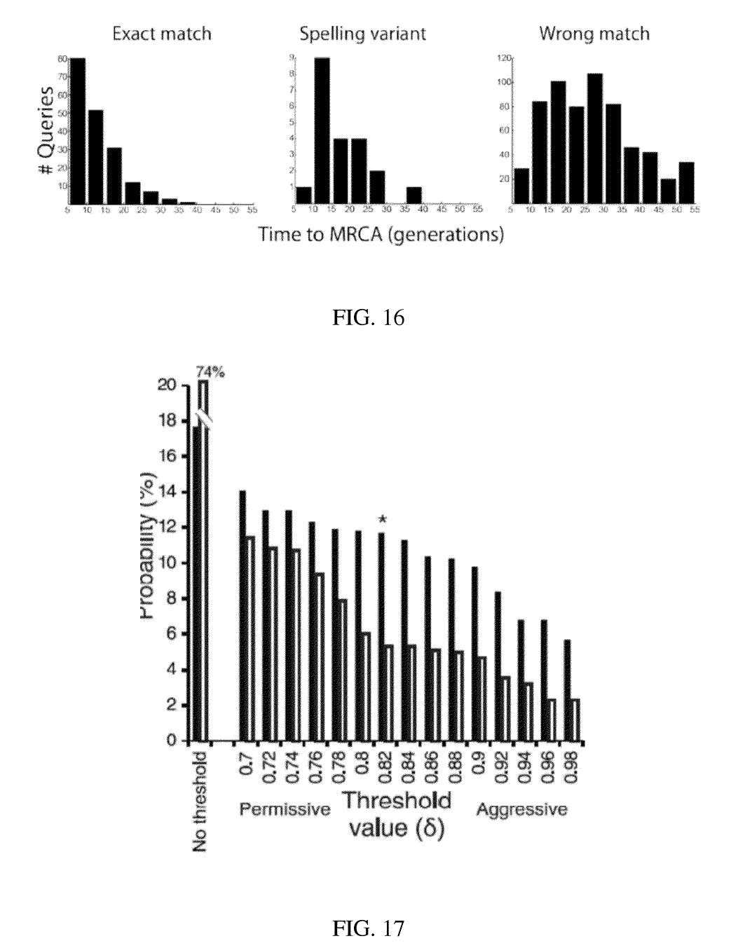

This cohort was compiled from the YBase genealogy database, and contained individuals with 521 surnames that segregated in the U.S. population. For each target haplotype used to query the databases, the described technique for surname recovery was used to retrieve one or more database records with the shortest TMRCA with the input haplotype (FIG. 16). Then, for each of the retrieved records, a confidence score indicating whether a surname associated with the retrieved record is significantly better than other matches was calculated as described above.

The calculated confidence score was compared to a confidence threshold which, in this example, was used to determine a minimum accepted quality for the retrieved record to provide a valid surname that can be assigned to the target haplotype. The threshold may be defined based on user input or in any other manner. In this example, the inventors used a range of confidence thresholds to explore the trade-off between successful versus wrong recovery of surnames.

TABLE SS1
List of markers used to query the Ysearch and SMGF database.
Mutation rates are based on Ballantyne (Ballantyne et al., 2010).
Mean and standard deviations for marker values were calculated using
Ysearch with NIST nomenclature.

| | | Expected | | |
|---|---|---|---|---|
| | | mutation | | |
| Count | Marker | rate | Mean | σ |
| 1 | DYS19 | 0.00437 | 14.34 | 0.8045 |
| 2 | DYS385a | 0.00208 | 12.0869 | 1.6522 |
| | DYS385b | 0.00414 | 14.5464 | 1.449 |
| 3 | DYS388 | 0.000425 | 12.5142 | 1.0753 |
| 4 | DYS389a | 0.00551 | 12.9668 | 0.6644 |
| | DYS389b | 0.00383 | 29.326 | 1.0418 |
| 5 | DYS390 | 0.00152 | 23.6032 | 1.0229 |
| 6 | DYS391 | 0.00323 | 10.4858 | 0.6104 |
| 7 | DYS392 | 0.00097 | 12.3413 | 1.1069 |
| 8 | DYS393 | 0.00211 | 13.0752 | 0.6025 |
| 9 | DYS426 | 0.000398 | 11.6459 | 0.5198 |
| 10 | DYS437 | 0.00153 | 14.9094 | 0.6931 |
| 11 | DYS438 | 0.000956 | 11.2206 | 1.0643 |
| 12 | DYS439 | 0.00385 | 11.66 | 0.8567 |
| 13 | DYS442 | 0.00978 | 17.2273 | 1.3301 |
| 14 | DYS444 | 0.00545 | 12.3666 | 0.892 |
| 15 | DYS445 | 0.00216 | 11.6015 | 0.9401 |
| 16 | DYS446 | 0.00267 | 13.1767 | 1.372 |
| 17 | DYS447 | 0.00212 | 24.6396 | 1.2057 |
| 18 | DYS448 | 0.000394 | 19.3437 | 0.8748 |
| 19 | DYS449 | 0.0122 | 29.5472 | 1.6474 |
| 20 | DYS452 | 0.00402 | 30.1854 | 1.1041 |
| 21 | DYS454 | 0.000475 | 11.0484 | 0.3744 |
| 22 | DYS455 | 0.000426 | 10.648 | 0.9704 |
| 23 | DYS456 | 0.00494 | 15.4571 | 1.1065 |
| 24 | DYS458 | 0.00836 | 16.6389 | 1.2634 |
| 25 | DYS459a | 0.00013 | 8.753 | 0.5017 |
| | DYS459b | 0.00013 | 9.601 | 0.5422 |
| 26 | DYS460 | 0.00622 | 10.6976 | 0.639 |
| 27 | DYS461 | 0.000989 | 11.882 | 0.6914 |
| 28 | DYS462 | 0.00265 | 11.3571 | 0.6266 |
| 29 | DYS464a | 0.00018 | 13.8555 | 1.4488 |
| | DYS464b | 0.00018 | 14.7374 | 1.0564 |
| | DYS464c | 0.00018 | 15.8236 | 1.124 |
| | DYS464d | 0.00018 | 16.5742 | 1.1157 |
| 30 | DYS635 | 0.00385 | 22.6604 | 1.1601 |
| 31 | GATA-A10 | 0.00322 | 15.5234 | 1.2242 |
| 32 | GATA-H4 | 0.00322 | 10.7333 | 0.7801 |
| 33 | GGAAT1B07 | 0.0024 | 10.2854 | 0.7397 |
| 34 | YCAIIa | 0.002 | 19.0997 | 0.905 |
| | YCAIIb | 0.002 | 22.136 | 1.2624 |

If the confidence score computed for a retrieved record was greater than the threshold, a surname associated with that record was assigned to the target haplotype. However, if the computed confidence score was equal to or less than the threshold, an indication that no match was found and therefore no surname was assigned to the target haplotype was generated. The indication may be, for example, the phrase “Unknown.” Though, it should be appreciated that embodiments of the invention are not limited to any specific way of providing an indication that no surname was assigned to the target haplotype, and the indication may be provided in any suitable manner.

In the example illustrated, if a search returned records with an empty surname field or with strings that are not found in the surname list of the US census, such as, for example, “AshkenaziJewishModal,” such results were reported as “Unknown.” TMRCA ties between two or more records with distinct surnames were also reported as “Unknown.” A surname recovery thus resulted in one of the following outcomes: success—the recovered surname is concordant with the true surname, wrong—the recovered surname does not match the true surname, unknown—below confidence threshold, non-valid surnames, and ties.

Modeling the Expected Outcomes from a Surname Recovery

The probability of surname recovery from personal genomes may depend on three factors: the prior distribution of surnames in personal genomes datasets, the distribution of haplotypes within a surname, and the ability to successfully retrieve the surname from the database using the haplotype. For simplicity, it may be assumed that the distribution of surnames of personal genomes is similar to the distribution of surnames in the population.

Let Iₓ (h, s) be an indicator function that returns 1 if querying the database with the combination of haplotype h and surname s returns the outcome x, where x is either: ‘success’, ‘wrong’, or ‘unknown’. Let fₛ be the frequency of a surname and α(h,s) be the frequency of haplotype h in the surname s. Further, the following may be defined: βₓ(s) [symbol] ₍ₛ₎α(h, s)Iₓ (h, s), where [symbol] (s) is the set of haplotypes that are associated with the surname s. The probability of the surname recovery outcome x for a given population may be defined as:

$$P ( x ) = \frac{{\sum }_{s ∈ 𝕊} {f}_{s} {β}_{x} ( s )}{{\sum }_{s ∈ 𝕊} {f}_{s}} \qquad ( 12 )$$

Where [symbol] is the set of all surnames in the population.

The probability in the equation 12 may be assessed by sampling individuals from the population using the following estimator:

$$\hat{P} ( x ) = \frac{{\sum }_{s ∈ 𝕊} {\hat{f}}_{s} {\hat{β}}_{x} ( s )}{{\sum }_{s ∈ 𝕊} {\hat{f}}_{s}} c + \frac{{\sum }_{s ∈ \overline{𝕊}} {\hat{f}}_{s} {\hat{β}}_{x} ( s )}{{\sum }_{s ∈ \overline{𝕊}} {\hat{f}}_{s}} ( 1 - c ) \qquad ( 13 )$$

where S is the set of surnames in the sample that are known to be present in the tested databases and S̅ is the set of surnames in the sample that are known to be absent from the tested databases. \hat{f}s the estimated frequency of the surname based on the Census data, βₓ(s) [symbol] ₍ₛ₎\hat{α}(h, s)Iₓ(h, s), and \hat{α}(h,s) is the frequency of the haplotype-surname combination in the sample, and c is the census coverage probability that was determined above. The equation 13 may be used to model the outcome rates as a weighted sum of sampling individuals from two distinct strata: those whose surname is found in the databases and those whose surname is not found. The two weights may mitigate potential ascertainment biases in the sample and increase the confidence that the results reflect the target population.

Estimating the Probability of Surname Recovery

In the experiments, an input sample relied on a cohort of individuals from the YBase database. This database was maintained by DNA Heritage and was acquired by FamilyTreeDNA. Surname-haplotype records from the database were obtained from FamilyTreeDNA, without other identifiers that could expose the identity of the database users. The YBase and SMGF entries are distinct because the SMGF database lists only SMGF users. The following steps were taken to remove potential duplicate records between Ysearch and Ybase: first, YBase entries whose email addresses appear in Ysearch as well as entries without email addresses were excluded. Second, approximately ˜900 users that were tested with DNA Heritage were removed from the downloaded copy of Ysearch. Third, YBase users whose haplotype did not show a combination of markers that are typical to the DNA Heritage test panel were excluded. Thus, the input cohort was tested with a different company (DNA Heritage) than the database users. This reduced the chance of ascertainment biases due to oversampling of close relatives of the database participants.

Genetic genealogy databases are subject to nomenclature heterogeneity that can confound the analysis. This is especially problematic for DNA Heritage test panels that were subject to five nomenclature changes between 2003 to 2009. For each input haplotype, allelic ranges for markers that underwent significant nomenclature changes, such as DYS452, were inspected to decipher the nomenclature stratum and to standardize the haplotype according to the NIST recommended nomenclature. In addition, a tolerable genotype range was set for each marker that is equal to the marker mean value in Ysearch±3 standard deviations. Entries outside of this range may have a high likelihood of nomenclature differences and typos of users. This step filtered approximately 5% of YBase haplotypes. Finally, only those YBase haplotypes were selected that had full genotyping results for a set of 34 STR markers (Table SS1) and whose surnames are in the US census. At the end of this process, 911 YBase records were retained.

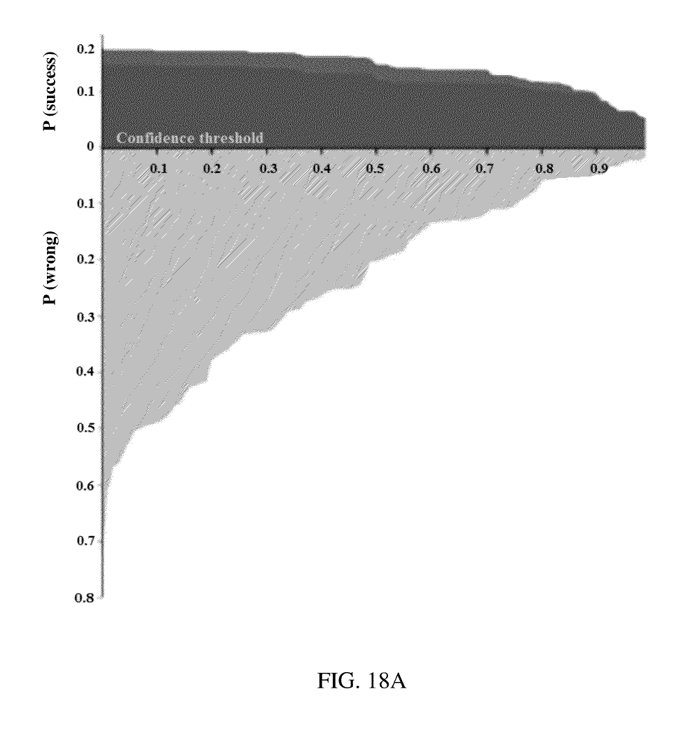

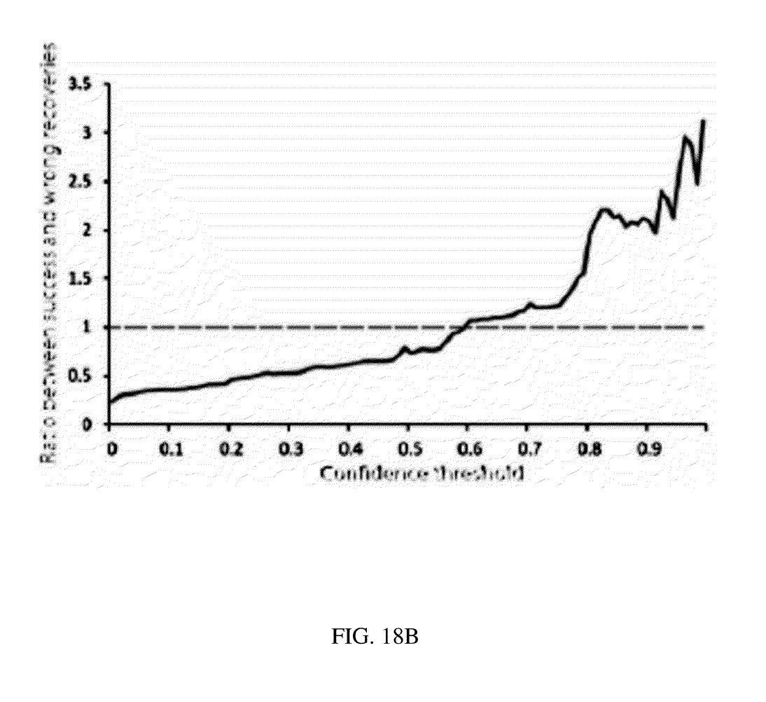

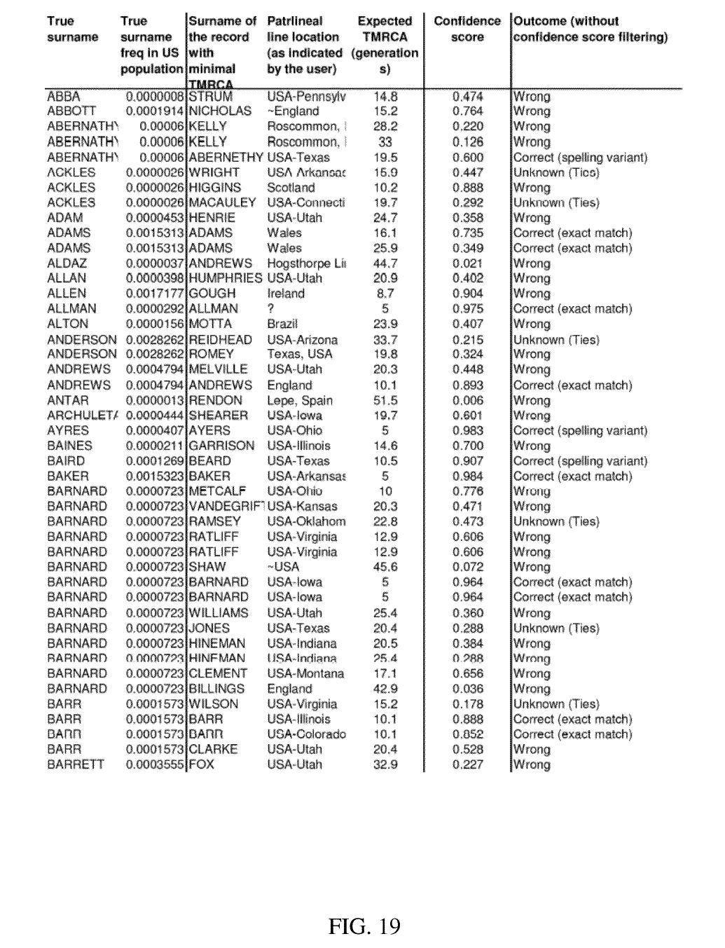

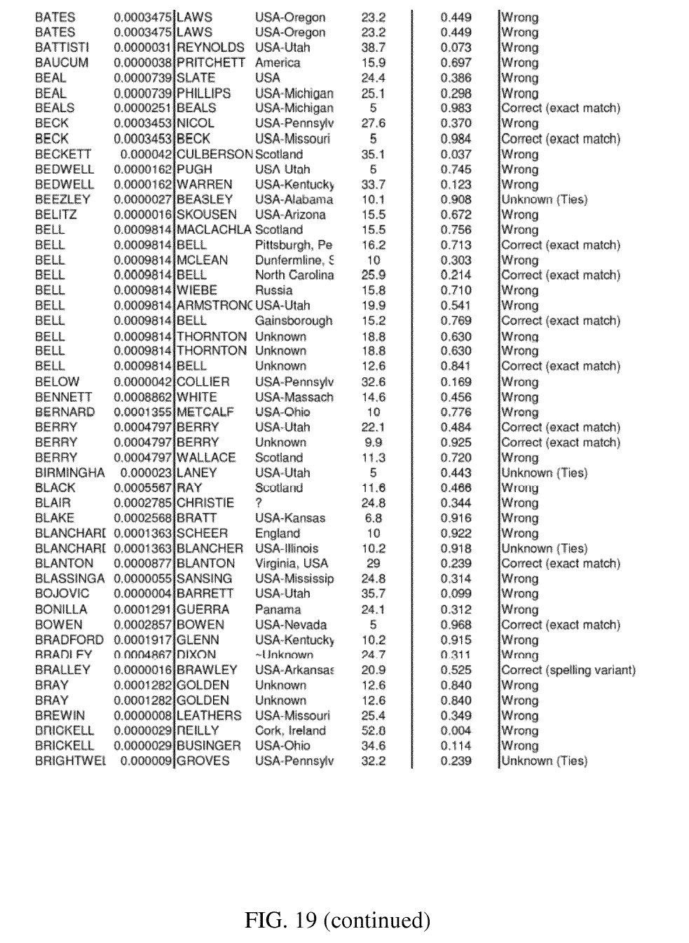

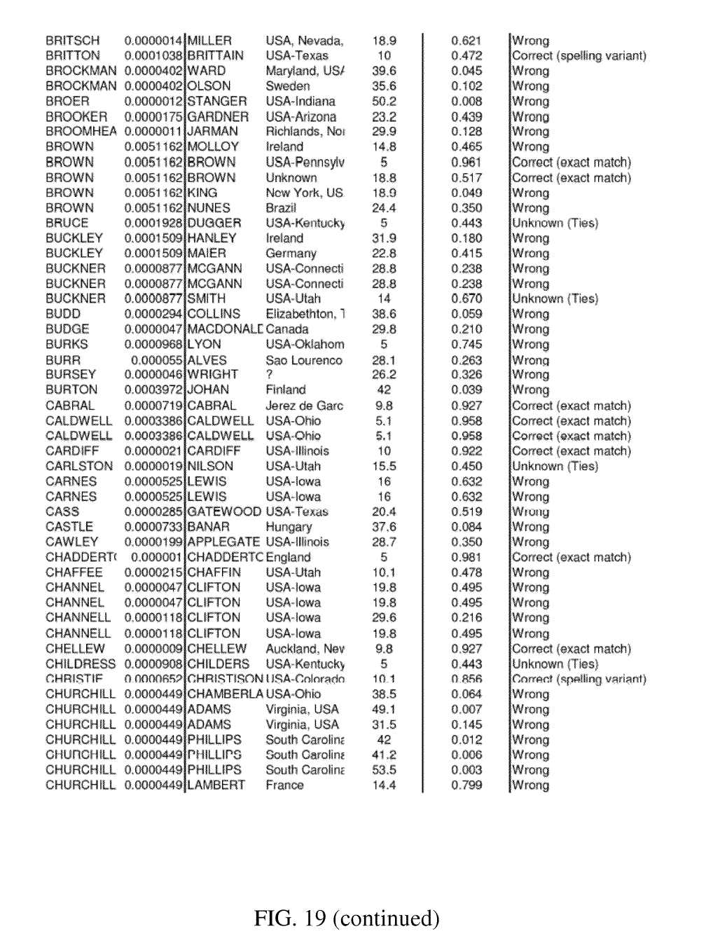

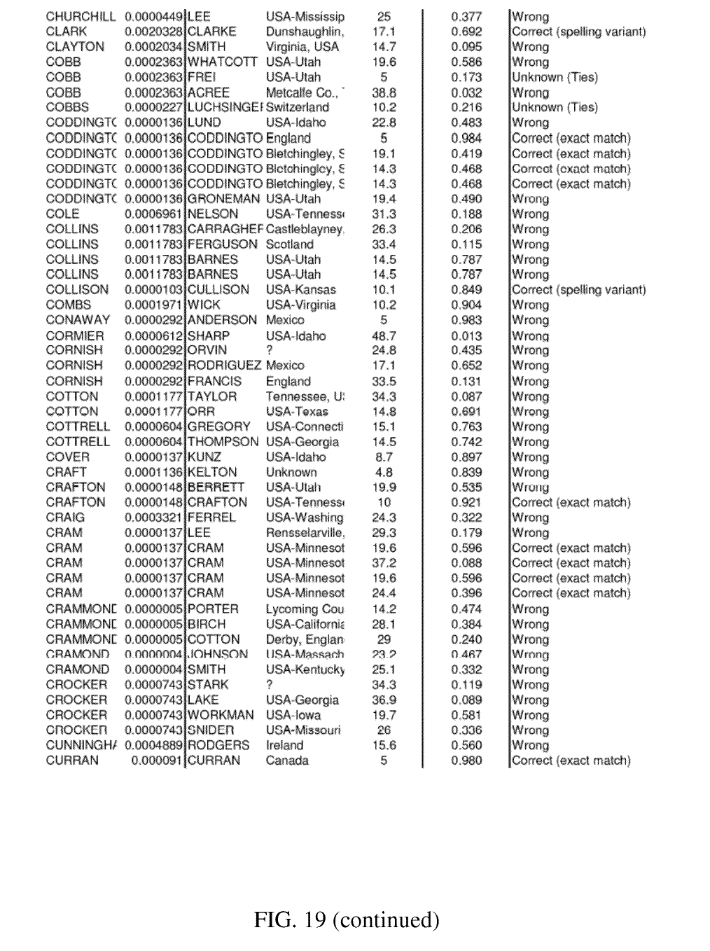

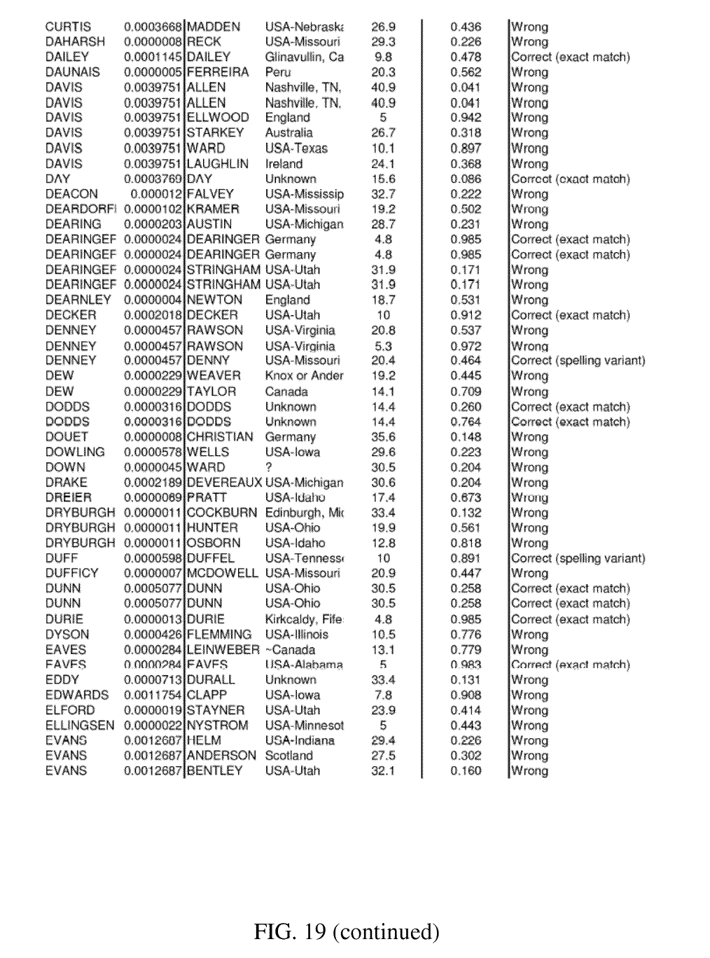

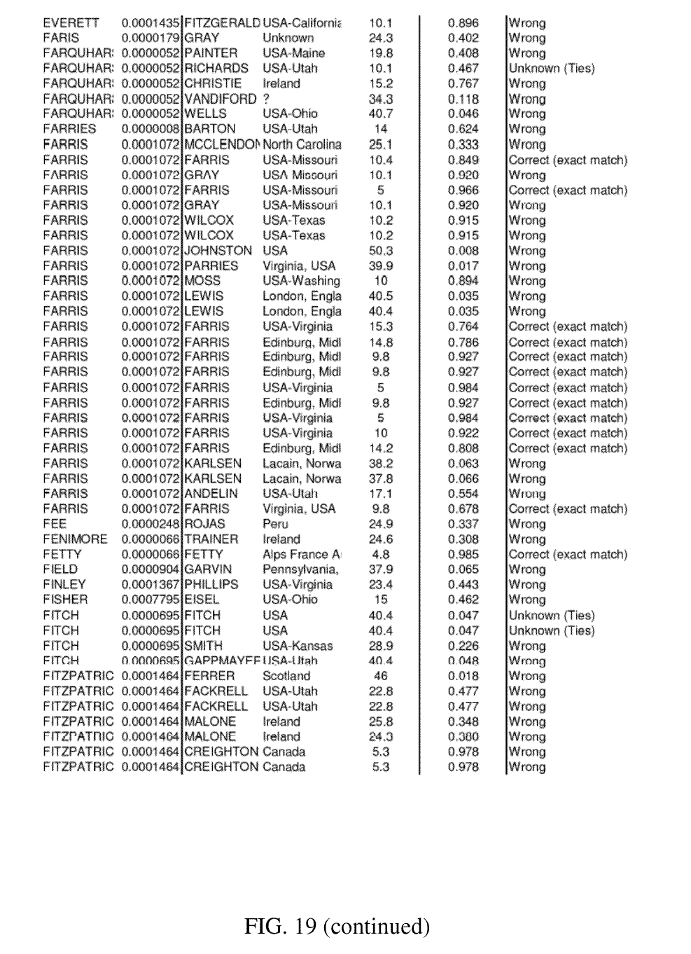

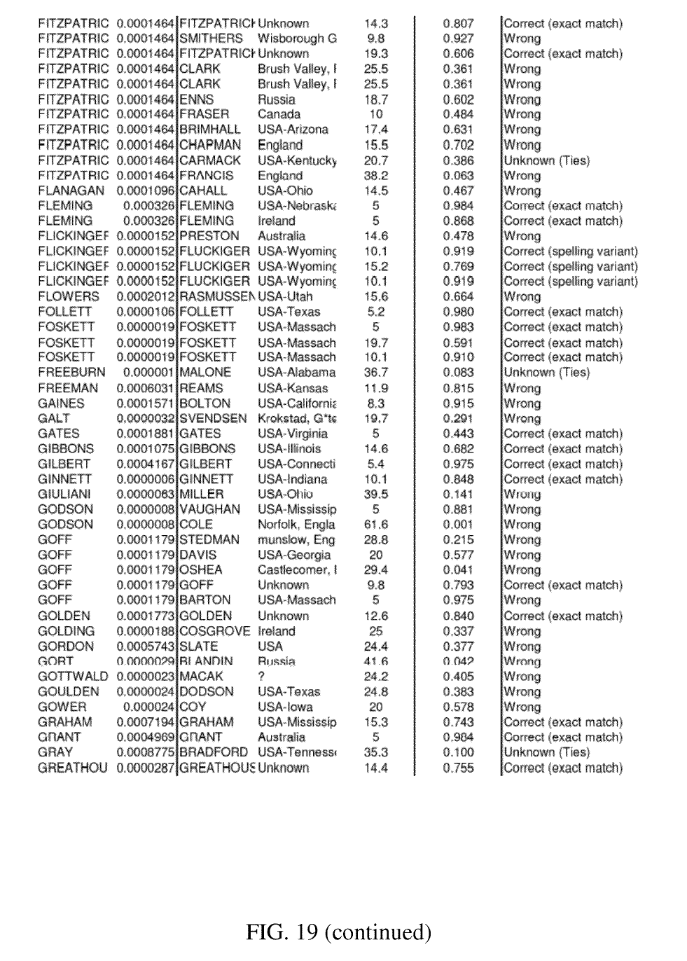

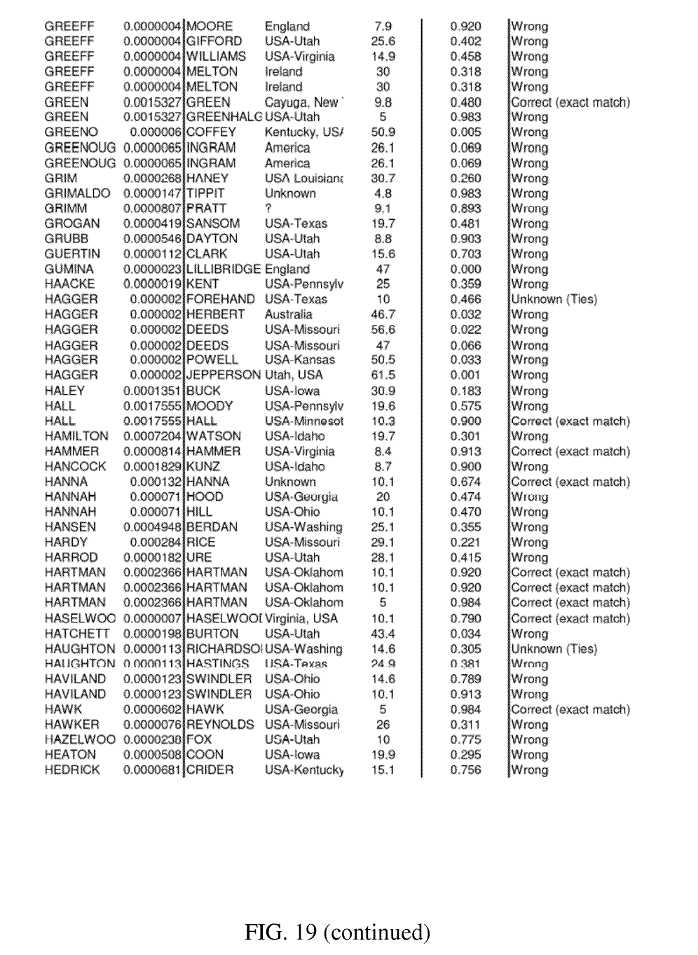

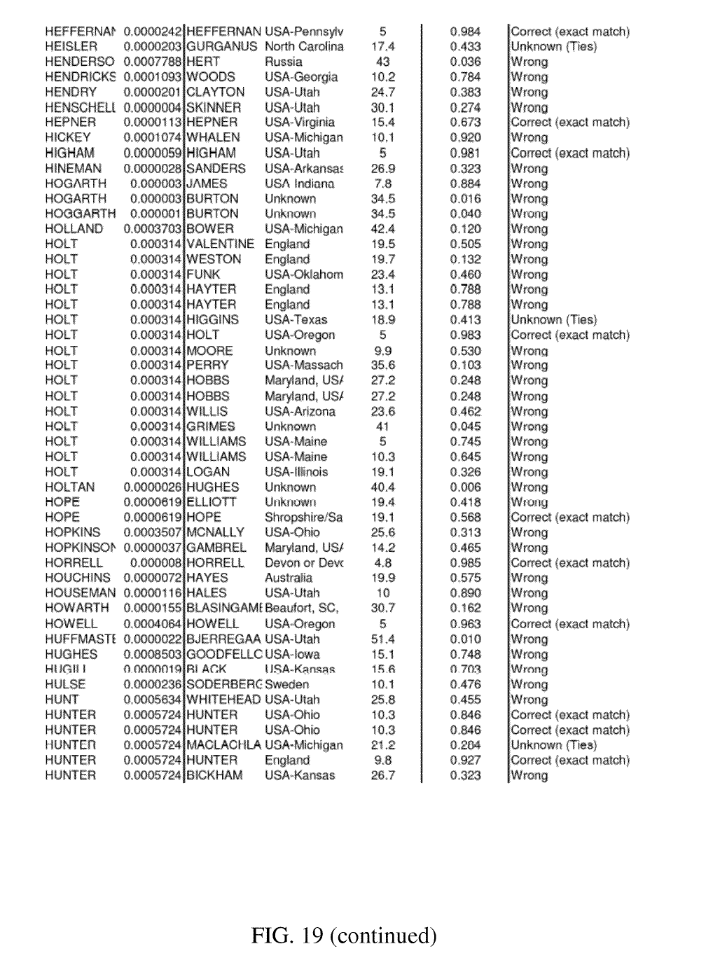

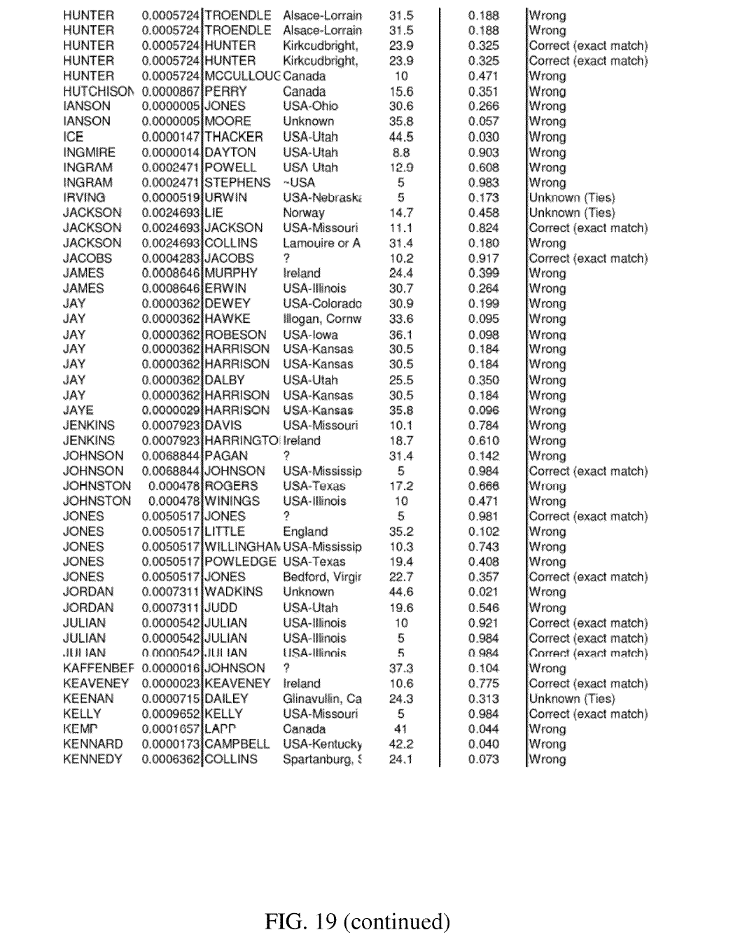

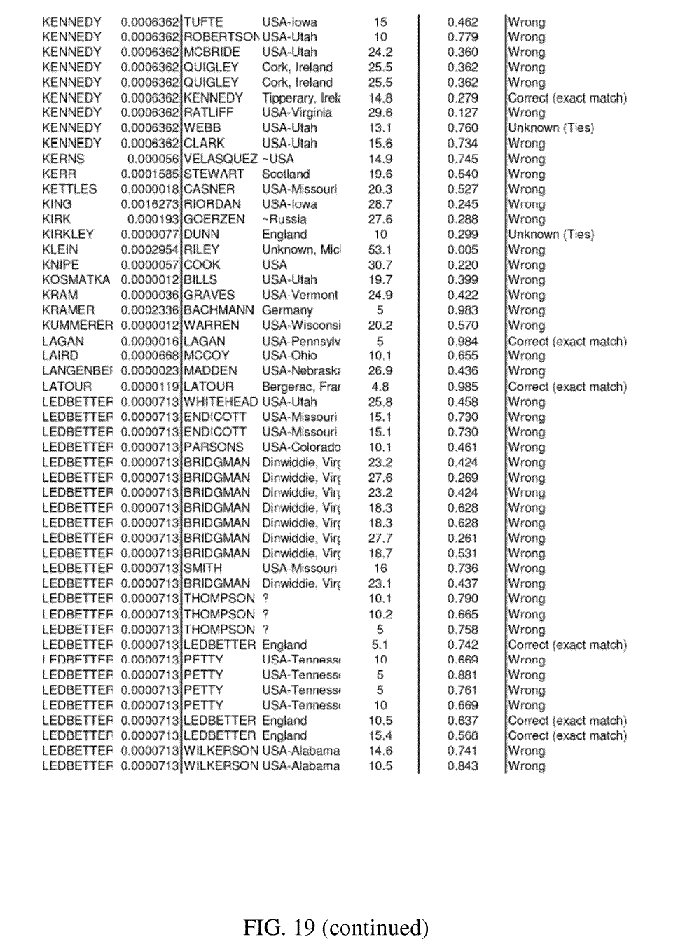

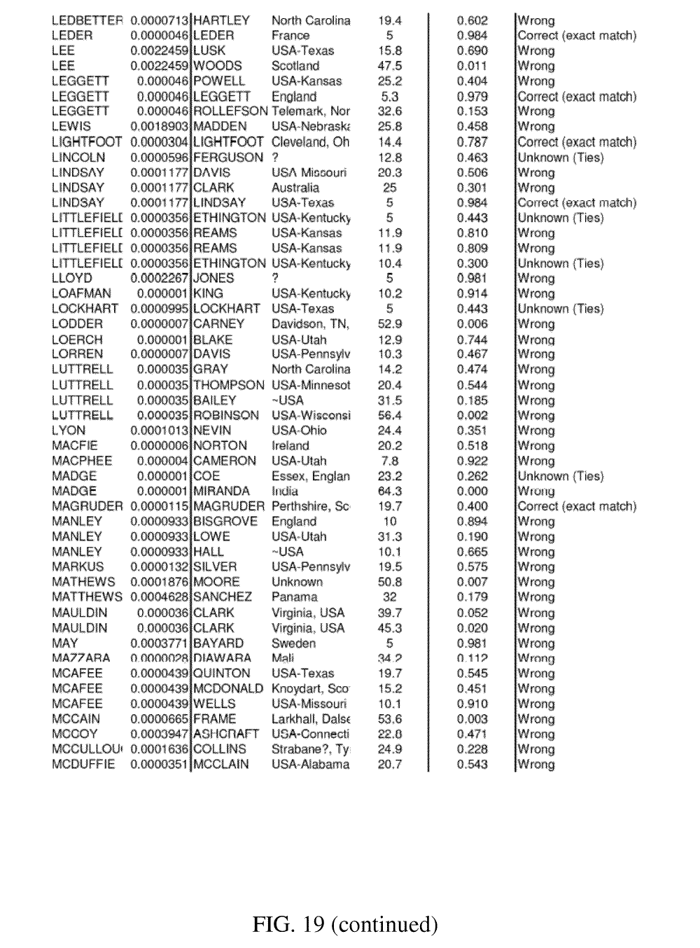

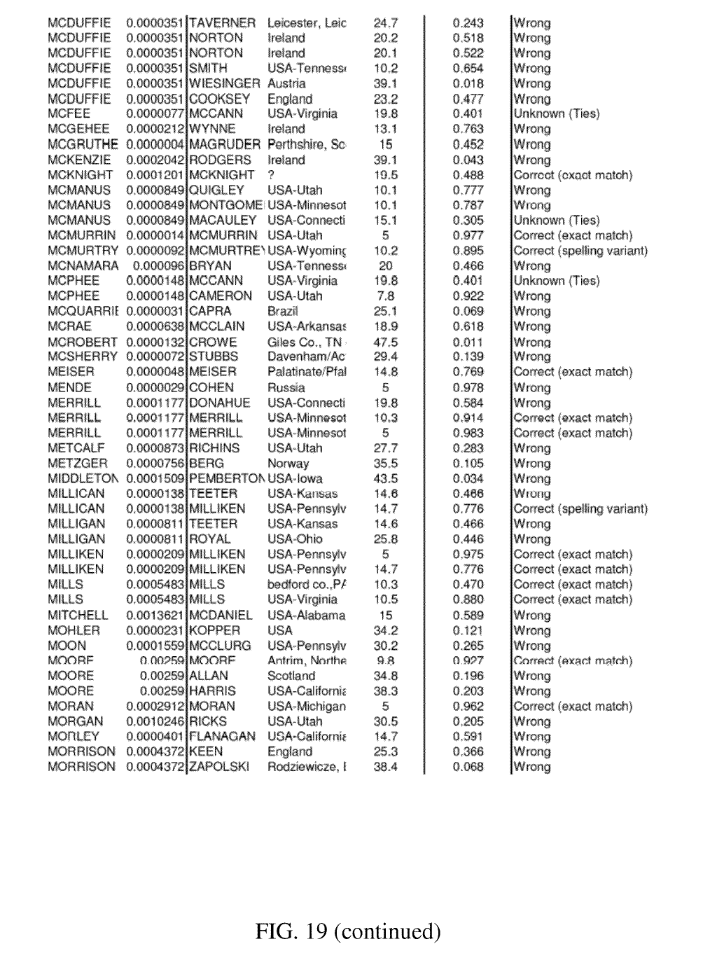

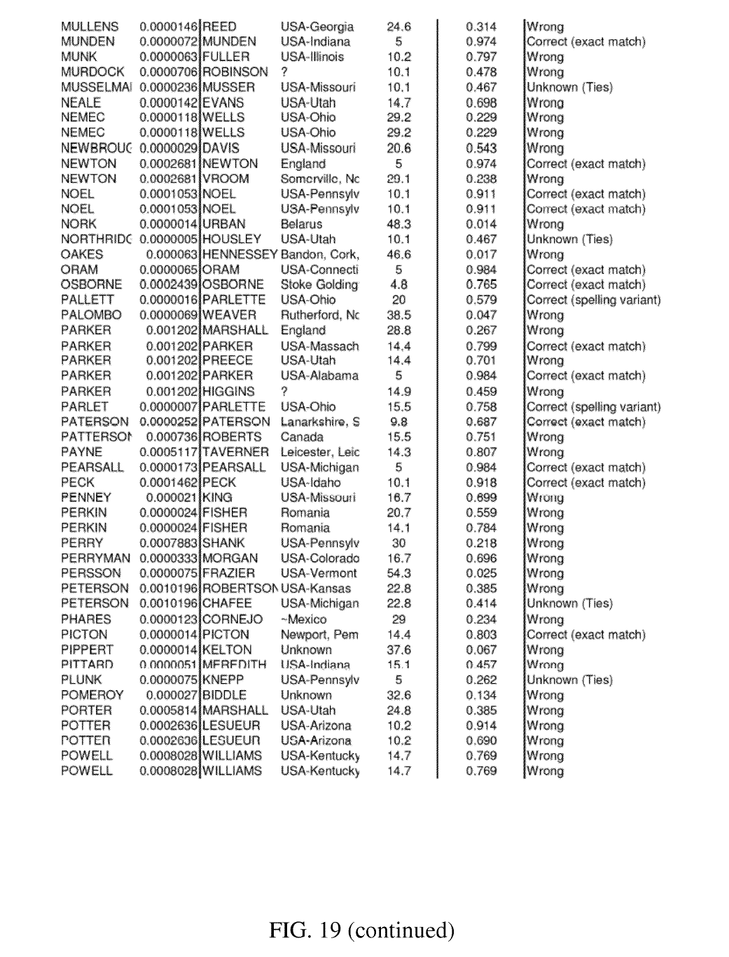

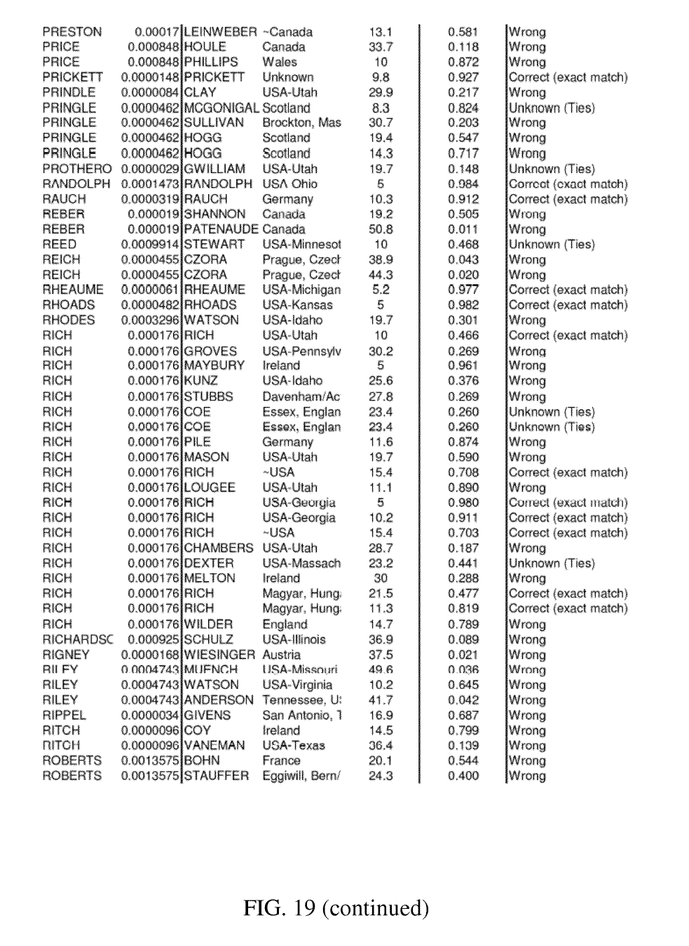

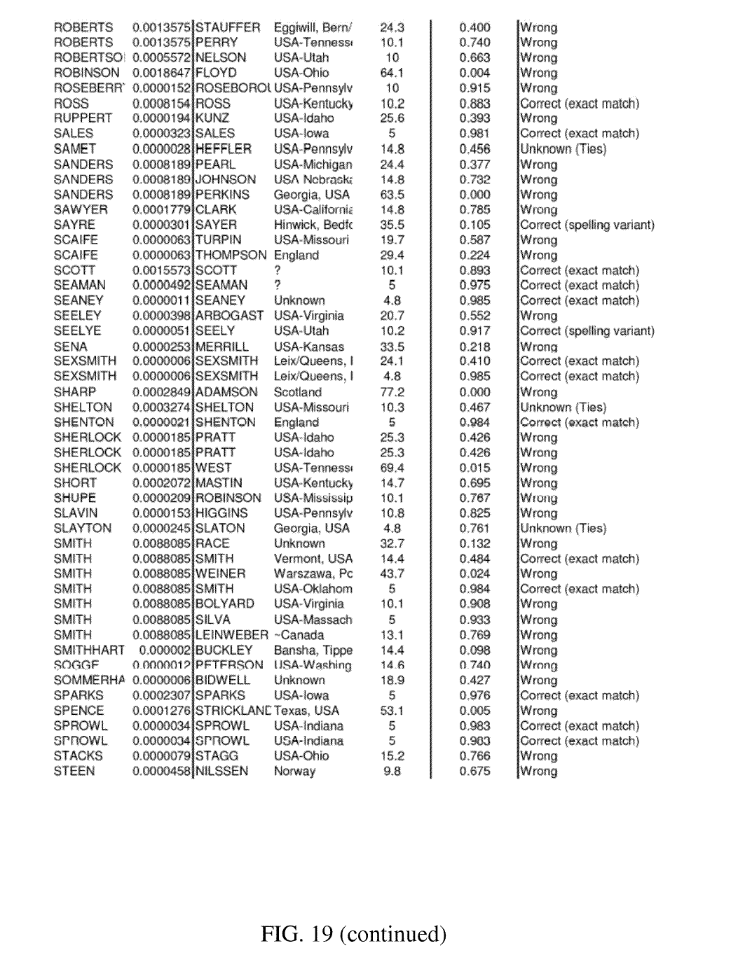

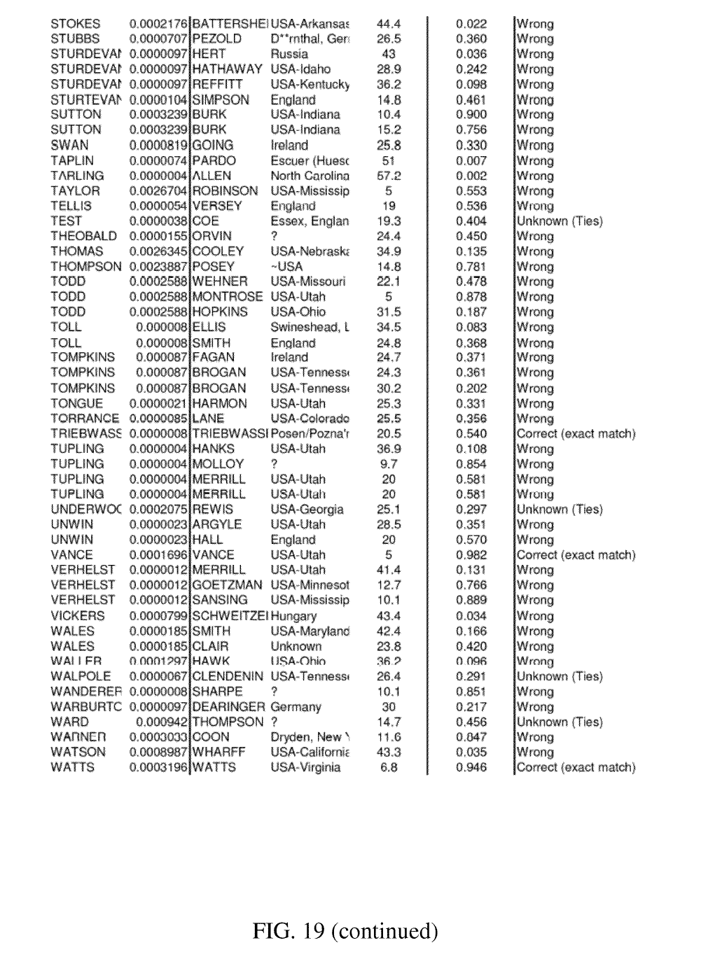

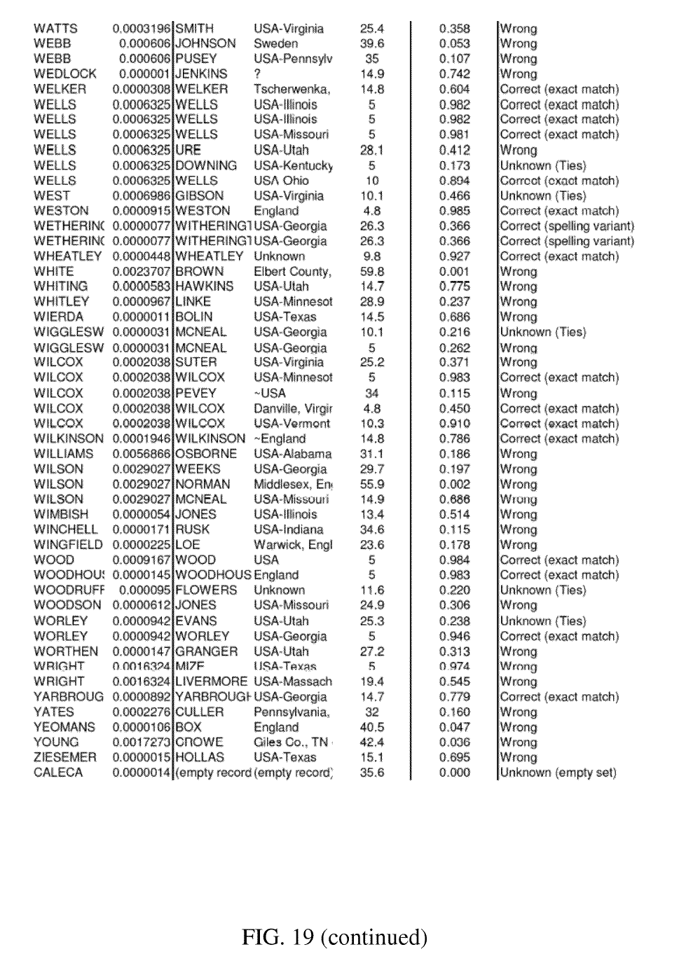

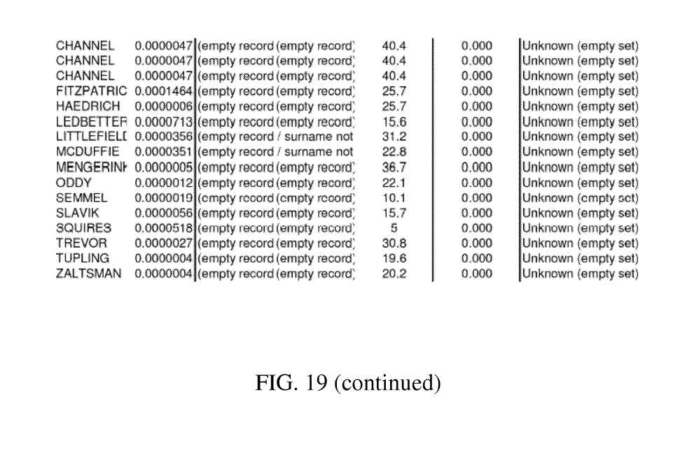

The results of the 911 queries exhibited distinct patterns between the TMRCA of records that exactly match the true surname, records with a spelling variant, and records that returned the wrong surnames (FIG. 16). A mean TMRCA was 10.3 generations for exact matches, 15.6 generations for a spelling variant, and 24.3 generations for wrong surnames. A TMRCA distribution of exact matches appeared to follow a geometric distribution trend. The TRMCA of records with spelling variants was almost never more recent than 10 generations and was quite different from the distribution of wrong matches. FIG. 18 shows final results after processing the results according to the equation 13.

Thus, the results were weighed using a stratified sampling approach to reflect the frequency of surnames in the U.S. population. The analysis demonstrated a success rate of approximately 12% (SD=2%) in recovering surnames of U.S. Caucasian males (FIGS. 17 and 18). This rate may be achieved with a conservative threshold that would return a wrong surname in 5% of cases and label 83% of cases as unknown. Higher success rates of up to 18% may be achieved at the price of increased probability to recover an incorrect surname.

The Frequency Distribution of Recovered Surnames

A frequency distribution of recovered surnames from YBase simulations was determined using the following equation:

$$P ( s ∈ {𝕊}_{i} \vert x = success , δ ) = \frac{P ( x = success \vert s ∈ {𝕊}_{i} , δ ) P ( s ∈ {𝕊}_{i} )}{P ( x = success \vert δ )} \qquad ( 14 )$$

Where [symbol] i is a subset of surnames whose frequencies fall in the i-th bin out of j possible bins. Specifically, the following bins were used:

| Bin (i) | Frequency boundaries | Example of surnames in bin |
|---|---|---|
| 1 | >1:400 | Smith, Johnson |
| 2 | 1:400-1:4,000 | Turner, Collins |
| 3 | 1:4,000-1:40,000 | Gates, Sloan |
| 4 | 1:40,000-1:400,000 | Bjork, Reach |
| 5 | <1:400,000 | Kellog, Venter |

The term P(sε [symbol] i) in the equation 14 is given by the census data. The other numerator term can be approximated using a slight modification to the equation 14 as follows:

$$\hat{P} ( x = success \vert s ∈ {𝕊}_{i} , δ ) = \frac{{\sum }_{s ∈ 𝕊} {\hat{f}}_{s} {\hat{β}}_{x} ( s )}{{\sum }_{s ∈ 𝕊} \hat{f} s} {c}_{i} + \frac{{\sum }_{s ∈ \overline{𝕊}} {\hat{f}}_{s} {\hat{β}}_{x} ( s )}{{\sum }_{s ∈ \overline{𝕊}} \hat{f} s} ( 1 - {c}_{i} ) \qquad ( 15 )$$

Where cᵢ is a normalization factor that denotes the probability that a random person from the US population whose surname is in the i-th bin has at least a single entry in Ysearch and SMGF. In this example, cᵢ was determined by intersecting the census data with the list of Ysearch and SMGF; δ=0.82 was used by way of example only.

Surname Recovery Using Craig Venter Dataset

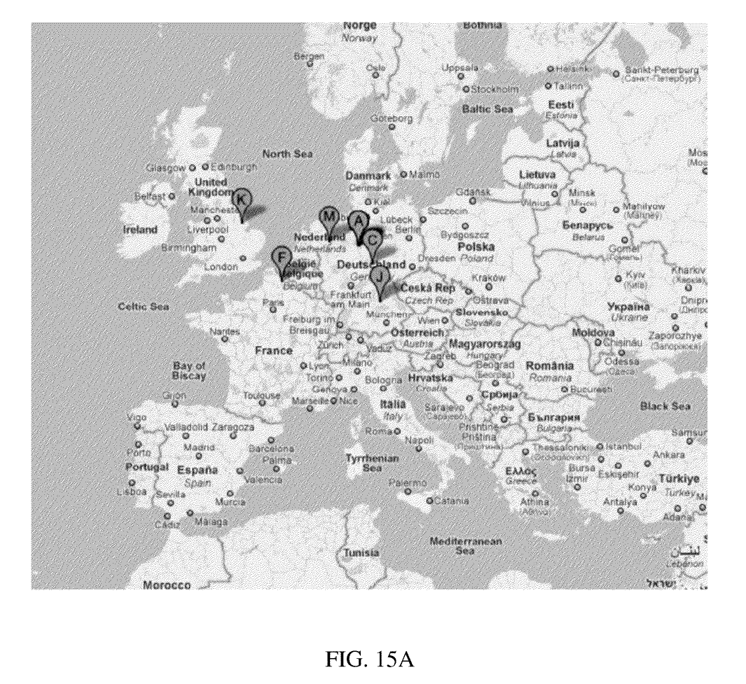

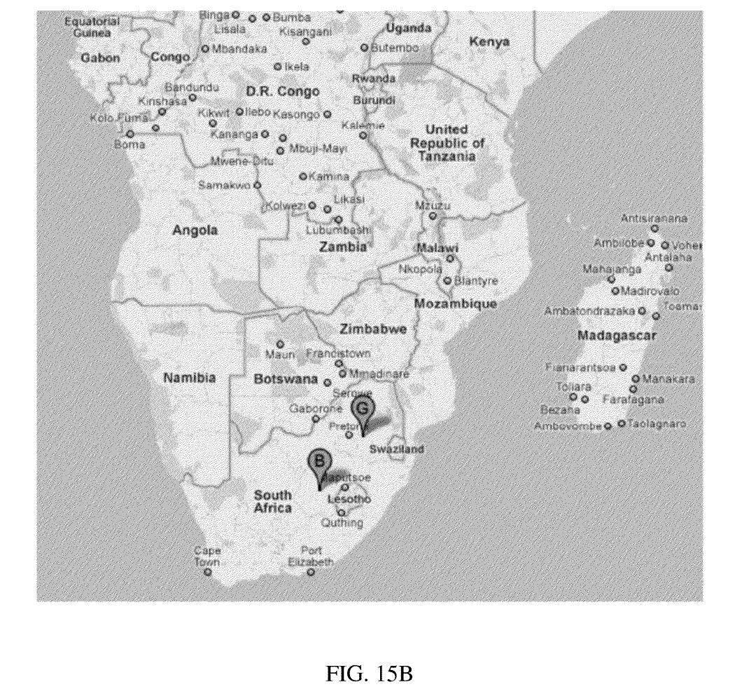

To analyze a feasibility of surname recovery from personal genome datasets, Craig Venter's genome was examined and his Y chromosome haplotype was identified using lobSTR. lobSTR recovered the genotypes of 41 Y-STR markers. A search using the Ysearch database returned “Venter” as the top match, as shown in FIG. 14 and Table S2. Concordant with Craig Venter's paternal roots (Levi et al., 2007), the top match was the only Venter record in the Ysearch database with a UK ancestor. The algorithm did not return any of the other dozen Venter entries with ancestors mostly from Germany and South Africa (FIGS. 15a-b and Table S3).

Sequence reads for the Venter genome were downloaded from TraceDB (Genbank accession ABBA00000000). First 50 bp of every read were trimmed due to possible errors at the beginning of Sanger sequence reads, and read having a length of less than 100 bp after trimming were excluded from a further analysis.

At the default settings, lobSTR returned 41 Y-STRs after 27 minutes of runtime using 30 processors on a server with four 12-core AMD Opteron™ 6100 Series. Markers returning a non-integer number of repeat copies were discarded. Querying the Ysearch database returned the entry VPBT4 with surname “Venter” from Lincolnshire, England as the top hit. The results, including the trace numbers of supporting reads, are summarized in Table S1.

TABLE S1

| | | Number | | | |
|---|---|---|---|---|---|
| Database | Link | of records | Maintained by: | Location | Remarks |
| Ysearch | www.ysearch.org | 105,000* | Family Tree | USA | |
| | | | DNA | | |
| Ancestry DNA | www.dna.ancestry.com | 50,000^{†} | Ancestry.com | USA | |
| SMGF | www.smgf.org/pages/ | 38,000* | Sorenson | USA | |
| | ydatabase.ispx | | Molecular | | |
| | | | Genealogy | | |
| | | | Foundation | | |
| YBase | www.ybase.org | 13,000^{†} | DNA heritage | USA | Discontinued. |
| | | | | | Recently |
| | | | | | acquired by |
| | | | | | Family Tree |
| | | | | | DNA |
| WorldFamilies | www.worldfamilies.net/ | ? | Collection of | USA | Mainly |
| | surnames | | admins of | | FTDNA users |
| | | | surname | | |
| | | | projects | | |
| Oxford | www.oxfordancestors. | ? | Oxford | UK | |
| Ancestors | com/ | | Ancestors | | |
| Family Tree | www.familytreedna. | 250,000* | Family Tree | USA | Closed |
| DNA | com/ | | DNA | | database. |

List of major genetic genealogy databases.

TABLE S2

| | | Craig | Best | Supporting reads |
|---|---|---|---|---|
| | Marker | Venter | Ysearch hit | (Genebank numbers) |
| 1 | DYS385b | 14 | 14 | [symbol] [symbol] |
| 2 | DYS388 | 12 | 12 | [symbol] [symbol] |
| 3 | DYS391 | 10 | 10 | [symbol] [symbol] |
| 4 | DYS392 | 13 | 13 | [symbol] [symbol] |
| 5 | DYS413a | 23 | 23 | [symbol] [symbol] |
| 6 | DYS426 | 12 | 12 | [symbol] [symbol] |
| 7 | DYS436 | 12 | 12 | [symbol] [symbol] |
| | | | | [symbol] [symbol] |
| | | | | [symbol] [symbol] |
| | | | | [symbol] [symbol] |
| 8 | DYS438 | 12 | 12 | [symbol] [symbol] |
| 9 | DYS439 | 12 | 12 | [symbol] [symbol] |
| 10 | DYS442 | 12 | 12 | [symbol] [symbol] |
| 11 | DYS449 | 30 | 30 | [symbol] [symbol] |
| 12 | DYS454 | 11 | 11 | [symbol] [symbol] |
| | | | | [symbol] [symbol] |
| | | | | [symbol] [symbol] |
| | | | | [symbol] [symbol] |
| | | | | [symbol] [symbol] |
| 13 | DYS455 | 11 | 11 | [symbol] [symbol] |
| 14 | DYS458 | 17 | 17 | [symbol] [symbol] |
| | | | | [symbol] [symbol] |
| | | | | [symbol] [symbol] |
| | | | | [symbol] [symbol] |
| 15 | DYS461 | 12 | | [symbol] [symbol] |
| 16 | DYS462 | 11 | | [symbol] [symbol] |
| 17 | DYS472 | 8 | 8 | [symbol] [symbol] |
| | | | | [symbol] [symbol] |
| | | | | [symbol] [symbol] |
| | | | | [symbol] [symbol] |
| 18 | DYS481 | 22 | 22 | [symbol] [symbol] |
| | | | | [symbol] [symbol] |
| | | | | [symbol] [symbol] |
| 19 | DYS485 | 16 | | [symbol] [symbol] |
| | | | | [symbol] [symbol] |
| 20 | DYS494 | 9 | | [symbol] [symbol] |
| 21 | DYS495 | 16 | | [symbol] [symbol] |
| 22 | DYS531 | 12 | 12 | [symbol] [symbol] |
| | | | | [symbol] [symbol] |
| 23 | DYS534 | 16 | 16 | [symbol] [symbol] |
| 24 | DYS537 | 10 | 10 | [symbol] [symbol] |
| 25 | DYS549 | 12 | | [symbol] [symbol] |
| 26 | DYS556 | 11 | | [symbol] [symbol] |
| 27 | DYS557 | 16 | 16 | [symbol] [symbol] |
| 28 | DYS565 | 12 | 12 | [symbol] [symbol] |
| 29 | DYS568 | 11 | 11 | [symbol] [symbol] |
| | | | | [symbol] [symbol] |
| | | | | [symbol] [symbol] |
| 30 | DYS570 | 17 | 17 | [symbol] [symbol] |
| | | | | [symbol] [symbol] |
| | | | | [symbol] [symbol] |
| 31 | DYS578 | 9 | 9 | [symbol] [symbol] |
| | | | | [symbol] [symbol] |
| 32 | DYS590 | 9 | 9 | [symbol] [symbol] |
| | | | | [symbol] [symbol] |
| 33 | DYS594 | 10 | 10 | [symbol] [symbol] |
| | | | | [symbol] [symbol] |
| 34 | DYS617 | 12 | 12 | [symbol] [symbol] |
| | | | | [symbol] [symbol] |
| 35 | DYS636 | 11 | | [symbol] [symbol] |
| 36 | DYS638 | 11 | | [symbol] [symbol] |
| 37 | DYS640 | 11 | 11 | [symbol] [symbol] |
| 38 | DYS641 | 10 | 10 | [symbol] [symbol] |
| 39 | DYS714 | 25 | | [symbol] [symbol] |
| 40 | TCAIIa | 19 | 19 | [symbol] [symbol] |
| 41 | TCAIIb | 23 | 23 | [symbol] [symbol] |

Craig Venter's haplotype from his personal genome versus the best match. Only Ysearch markers with corresponding sequencing results are shown. [symbol]
indicates data missing or illegible when filed

TABLE S3

| User | Ancestor | |
|---|---|---|
| surname | surname | Origin |
| Venter | Von Dempter | Hameln, Germany |
| Venter | Venter | Bloemfontein, South Africa |
| Venter | Venter | Germany |
| Venter | von Dempter | Hamelin, Lower Saxony/Niedersachsen, |
| | | Germany |
| Venter | Von Dempter | Hameln, Lower Saxony/Niedersachsen, |
| | | Germany |
| Venter | Venter | Hamel, France |
| Venter | Venter | Witbank, South Africa |
| Venter | Von Dempter | Hameln, Germany |
| Venter | Venter | Hamln, Germany |
| Venter | Venter | Roth near Meisenheim, Palatinate/Pfalz, |
| | | Germany |
| Venter | | Lincolnshire, England |
| Venter | Venter | Hameln, Lower Saxony/Niedersachsen, |
| | | Germany |
| Venter | van Deventer | Oldenzee, Netherlands |

Venter records in Ysearch and their ancestral origins. In red - the top match to Craig Venter's Genome.

### Results

Comparing lobSTR to Mainstream Aligners

lobSTR's alignment performance was benchmarked with reads from an Illumina® whole genome sequencing library with 101 bp reads. To demonstrate its added value for STR profiling over mainstream aligners, BWA, Novoalign, and Bowtie were also applied to the same input data with and without the GATK local indel realignment tool. In addition, BLAT (Kent 2002) was used to characterize STR alignment by a tool that is centered on sensitivity rather than speed. BWA and Novoalign were tested with the default parameters that can detect up to 5 bp and 7 bp indels, respectively. Bowtie has no indel tolerance and was evaluated as a control condition with tolerance of up to two mismatches. BLAT was tested with the default parameters that can tolerate up to 10% divergence from the reference, which corresponds to approximately 10 bp indels. To focus on the pure algorithm speed-up, all tests were executed on a single CPU.

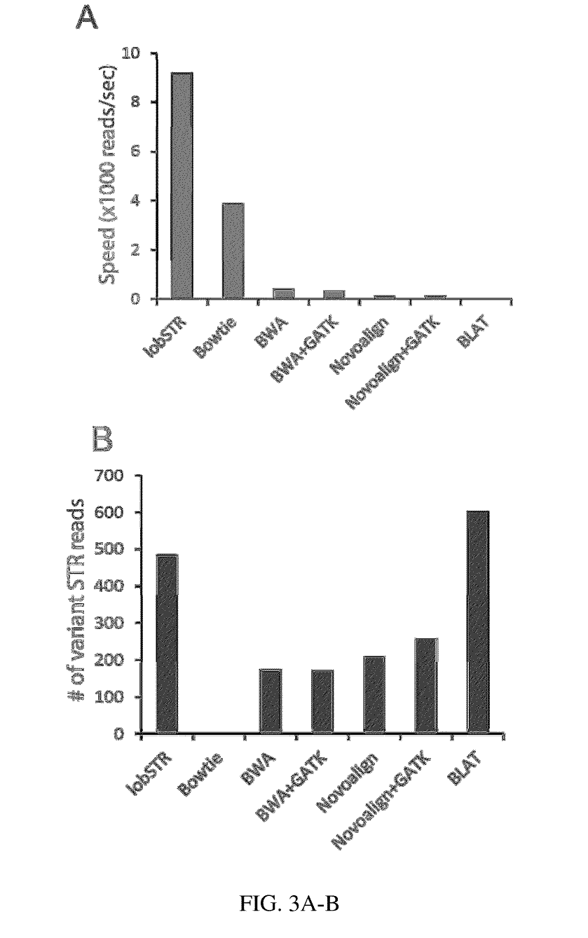

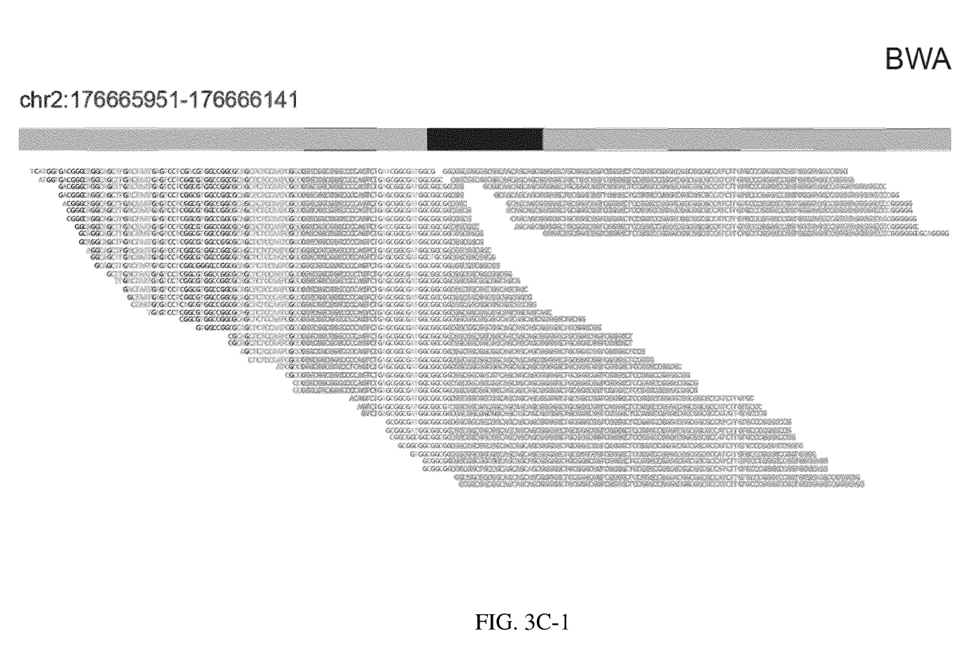

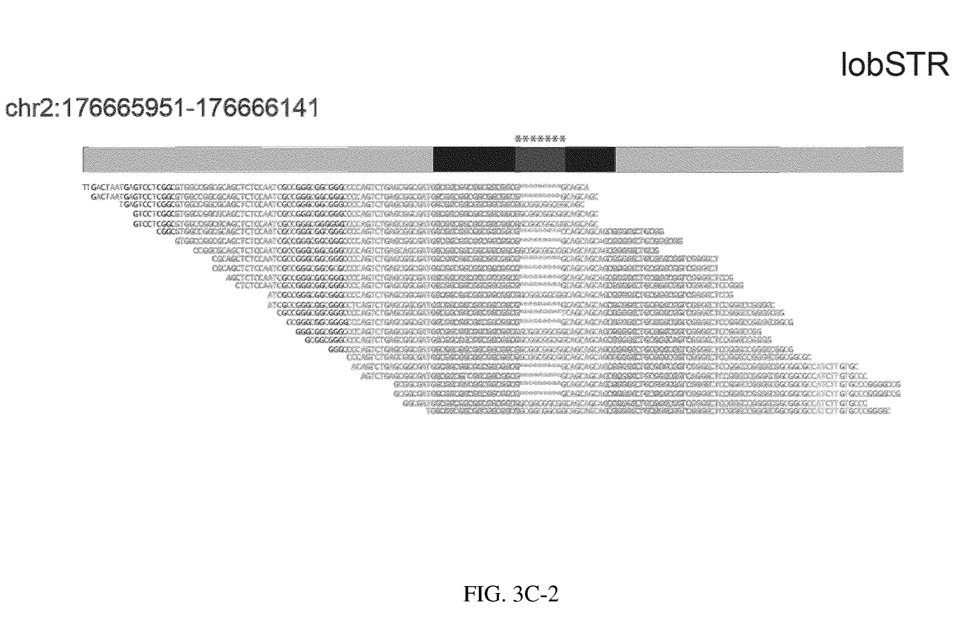

lobSTR performed well in all the parameters required for efficient STR alignment (Table 1). First, lobSTR processed the reads 2.2 times faster than Bowtie, 22 times faster than BWA, 70 times faster than Novoalign, and almost 1000 times faster than BLAT (FIG. 3A). These results indicate that there is a minimal computational payment in running lobSTR in parallel to mainstream aligners in order to augment variation calling to include STR polymorphisms. Second, as required, lobSTR reported only informative reads that fully encompass STR loci. On the other hand, the mainstream aligners reported between 2,000 to 5,000 non-informative STR reads per million input sequences, which may confound downstream calling algorithms if not removed. Third, lobSTR detected the largest number of informative reads with STR variations compared to mainstream aligners (FIG. 3B). The other aligners showed a strong tendency to report STR reads with the reference allele vis-à-vis with their indel tolerance. Bowtie did not report any STR variation. After GATK local realignment, BWA and Novoalign, respectively, reported that 20% and 25% of the informative reads have STR variations. BLAT reported that 37% of the informative reads have STR variations, compared to 50% in lobSTR. Analyzing data collected from a large number of randomly ascertained STR loci (Utah Marker Development Group, 1995; Payseur et al., 2011(Payseur et al., 2011) demonstrates that 33-66% of STR sequence reads should exhibit a non-reference allele. This suggests that lobSTR's results are more representative of the true rate of STR variations than mainstream alignment tools.

TABLE 1

| | Indel | | # Non- | | | | Peak |
|---|---|---|---|---|---|---|---|
| | tolerance | Time | informative | # Informative | # Var. | | memory |
| Algorithm | (bp) | (sec) | reads | reads | reads^{a} | Ratio^{b} | (Gbyte) |
| lobSTR | — | 109 | 0 | 973 | 485 | 0.5 | 0.3 |
| Bowtie | 0 | 258 | 2,193 | 523 | 0 | 0 | 2.2 |
| BWA | 5 | 2,450 | 3,026 | 883 | 174 | 0.19 | 2.5 |
| BWA + GATK | 5 | 2,943 | 2,691 | 869 | 172 | 0.20 | 2.5 |
| Novoalign | 7 | 7,601 | 4,947 | 1,024 | 208 | 0.2 | 13.8 |
| Novoalign + GATK | 7 | 8,123 | 4,906 | 1,047 | 259 | 0.25 | 13.8 |
| BLAT | 10 | 108,862 | 19,919 | 1,611 | 602 | 0.37 | 3.7 |

Reporting STR reads with non-reference alleles is crucial for profiling pathogenic mutations. It was further determined whether lobSTR can correctly detect disease alleles of dominant trinucleotide repeat expansion disorders. As test cases, two conditions that can be theoretically profiled using standard Illumina® runs were used. The first condition was a GCN expansion in PABPN1 that causes oculopharyngeal muscular dystrophy (OPMD) (Brais et al., 1998), where the normal allele exhibits 10 repeats and the pathogenic allele spectrum for the dominant form is between 12 to 17 repeats (Pearson et al., 2005). The second condition was a GCG expansion in HOXD13 that is implicated in synpolydactyly (Muragaki et al., 1996), a severe limb malformation, where the normal allele is 15 repeats and the documented pathogenic allele spectrum is between 22-29 repeats (Pearson et al., 2005). To simulate each condition, 100 reads of length 101 bp were generated that were equally sampled from the disease locus consisting of a normal and pathogenic allele with 100 bp flanking upstream and downstream regions with 1% sequencing error rate. For both simulated disease conditions, lobSTR accurately aligned the normal and pathogenic reads to the correct location in the genome. All aligned reads were informative and the allelotyping step correctly assigned a heterozygous state to the disease loci with the correct repeat lengths: (10,15) for PABPN1 and (15, 22) for HOXD13. In stark contrast, BWA failed to correctly align reads from the pathogenic alleles of both loci. Only reference reads were reported (FIG. 3C).

Measuring lobSTR Concordance Using Biological Replicates

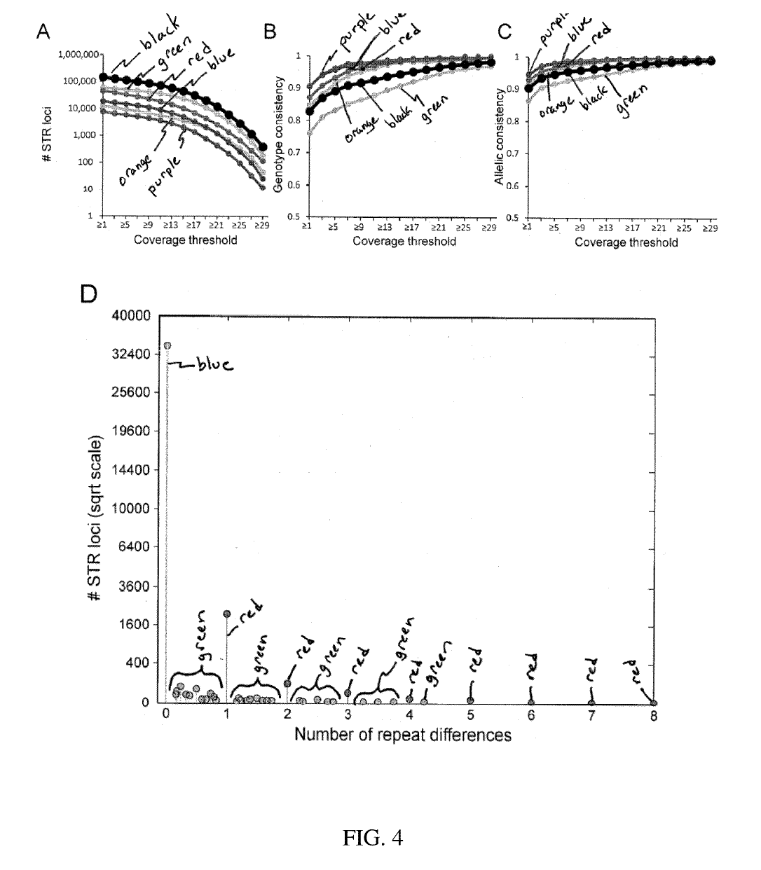

To explore the precision of lobSTR, the genome-wide STR profiling of blood and saliva samples from the same individual was conducted (Lam et al., 2012). These samples were sequenced using Illumina® HiSeq2000 with 101 bp PE to a mean autosomal coverage of 50× and 102×, respectively. lobSTR ran with default parameters on 20 CPUs and analyzed the two datasets within 12 and 22 hours respectively. After filtering loci with low quality calls, 143,793 shared STRs were covered in the two datasets with at least one read and 79,771 STRs were covered with 10 reads or more (FIG. 4A).

The rate of discordant autosomal calls between the two samples was quantified. The genotype discordance rate and the allelic discordance rate were measured (Pompanon et al., 2005). The former reports as an error any mismatch between corresponding calls, whereas the latter reports only the fraction of discordant alleles in corresponding calls. For example, consider a locus that is called (A,B) in the saliva sample and (A,C) in the blood sample. This locus shows a single genotype discordance, but only 0.5 allelic discordance, since the A allele was correct.

Both types of error greatly diminished with sufficient coverage (FIGS. 4B and 4C). At 5× coverage, the genotype discordance rate was 11% and the allelotype discordance was 5%; At 21× coverage, the genotype discordance rate was 3% and the allelotype discordance rate was 2%. Similar to STR studies with capillary platforms (Weber and Broman 2001), most of the errors were generated in dinucleotide STR loci, whereas other types of STRs showed moderate and similar error rates. The dinucleotide error rates presumably stem from two factors: first, these loci usually show the highest heterozygosity rates (Chakraborty et al., 1997; Brinkmann et al., 1998; Pemberton et al., 2009). Therefore, they require on average more sequence reads to be correctly called. Second, dinucleotide STRs are more prone to stutter noise (Ellegren 2004a) and their higher error rates might be due to residual noise after lobSTR stutter deconvolution.

The STR length differences in discordant calls were further analyzed. To avoid analyzing errors that are simply due to allele drop-outs, discordant calls that were both heterozygous in blood and saliva were analyzed. At a coverage of >5×, more than 90% of the errors showed a single repeat unit difference and 99% of the errors were within two repeat units (FIG. 4D). This indicates that incorrect alignment of STRs has a minimal effect on allelotyping results, and that stutter is likely the main source of noise. It was also found that only 0.8% of calls at heterozygous loci showed a difference due to an incomplete repeat unit. This highlights that lobSTR can determine STR alleles at a single base-pair resolution.

Tracing Mendelian Inheritance Using lobSTR

To further explore lobSTR performance, conducted a genome-wide STR profiling of a HapMap trio—a father (NA12877), mother (NA12878), and son (NA12882)—from the CEU population that were sequenced using 100PE reads on a HiSeq2000 was conducted (Table 2). The average autosomal coverage was 50× and average STR coverage was 14×. At ≧10× coverage threshold, 57% of the STRs in the CEU trio had a non-reference allele.

TABLE 2

| | | | STR | Mean |
|---|---|---|---|---|
| | | | Aligned | STR |
| Individual | Relationship | Input reads | reads | Coverage |
| NA12878 | Mother | 1,708,169,546 | 3,398,933 | 14.8 |
| NA12877 | Father | 1,637,816,924 | 3,212,073 | 14.1 |
| NA12882 | Son | 1,625,404,856 | 3,183,795 | 14.0 |

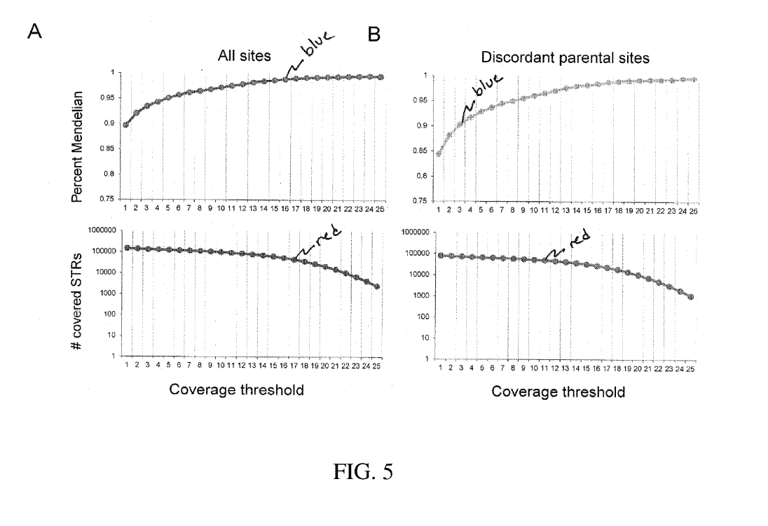

In general, deviations of offspring's STR alleles from Mendelian inheritance (MI) indicate a potential calling error (Ewen et al., 2000). With 5× coverage across all trio members, the MI rate was 95%; with 10× coverage, MI was 97%; and with coverage threshold of 15 or more, MI was 99%. (FIG. 5A). The analysis was also repeated only with discordant parental sites (for example, A/B call in one parent and A/C call in another parent). A drop to 93% in the MI patterns with a low coverage threshold of 5× was observed, which is mainly because of partial coverage of heterozygous sites in the parents. The MI rate was recovered to the same level with higher coverage threshold. At 17× coverage 99% of sites showed a perfect Mendelian segregation pattern (FIG. 5B).

Validating lobSTR Accuracy with DNA Electrophoresis

lobSTR performance was compared to the results of DNA electrophoresis, which is considered the gold standard for STR allelotyping. First, a set of STR markers that are used for forensic DNA fingerprinting was analyzed. As an input for lobSTR, a male genome was sequenced with three runs of IIlumina® GAIIx for 101PE cycles that yielded ˜740 million reads. The autosomal sequencing coverage was 36× according to alignment with mainstream algorithms. lobSTR identified 1.6 million informative reads that mapped to ˜140,000 STR loci, with an average of 4.91× coverage of diploid STR loci. In parallel, a commercial forensic kit was used to genotype 14 autosomal STR markers on a capillary electrophoresis platform. Thirteen out of 14 markers were covered by at least a single sequence read and 8 markers were covered by at least 3 sequence reads. The marker that was not covered spanned more than 129 bp, exceeding the limit for detecting informative reads with the 101 bp sequence reads.

The inventors observed good concordance between lobSTR and the capillary results (Table 3).

TABLE 3

| STR | lobSTR | Converted | Capillary | | | | |
|---|---|---|---|---|---|---|---|
| locus | (bp) | lobSTR | platform | Hg18 | Repeat | Coverage | Result^{a} |
| D8S1179 | −8/8 | 11/15 | 11/15 | 13 | [TCTA]n | 13 | Y |
| CSF1PO | −12/−4 | 10/12 | 10/12 | 13 | [AGAT]n | 13 | Y |
| TPOX | 0/12 | 8/11 | 8/11 | 8 | [AATG]n | 12 | Y |
| THO1 | 11/11 | 9.3/9.3 | 9.3 | 7 | [AATG]n | 11 | Y |
| D16S539 | 4/12 | 12/14 | 12/14 | 11 | [GATA]n | 5 | Y |
| D7S820 | −20/−8 | 8/11 | 8/11 | 13 | [GATA]n | 3 | Y |
| Penta D | −20/0 | 9/13 | 9/13 | 13 | [AAAGA]n | 3 | Y |
| DS5818 | 0/4 | 11/12 | 11 | 11 | [AGAT]n | 3 | E |
| D3S1358 | −4/−4 | 15/15 | 15/17 | 16 | [TCTN]n | 2 | P |
| Penta E | 25/25 | 10/10 | 10/15 | 5 | [AAAGA]n | 1 | P |
| FGA | −4/−4 | 21/21 | 21/24 | 22 | [TTTC]n | 1 | P |
| D18S51 | −12/−12 | 15/15 | 15 | 18 | [AGAA]n | 1 | Y |
| D13S317 | 4/4 | 12/12 | 11/12 | 11 | [TATC]n | 1 | P |

lobSTR correctly called all but one of the 8 markers that were covered by at least 3 reads and most of the alleles in loci that were covered with 2 or less reads. Remarkably, some of these markers, such as D8S1179, displayed two heterozygous alleles that did not match the reference. Other alleles, such as in Penta D and Penta E, correctly returned 20 bp and 25 bp length differences from the reference allele, respectively. The capillary results of one tetranucleotide marker, THO1, exhibited a non-integer number of copies (9 repeats+3 bp). lobSTR reported exactly the same results, further demonstrating that STRs can be called within a single base pair resolution. lobSTR also correctly called a homozygous STR that was covered by a single read. In another 4 markers with coverage of ≦2×, lobSTR correctly called one allele and missed the other allele due to sequencing coverage. Only a single erroneous call was observed due to stutter noise in the D5S818 locus. This homozygous locus was covered by three sequence reads: two correct and one with a single repeat expansion. With such a low sequencing coverage, the allelotyping algorithm was not able to identify the noisy read and assigned a heterozygous state to the locus.

Next, lobSTR calls made in 12 low-pass sequenced genomes from the Human Genome Diversity Project (HGDP) were evaluated (Green et al., 2010; Reich et al., 2010). Five genomes had coverage of 1.4×-1.9× with 109 bp reads, and the other seven had coverage of 4.8×-7.7× with 77 bp reads (Supplemental Table 3).

SUPPLEMENTAL TABLE 3
HGDP sample coverage and lobSTR results

| | | STR | | |
|---|---|---|---|---|
| | | Aligned | | |
| Sample | Coverage | reads | STRs ≧ 1x | STRs ≧ 3x |
| HGDP00456 (Mbuti Pygmy) | 1.4× | 70,424 | 50,505 | 3,339 |
| HGDP00998 (Karitiana | 1.3× | 65,236 | 48,481 | 2,553 |
| Native American) | | | | |
| HGDP00665 (Sardinian) | 1.5× | 91,157 | 58,623 | 6,215 |
| HGDP00491 (Bougainville | 1.7× | 97,398 | 61,463 | 6,523 |
| Melanesian) | | | | |
| HGDP00711 (Cambodian) | 1.9× | 104,594 | 66,566 | 7,263 |
| HGDP01224 (Mongolian) | 1.7× | 93,938 | 61,356 | 5,767 |
| HGDP00551 (Papuan) | 1.6× | 94,540 | 61,486 | 6,036 |
| HGDP00521 (French) | 5.9× | 184,437 | 91,813 | 17,855 |
| HGDP01029 (San) | 7.7× | 192,798 | 93,376 | 18,928 |
| HGDP00542 (Papuan) | 5.9× | 118,232 | 72,654 | 7,065 |
| HGDP00927 (Yoruba) | 4.8× | 155,136 | 84,828 | 12,774 |
| HGDP00778 (Han) | 5.0× | 141,522 | 80,631 | 10,815 |

One hundred and ninety five STRs with equivalent entries in the lobSTR reference have been genotyped in these genomes using DNA electrophoresis as part of the CEPH-HGDP panel (Ramachandran et al., 2005; Pemberton et al., 2009). Combining lobSTR results from all datasets gave 59 comparable markers with coverage of 3-5 reads with a median coverage of 3× (Supplemental Table 4).

SUPPLEMENTAL TABLE 4
Comparison of lobSTR allelotype calls to the CEPH−HGDP results.
Differences between the RefSeq sequence and hg18 are indicated in parentheses.

| | | | | | Converted | Converted | |
|---|---|---|---|---|---|---|---|
| | | | Refseq | | lobSTR | HGDP | |
| Sample | Period | Marker | (hg18 diff) | Coverage | alleles^{a} | alleles^{a} | Status^{b} |
| HGDP01029 | 4 | D11S2371 | (TATC)11 | 5 | 0,0 | 0,0 | 2 |
| HGDP01029 | 4 | D12S1300 | (TAGA)12 | 5 | 0, 0 | 0, 0 | 2 |
| HGDP00521 | 4 | D6S1009 | (TATC)11 | 5 | 1, 1 | 1, 4 | 1 |
| HGDP01029 | 4 | D2S405 | (TAGA)12 | 5 | 2, −2 | −2, 0 | 1 |
| HGDP00778 | 4 | D8S1108 | (TCTA)11 | 4 | 0, 0 | 0, 0 | 2 |
| HGDP01029 | 4 | D15S818 | (TAGA)10 | 4 | 3, 3 | 3, 3 | 2 |
| HGDP00551 | 4 | D1S1653 | (TCTA)12 | 4 | −1, 0 | −1, 0 | 2 |
| HGDP00521 | 4 | D5S2500 | (ATAG)11 | 4 | 0, 1 | 0, 1 | 2 |
| HGDP00927 | 4 | D10S1426 | (TATC)11 | 4 | 0, 2 | 0, 2 | 2 |
| HGDP01029 | 4 | D17S1308 | (TGTA)11 | 4 | −1, −1 | −1, −1 | 2 |
| | | | (−1) | | | | |
| HGDP00521 | 4 | D17S1308 | (TGTA)11 | 4 | −1, 0 | −1, 0 | 2 |
| | | | (−1) | | | | |
| HGDP00542 | 4 | D17S1308 | (TGTA)11 | 4 | −1, −1 | −1, −1 | 2 |
| | | | (−1) | | | | |
| HGDP00927 | 2 | D3S3644 | (AC)16 | 4 | −1, 0 | 0, 0 | 0.5 |
| HGDP00521 | 2 | D9S1779 | (AC)14 | 4 | 0, 0 | −2, −2 | 0 |
| HGDP00521 | 2 | D8S503 | (AC)17 | 4 | 2, 4 | 3, 6 | 0 |
| HGDP00521 | 2 | D1S2682 | (CA)10 | 3 | 0, 10 | 0, 10 | 2 |
| HGDP00998 | 4 | D2S427 | (GATA)9 | 3 | 0, 0 | 0, 0 | 2 |
| HGDP00542 | 4 | D8S1113 | (GGAA)12 | 3 | −6, −6 | −6, −6 | 2 |
| HGDP01029 | 4 | D10S1425 | (GATA)11 | 3 | −5, 0 | −5, 0 | 2 |
| HGDP01029 | 4 | D7S1824 | (TCTA)11 | 3 | −3, −2 | −3, −2 | 2 |
| HGDP00778 | 4 | D1S3669 | (TATC)10 | 3 | 1, 1 | 1, 1 | 2 |
| HGDP00711 | 4 | D3S2432 | (AGAT)15 | 3 | −3, 0 | −3, 0 | 2 |
| | | | (−3) | | | | |
| HGDP00491 | 4 | D2S405 | (TAGA)12 | 3 | 0, 0 | 0, 0 | 2 |
| HGDP00998 | 4 | D16S3253 | (TAGA)9 | 3 | 0, 0 | 0, 0 | 2 |
| HGDP00998 | 4 | D9S301 | (GATA)15 | 3 | −7, −1 | −7, −1 | 2 |
| HGDP00998 | 4 | D19S586 | (TAGA)12 | 3 | 1, 2 | 1, 2 | 2 |
| | | | (+2) | | | | |
| HGDP00711 | 2 | D15S165 | (AC)21 | 3 | −6, −6 | −6, −6 | 2 |
| HGDP00665 | 2 | D20S103 | (AC)16 | 3 | −1, −1 | −1, −1 | 2 |
| HGDP00456 | 3 | D4S2394 | (ATT)11 | 3 | 0, 0 | 0, 0 | 2 |
| HGDP00711 | 4 | D11S2371 | (TATC)11 | 3 | 1, 1 | 1, 1 | 2 |
| HGDP00927 | 4 | D10S1239 | (ATCT)11 | 3 | 0, 1 | 0, 1 | 2 |
| HGDP00521 | 4 | D14S1434 | (GATA)10 | 3 | 0, 0 | 0, 0 | 2 |
| HGDP00491 | 4 | D19S591 | (TAGA)10 | 3 | −1, 0 | −1, 0 | 2 |
| | | | (−2) | | | | |
| HGDP00521 | 4 | D19S591 | (TAGA)10 | 3 | −2, 1 | −2, 1 | 2 |
| | | | (−2) | | | | |
| HGDP00542 | 4 | D19S591 | (TAGA)10 | 3 | −1, 0 | −1, 0 | 2 |
| | | | (−2) | | | | |
| HGDP00551 | 4 | D19S591 | (TAGA)10 | 3 | −2, 0 | −2, 0 | 2 |
| | | | (−2) | | | | |
| HGDP01224 | 4 | D19S591 | (TAGA)10 | 3 | −2, 1 | −2, 1 | 2 |
| | | | (−2) | | | | |
| HGDP00927 | 4 | D17S2196 | (AGAT)9 | 3 | 0, 2 | 0, 2 | 2 |
| | | | (−2) | | | | |
| HGDP01029 | 4 | D2S1391 | (ATCT)14 | 3 | −2, 0 | −2, 0 | 2 |
| HGDP00456 | 3 | D4S2361 | (TTA)13 | 3 | −1, −1 | −1, −1 | 2 |
| HGDP00665 | 4 | D1S1653 | (TCTA)12 | 3 | 0, 0 | 0, 0 | 2 |
| HGDP01224 | 4 | D1S1653 | (TCTA)12 | 3 | −2, −1 | −2, −1 | 2 |
| HGDP00542 | 4 | D5S2500 | (ATAG)11 | 3 | 0, 0 | 0, 0 | 2 |
| HGDP00778 | 4 | D10S1426 | (TATC)11 | 3 | 1, 1 | 1, 1 | 2 |
| HGDP01029 | 4 | D5S2500 | (ATAG)11 | 3 | −2, 0 | −2, 0 | 2 |
| HGDP00456 | 4 | D17S1298 | (TGAA)8 | 3 | 0, 0 | 0, 0 | 2 |
| HGDP00927 | 4 | D17S1298 | (TGAA)8 | 3 | 3, 3 | 3, 3 | 2 |
| HGDP00542 | 4 | D19S254 | (AGAT)13 | 3 | −1, 1 | −1, 1 | 2 |
| | | | (−6) | | | | |
| HGDP00711 | 2 | D1S2682 | (CA)10 | 3 | 0, 0 | 0, 10 | 1 |
| HGDP00998 | 4 | D5S1457 | (ATAG)9 | 3 | 0, 0 | 0, 1 | 1 |
| HGDP00521 | 2 | D20S103 | (AC)16 | 3 | 2, 2 | −1, 2 | 1 |
| HGDP00998 | 4 | D20S482 | (TCTA)14 | 3 | 0, 0 | 0, 1 | 1 |
| HGDP01224 | 3 | D9S910 | (ATA)14 | 3 | −7, −7 | −7, −7 | 1 |
| HGDP01224 | 4 | D11S2363 | (TATC)14 | 3 | −1, −1 | −1, 9 | 1 |
| HGDP00711 | 4 | D19S591 | (TAGA)10 | 3 | −1, −1 | −1, 0 | 1 |
| | | | (−2) | | | | |
| HGDP00927 | 2 | D18S1390 | (TG)18 | 3 | −1, 0 | −2, −1 | 0.5 |
| HGDP00778 | 2 | D8S503 | (AC)17 | 3 | 2, 3 | 3, 3 | 0.5 |
| HGDP00778 | 4 | D12S1300 | (TAGA)12 | 3 | 2, 4 | 2, 2 | 0.5 |
| HGDP00491 | 2 | D9S1779 | (AC)14 | 3 | 0, 9 | −1, 6 | 0 |

^{a}Converted allelotypes given in number of repeat units different from the reference.
^{b}Status: 2 = both alleles called correctly, 1 = one allele of a heterozygous locus called correctly, 0.5 = one allele called correctly and one incorrectly, 0 = no correct alleles called.

Despite the low coverage, lobSTR correctly returned 75% of the genotypes and 85% of the allele calls. Most of the alleles showed at least 5 bp difference from the reference and some alleles showed a difference of 24 bp and were correctly called. No significant correlation between errors and the size of the variation was observed.

Genome-Wide STR Profiling Confirms Previously Locus-Centric Observations

A reference for future experiments may be developed. An input dataset was a male individual that, as of today, has been sequenced to highest coverage of 126-fold from a blood sample (Ajay et al., 2011). Fourteen billion sequencing reads were obtained from 100 bp PE runs on Illumina® GAIIx and HiSeq 2000. lobSTR ran for 26 hours using 25 CPUs. It aligned ˜6 million reads to approximately 180,000 STR loci out of the 249,000 in the Tandem Repeat Table reference with average coverage 20.82 for autosomal loci. The average reference allele length of undetected loci was 150 bp, whereas the mean reference length of detected loci was 41 bp. Therefore, in most cases, the undetected loci could not physically be spanned by a single read of the current sequencing length.

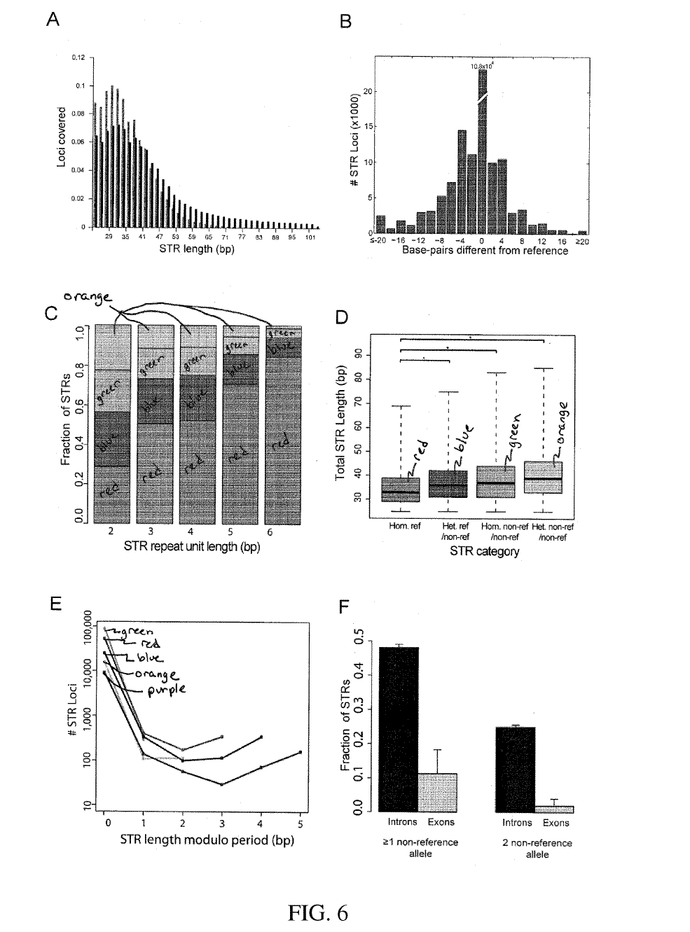

Each autosomal STR was assigned to one of four allelotype categories: both alleles match the reference (homozygous reference), one allele matches the reference (heterozygous reference), both alleles do not match the reference but are the same (homozygous non-reference), and both alleles are different and do not match the reference (heterozygous non-reference). In all previous experiments, a coverage threshold of 20× resulted with near-perfect STR calling even for dinucleotide loci. To increase the reliability of the results, the analysis was performed on the 97,844 loci that were called with at least this sequencing coverage. The length distribution of these alleles in the reference was mainly between 25-50 bp with a low number of very long STRs (FIG. 6A).

Similar to the other genomes in this study, 55% (52,338) of the STR loci differed from the reference: 22,271 (23%) loci were heterozygous reference, 15,515 (16%) loci were homozygous non-reference, and 14,552 (15%) loci were heterozygous non-reference. The other 43,335 (45%) loci were homozygous reference. Some of the variations reached to 49 bp difference from the reference allele. On average, STR variations showed 6.3 bp difference from the reference allele and 41% of the variations were more than 5 bp away from the reference (FIG. 6B). Thus, mainstream-dependent analysis pipelines that can tolerate only a few nucleotide indels, such as BWA, are likely to miss most STR variations.

The genome-wide STR dynamics reported by lobSTR confirm previous findings of locus-centric studies. The rate of STR polymorphism showed a striking correlation with the repeat unit length (FIG. 6C). Dinucleotide STRs are nearly equally likely to fall into any of the above four categories, whereas hexanucleotide STRs are most likely to match the reference. This trend matches results of a previous study that measured the mutation rate of a few hundreds of Y-STR loci as a function of repeat unit length (Jarve et al., 2009). Similar to the results obtained by the inventors, the authors showed that penta- and hexanucleotide repeats mutate at half the rate of tri- and tetra-nucleotide repeats. It was also found that the rate of STR polymorphism is significantly correlated to the length of the STR allele in the reference (FIG. 6D). The non-reference loci (n=52,338) had significantly greater lengths than loci that are homozygous reference (n=43,335) (p<0.05, one-sided Mann-Whitney test for each allelotype category versus reference) as previously reported in studies that analyzed a few dozen STRs (Brinkmann et al., 1998; Ellegren 2000).

lobSTR was also used to determine genome-wide trends of STRs at single base pair resolution (FIG. 6E). Overall, 99% of alleles varying from the reference allele showed differences that were complete multiples of the STR unit. This trend varied by period, with dinucleotide STRs least likely (0.3%) to differ by an incomplete motif unit and hexanucleotide most likely (4.7%).

Finally, lobSTR reported significant differences between repeat variations in intronic and exonic regions (FIG. 6F). Intronic trinucleotide STRs were twice as likely to exhibit at least one non-reference allele than exonic regions (0.480-0.502 95% CI and 0.179-0.336 95% CI for introns and exons, respectively), and nearly five times as likely to exhibit two non-reference alleles (0.107-0.119 95% CI and 0-0.047 95% CI for introns and exons, respectively). Significantly, lobSTR reported that 1.9% (62 out of 3276) of the intronic trinucleotide STRs showed length differences that were not a multiple of three nucleotides. On the other hand, all reported exonic trinucleotide variants retained the reading frame. In addition, lobSTR allelotyped 34,667 intronic and 7 exonic non-trinucleotide STRs. Of the intronic non-trinucleotide STRs, 18,277 (53%) showed at least one allele with a frameshift deviation, and 8,686 (25%) showed two frameshifted alleles. Surprisingly, 3 of the 7 exonic loci, all tetranucleotides, showed expansions by units of 4 bp, which would result in a frameshift mutation. In one case, in exon 8 of DCHS2, the frameshift variation was homozygous. This call was supported by 33 independent reads, showing a potential loss of function in this gene.

Taken together, the overall findings of lobSTR in this genome serve as a biological validation for the accuracy and utility of genome-wide STR profiling using the described technique.

### Discussion

STR profiling techniques have changed very little in the past two decades, relying on the faithful yet cumbersome capillary electrophoresis technique to scan a few dozen loci at a time. The advent of HTS has ushered in the opportunity to conduct genome-wide STR variation analyses. The described solution may bypass the gapped alignment problem, has no inherent indel limitation, and can reliably profile highly polymorphic STRs at a single base pair resolution. A comparison between lobSTR and popular mainstream aligners was performed and the results and showed that even with long reads, these aligners are significantly biased towards the detection of the reference allele. Thus, the feasibility of lobSTR to profile STR loci from a total of 20 genomic datasets was established and it the accuracy of the method was demonstrated by analyzing its consistency, ability to trace Mendelian inheritance, and comparing its results to orthogonal molecular techniques. Moreover, the performed genome-wide STR analysis confirms previous biological observations, which further highlights the algorithmic validity.

lobSTR results from the trio genomes and the Ajay et al. genome consistently showed genome-wide polymorphism rates of 55%-57% for STRs with lengths 25 bp and over. A recent study by McIver et al. (2011) evaluated the performance of STR calling using post-BWA alignment files with a set of quality rules. Using a mixture of IIlumina® 45-100 bp reads and 454 reads from two trios in the 1000Genoems project, they reported that 1.1% of the STRs with lengths of 20 bp and over were polymorphic. When lobSTR was applied to the 1000Genomes CEU trio datasets, it was found again that 57% of the STRs were polymorphic (25,885 out of 45,461 STRs that were called with >5× coverage at the three genomes). These results suggest that STR profiling that is restricted by the default BWA indel tolerance—5 bp for the IIlumina® datasets in the McIver et al. study—can significantly reduce the sensitivity for observing STR variations.

Accordingly, lobSTR may be used in parallel to conventional analysis pipelines in order to augment variation calling to STR loci. The fast running time of the algorithm may not impose a significant computational burden on users. A low coverage genome of 5× takes about an hour on a standard server with 25 CPUs, a high coverage genome of 30× takes eight hours using the same settings, and a ultra-high covered genome of 126× takes 26 hours (Supplemental Table 2).

Currently, the major barrier for STR profiling is the sequencing read length, as the number of detectable STRs is limited to those that are entirely spanned by a single read. To test the effect of genomic coverage on STR profiling, reads from the 126× genome were sampled and the amount of reported STRs was calculated, as shown in FIG. 12. With genome-wide coverage of 40×, there are more than 100,000 STRs that may pass an STR-coverage threshold of 10×. However, higher genomic coverage does not linearly improve the number of STRs that pass this threshold, marking a potential upper bound of sequencing read lengths of 100 bp. The utility of the longer reads by Sanger, 454, and IonTorrent for STR profiling of personal genomes was assessed using lobSTR (Supplemental Table 5). Longer reads indeed increased the number of reported STR loci compared to the same autosomal coverage by Illumina®. However, out of these, Sanger seemed to be the only method to produce reliable STR reads. Because sequencing reads may continue to increase in both length and quality, lobSTR's performance may further improve and allow inclusion of a larger number of STR variations. Ultimately, these may include large pathogenic expansion, such as those in Huntington's disease, which can span more than 100 bp.

SUPPLEMENTAL TABLE 6
STR reference repeat unit size distribution.

| Repeat | | |
|---|---|---|
| unit size | # STR loci | Percentage |
| 2 | 106,457 | 44% |
| 3 | 17,383 | 7% |
| 4 | 70,847 | 30% |
| 5 | 28,746 | 12% |
| 6 | 16,626 | 7% |
| Total | 240,059 | 100% |

As of today, sequence analysis algorithms can detect almost any type of genetic variations, from SNPs (Goya et al., 2010) and indels (Koboldt et al., 2009; Goya et al., 2010) to CNVs and chromosomal translocations (Chen et al., 2009). lobSTR adds a new layer of information with tens of thousands of highly polymorphic genetic variations that have a multitude of applications, from personal genomics, to population studies, forensics analysis, and cancer genome profiling.

### REFERENCES

Ajay S S, Parker S C, Abaan H O, Fajardo K V, Margulies E H. 2011. Accurate and comprehensive sequencing of personal genomes. Genome Res 21(9): 1498-1505.
Ballantyne K N, Goedbloed M, Fang R, Schaap O, Lao O, Wollstein A, Choi Y, van Duijn K, Vermeulen M, Brauer S et al. 2010. Mutability of Y-chromosomal microsatellites: rates, characteristics, molecular bases, and forensic implications. Am J Hum Genet 87(3): 341-353.
Barnett D W, Garrison E K, Quinlan A R, Stromberg M P, Marth G T. 2011. BamTools: a C++ API and toolkit for analyzing and managing BAM files. Bioinformatics 27(12): 1691-1692.
Benson G. 1999. Tandem repeats finder: a program to analyze DNA sequences. Nucleic Acids Res 27(2): 573-580.
Brais B, Bouchard J P, Xie Y G, Rochefort D L, Chretien N, Tome F M, Lafreniere R G, Rommens J M, Uyama E, Nohira 0 et al. 1998. Short GCG expansions in the PABP2 gene cause oculopharyngeal muscular dystrophy. Nat Genet 18(2): 164-167.
Brinkmann B, Klintschar M, Neuhuber F, Huhne J, Rolf B. 1998. Mutation rate in human microsatellites: influence of the structure and length of the tandem repeat. Am J Hum Genet 62(6): 1408-1415.
Burrows M, Wheeler D J. 1994. A block-sorting lossless data compression algorithm.
Chakraborty R, Kimmel M, Stivers D N, Davison L J, Deka R. 1997. Relative mutation rates at di-, tri-, and tetranucleotide microsatellite loci. Proc Natl Acad Sci USA 94(3): 1041-1046.
Chen K, Wallis J W, McLellan M D, Larson D E, Kalicki J M, Pohl C S, McGrath S D, Wendl M C, Zhang Q, Locke DP et al. 2009. BreakDancer: an algorithm for high-resolution mapping of genomic structural variation. Nat Methods 6(9): 677-681.
Conrad D F, Keebler J E, DePristo M A, Lindsay S J, Zhang Y, Casals F, Idaghdour Y, Hartl C L, Torroja C, Garimella K V et al. 2011. Variation in genome-wide mutation rates within and between human families. Nat Genet 43(7): 712-714.
Ellegren H. 2000. Heterogeneous mutation processes in human microsatellite DNA sequences. Nat Genet 24(4): 400-402.
Ellegren H. 2004. Microsatellites: simple sequences with complex evolution. Nat Rev Genet 5(6): 435-445.
   2004a. Microsatellites: simple sequences with complex evolution. Nat Rev Genet 5(6): 435-445.
   2004b. Microsatellites: simple sequences with complex evolution. Nat Rev Genet 5(6): 435-445.
Erlich Y, Edvardson S, Hodges E, Zenvirt S, Thekkat P, Shaag A, Dor T, Hannon G J, Elpeleg O. 2011. Exome sequencing and disease-network analysis of a single family implicate a mutation in KIF1A in hereditary spastic paraparesis. Genome Res 21(5): 658-664.
Ewen K R, Bahlo M, Treloar S A, Levinson D F, Mowry B, Barlow J W, Foote S J. 2000. Identification and analysis of error types in high-throughput genotyping. Am J Hum Genet 67(3): 727-736.
Frigo M, Johnson S G. 1998. FFTW: An adaptive software architecture for the FFT. Proceedings of the 1998 Ieee International Conference on Acoustics, Speech and Signal Processing, Vols 1-6: 1381-1384.
Frumkin D, Wasserstrom A, Itzkovitz S, Stern T, Harmelin A, Eilam R, Rechavi G, Shapiro E. 2008. Cell lineage analysis of a mouse tumor. Cancer Res 68(14): 5924-5931.
Goya R, Sun M G, Morin R D, Leung G, Ha G, Wiegand K C, Senz J, Crisan A, Marra M A, Hirst M et al. 2010. SNVMix: predicting single nucleotide variants from next-generation sequencing of tumors. Bioinformatics 26(6): 730-736.
Green R E, Krause J, Briggs A W, Maricic T, Stenzel U, Kircher M, Patterson N, Li H, Zhai W, Fritz M H et al. 2010. A draft sequence of the Neandertal genome. Science 328(5979): 710-722.
Hauge X Y, Litt M. 1993. A study of the origin of ‘shadow bands’ seen when typing dinucleotide repeat polymorphisms by the PCR. Hum Mol Genet 2(4): 411-415.
E. Heyer, J. Puymirat, P. Dieltjes, E. Bakker, P. de Knijff, Hum Mol Genet 6, 799 (May, 1997).
Jarve M, Zhivotovsky L A, Rootsi S, Help H, Rogaev E I, Khusnutdinova E K, Kivisild T, Sanchez J J. 2009. Decreased rate of evolution in Y chromosome STR loci of increased size of the repeat unit. PloS one 4(9): e7276.
Kayser M, de Knijff P. 2011. Improving human forensics through advances in genetics, genomics and molecular biology. Nat Rev Genet 12(3): 179-192.
Kehdy F S, Pena S D. 2010. Worldwide diversity of the Y-chromosome tetra-local microsatellite DYS464. Genet Mol Res 9(3): 1525-1534.
Kent W J. 2002. BLAT—the BLAST-like alignment tool. Genome Res 12(4): 656-664.
Kent W J, Sugnet C W, Furey T S, Roskin K M, Pringle T H, Zahler A M, Haussler D. 2002. The human genome browser at UCSC. Genome Res 12(6): 996-1006.
Koboldt D C, Chen K, Wylie T, Larson D E, McLellan M D, Mardis E R, Weinstock G M, Wilson R K, Ding L. 2009. VarScan: variant detection in massively parallel sequencing of individual and pooled samples. Bioinformatics 25(17): 2283-2285.
Lam H Y, Clark M J, Chen R, Natsoulis G, O'Huallachain M, Dewey F E, Habegger L, Ashley E A, Gerstein M B, Butte A J et al. 2012. Performance comparison of whole-genome sequencing platforms. Nat Biotechnol 30(1): 78-82.
Levy S, Sutton G, Ng P C, Feuk L, Halpern A L, Walenz B P, Axelrod N, Huang J, Kirkness E F, Denisov G et al. 2007. The diploid genome sequence of an individual human. PLoS Biol 5(10): e254.
Li H, Durbin R. 2009. Fast and accurate short read alignment with Burrows-Wheeler transform. Bioinformatics 25(14): 1754-1760.
Li H, Handsaker B, Wysoker A, Fennell T, Ruan J, Homer N, Marth G, Abecasis G, Durbin R. 2009. The Sequence Alignment/Map format and SAMtools. Bioinformatics 25(16): 2078-2079.
Li H, Homer N. 2010. A survey of sequence alignment algorithms for next-generation sequencing. Brief Bioinform 11(5): 473-483.
Lupski J R. 2007. Genomic rearrangements and sporadic disease. Nat Genet 39(7 Suppl): S43-47.
Mirkin S M. 2007. Expandable DNA repeats and human disease. Nature 447(7147): 932-940.
Muragaki Y, Mundlos S, Upton J, Olsen B R. 1996. Altered growth and branching patterns in synpolydactyly caused by mutations in HOXD13. Science 272(5261): 548-551.
Needleman S B, Wunsch C D. 1970. A general method applicable to the search for similarities in the amino acid sequence of two proteins. J Mol Biol 48(3): 443-453.
Payseur B A, Jing P, Haasl R J. 2011. A genomic portrait of human microsatellite variation. Mol Biol Evol 28(1): 303-312.
Pearson C E, Nichol Edamura K, Cleary J D. 2005. Repeat instability: mechanisms of dynamic mutations. Nat Rev Genet 6(10): 729-742.
Pemberton T J, Sandefur C I, Jakobsson M, Rosenberg N A. 2009. Sequence determinants of human microsatellite variability. BMC Genomics 10: 612.
Ramachandran S, Deshpande O, Roseman C C, Rosenberg N A, Feldman M W, Cavalli-Sforza L L. 2005. Support from the relationship of genetic and geographic distance in human populations for a serial founder effect originating in Africa. Proc Natl Acad Sci USA 102(44): 15942-15947.
Reich D, Green R E, Kircher M, Krause J, Patterson N, Durand E Y, Viola B, Briggs A W, Stenzel U, Johnson P L et al. 2010. Genetic history of an archaic hominin group from Denisova Cave in Siberia. Nature 468(7327): 1053-1060.
Rothberg J M, Hinz W, Rearick T M, Schultz J, Mileski W, Davey M, Leamon J H, Johnson K, Milgrew M J, Edwards M et al. 2011. An integrated semiconductor device enabling non-optical genome sequencing. Nature 475(7356): 348-352.
Sharma D, Issac B, Raghava G P, Ramaswamy R. 2004. Spectral Repeat Finder (SRF): identification of repetitive sequences using Fourier transformation. Bioinformatics 20(9): 1405-1412.
Skorecki K, Selig S, Blazer S, Bradman R, Bradman N, Waburton P J, Ismajlowicz M, Hammer M F. 1997. Y chromosomes of Jewish priests. Nature 385(6611): 32.
R. Thomson, J. K. Pritchard, P. Shen, P. J. Oefner, M. W. Feldman, Proc Natl Acad Sci USA 97, 7360 (Jun. 20, 2000).
Treangen T J, Salzberg S L. 2011. Repetitive DNA and next-generation sequencing: computational challenges and solutions. Nat Rev Genet.
Walsh B. 2001. Estimating the time to the most recent common ancestor for the Y chromosome or mitochondrial DNA for a pair of individuals. Genetics 158(2): 897-912.
Weber J L, Broman K W. 2001. Genotyping for human whole-genome scans: past, present, and future. Adv Genet 42: 77-96.
B. Walsh, Genetics 158, 897 (June, 2001).
Wattier R, Engel C R, Saumitou-Laprade P, Valero M. 1998. Short allele dominance as a source of heterozygote deficiency at microsatellite loci: experimental evidence at the dinucleotide locus Gv1CT in Gracilaria gracilis (Rhodophyta). Mol Ecol 7(11): 1569-1573.
Wheeler D A, Srinivasan M, Egholm M, Shen Y, Chen L, McGuire A, He W, Chen Y J, Makhijani V, Roth G T et al. 2008. The complete genome of an individual by massively parallel DNA sequencing. Nature 452(7189): 872-876.
Zhivotovsky L A, Underhill P A, Cinnioglu C, Kayser M, Morar B, Kivisild T, Scozzari R, Cruciani F, Destro-Bisol G, Spedini G et al. 2004. The effective mutation rate at Y chromosome short tandem repeats, with application to human population-divergence time. Am J Hum Genet 74(1): 50-61.
Zhou H, Du L, Yan H. 2009. Detection of tandem repeats in DNA sequences based on parametric spectral estimation. IEEE transactions on information technology in biomedicine: a publication of the IEEE Engineering in Medicine and Biology Society 13(5): 747-755.

1. A method of operating a computing device comprising at least one processor to assign characteristics to a sample from an individual, the method comprising, with the at least one processor:
obtaining a plurality of deoxyribonucleic acid (DNA) sequences from the sample;
analyzing the plurality of DNA sequences to identify at least one DNA sequence of the plurality of DNA sequences comprising at least one short tandem repeat (STR) region, the at least one STR region comprising at least two repeat units;
determining a length and an identity of a repeat unit of the at least two repeat units of the at least one STR region;
determining a length and an identity of the at least one STR region, based on an alignment of at least a portion of the at least one DNA sequence to at least one reference DNA sequence;
determining an allele of the at least one STR region;
comparing the determined allele to a database comprising a plurality of alleles to identify at least one matching allele of the plurality of alleles that matches the determined allele, wherein the at least one matching allele is associated with information relating to a subject; and
assigning at least one characteristic to the sample based on the information relating to the subject associated with the at least one matching allele. or a method of operating a computing device comprising at least one processor to assign a surname to a sample from an individual, the method comprising, with the at least one processor:
sequencing a plurality of nucleic acids extracted from the sample to obtain a plurality of deoxyribonucleic acid (DNA) sequences;
analyzing the plurality of DNA sequences to identify at least one DNA sequence of the plurality of DNA sequences comprising at least one short tandem repeat (STR) region, the at least one STR region comprising at least two repeat units;
determining a length and an identity of a repeat unit of the at least two repeat units of the at least one STR region;
determining a length and an identity of the at least one STR region, based on an alignment of at least a portion of the at least one DNA sequence to at least one reference DNA sequence;
determining an allele of the at least one STR region;
comparing the determined allele to a database comprising a plurality of alleles to identify at least one matching allele of the plurality of alleles that matches the determined allele, wherein the at least one matching allele is associated with information relating to a subject; and
assigning at least one characteristic to the sample based on the information relating to a subject associated with the at least one matching allele.

2. The method of claim 1, wherein the analyzing of the plurality of DNA sequences comprises:
dividing each DNA sequence of the plurality of DNA sequences into a plurality of overlapping sequences;
determining an entropy value for each of the plurality of overlapping sequences; and
identifying the at least one DNA sequence from the plurality of DNA sequences that comprises the at least one STR region based on entropy values of the plurality of overlapping sequences.

3. The method of claim 2, wherein the entropy value for each of the plurality of overlapping sequences is determined according to a formula:
$$E ( {S}_{j} ) = - {\sum }_{i ∈ Σ} {f}_{i} {log}_{2} {f}_{i} ,$$
wherein E comprises the entropy value, Sⱼ comprises a j^{th} sequence of the plurality of overlapping sequences, Σ comprises an alphabet, i comprises a symbol in the alphabet, and fᵢ comprises a frequency of the symbol i.

4. The method of claim 3, wherein the alphabet comprises a plurality of nucleotide sequences each comprising at least two nucleotides selected from an adenine, guanine, cytosine and thymine.

5. The method of claim 2, wherein dividing each DNA sequence of the plurality of DNA sequences into the plurality of overlapping sequences comprises:
receiving input indicating a length of each sequence of the plurality of overlapping sequences and a length of an overlap between each two consecutive sequences of the plurality of overlapping sequences.

6. The method of claim 2, wherein the analyzing of the plurality of DNA sequences to identify the at least one DNA sequence comprising the at least one STR region comprises:
identifying at least one sequence of the plurality of overlapping sequences that is flanked by an upstream sequence and by a downstream sequence, wherein the at least one sequence has a corresponding entropy value that is below a threshold, and each of the upstream sequence and the downstream sequence has a corresponding entropy value that is above the threshold.

7. The method of claim 1, wherein determining the length of the repeat unit of the at least two repeat units of the at least one STR region comprises:
representing the at least one STR region as a binary matrix;
applying a Fourier transform along columns of the binary matrix, each representing an occurrence of a type of a nucleotide in the at least one STR region, to generate a plurality of frequency bins, the type of the nucleotide being selected from the group consisting of adenine, cytosine, guanine and thymine;
analyzing the plurality of frequency bins to identify a frequency bin from the plurality of frequency bins having a signal strength above a threshold, the identified frequency bin corresponding to a repeat unit length; and
determining the length of the repeat unit based on the identified frequency bin.

8. The method of claim 7, wherein determining the identity of the repeat unit of the at least two repeat units of the at least one STR region comprises:
determining a nucleotide sequence of the repeat unit by determining a frequency of occurrence of each of a plurality of repeat units of the length in the at least one STR region.

9. The method of claim 8, wherein determining the nucleotide sequence of the repeat unit comprises:
applying a rolling hash function to identify the plurality of repeat units of the length in the at least one STR region; and
determining the nucleotide sequence as a nucleotide sequence of a repeat unit of the plurality of repeat units characterized by a frequency of occurrence that is above a frequency of occurrence of each of the other repeat units of the plurality of repeat units.

10. The method of claim 1, wherein:
each of the at least two repeat units comprises at least two nucleotides.

11. The method of claim 1, wherein:
the alignment of at least a portion of the at least one DNA sequence to the at least one reference DNA sequence comprises alignment of upstream and downstream regions flanking the at least one STR region to the at least one reference DNA sequence.

12. The method of claim 11, wherein:
determining the length and the identity of the at least one STR region comprises:
aligning the upstream sequence to the at least one reference DNA sequence to identify a first matching sequence in the at least one reference DNA sequence;
aligning the downstream sequence to the at least one reference DNA sequence to identify a second matching sequence in the at least one reference DNA sequence; and
determining the length and the identity of the at least one STR region based at least on positions in the at least one DNA reference sequence of the first matching sequence and the second matching sequence.

13. The method of claim 1, wherein the at least one reference DNA sequence comprises a second STR region formed by at least two repeat units characterized by the same length and identity as the length and identity of the repeat unit of the at least two repeat units of the at least one STR region, the second STR region being flanked by respective upstream and downstream sequences.

14. The method of claim 1, wherein:
the alignment of at least a portion of the at least one DNA sequence to the at least one reference DNA sequence comprises alignment of an upstream region flanking the at least one STR region or a downstream region flanking the at least one STR region to the at least one reference DNA sequence.

15. The method of claim 1, wherein:
the plurality of alleles are stored in at least one database.

16. The method of claim 15, wherein:
the at least one database comprises a Y-chromosome database.

17. The method of claim 15, further comprising:
accessing the at least one database over a network to access the plurality of alleles.

18-35. (canceled)

36. At least one computer-readable medium storing computer-executable instructions that, when executed by at least one processor, perform a method of identifying short tandem repeat (STR) regions in a genome from a sample and assigning characteristics to the sample based on the identification, the method comprising:
obtaining a plurality of deoxyribonucleic acid (DNA) sequences from the sample from an individual;
analyzing the plurality of DNA sequences to identify at least one DNA sequence of the plurality of DNA sequences comprising at least one short tandem repeat (STR) region, the at least one STR region comprising at least two repeat units;
determining a length and an identity of a repeat unit of the at least two repeat units of the at least one STR region;
determining a length and an identity of the at least one STR region, based on an alignment of at least a portion of the at least one DNA sequence to at least one reference DNA sequence;
determining an allele of the at least one STR region;
comparing the determined allele to a database comprising a plurality of alleles to identify at least one matching allele of the plurality of alleles that matches the determined allele, wherein the at least one matching allele is associated with information relating to a subject; and
assigning at least one characteristic to the sample based on the information relating to the subject associated with the at least one matching allele.

37-70. (canceled)

71. A system comprising:
at least one storage medium storing computer-executable instructions for performing, when executed by at least one processor, a method for recovering characteristics of a sample from an individual based on identification of short tandem repeat (STR) regions; and
the at least one processor configured to execute the computer-executable instructions to perform the method comprising:
obtaining a plurality of deoxyribonucleic acid (DNA) sequences from the sample from the individual;
analyzing the plurality of DNA sequences to identify at least one DNA sequence of the plurality of DNA sequences comprising at least one short tandem repeat (STR) region, the at least one STR region comprising at least two repeat units;
determining a length and an identity of a repeat unit of the at least two repeat units of the at least one STR region;
determining a length and an identity of the at least one STR region, based on an alignment of at least a portion of the at least one DNA sequence to at least one reference DNA sequence;
determining an allele of the at least one STR region;
comparing the determined allele to a database comprising a plurality of alleles to identify at least one matching allele of the plurality of alleles that matches the determined allele, wherein the at least one matching allele is associated with information relating to a subject; and
assigning at least one characteristic to the sample based on the information relating to a subject associated with the at least one matching allele. or a system for identifying short tandem repeat (STR) regions in a genome, the system comprising:
a computing device comprising at least one processor and memory storing computer-executable instructions that, when executed by the at least one processor, perform a method comprising:
obtaining a plurality of deoxyribonucleic acid (DNA) sequences from a sample from an individual;
analyzing the plurality of DNA sequences to identify at least one DNA sequence of the plurality of DNA sequences comprising at least one short tandem repeat (STR) region, the at least one STR region comprising at least two repeat units;
determining a length and an identity of a repeat unit of the at least two repeat units of the at least one STR region;
determining a length and an identity of the at least one STR region, based on an alignment of at least a portion of the at least one DNA sequence to at least one reference DNA sequence;
determining an allele of the at least one STR region;
comparing the determined allele to a database comprising a plurality of alleles to identify at least one matching allele of the plurality of alleles that matches the determined allele, wherein the at least one matching allele is associated with a surname; and
assigning a surname to the sample based on the surname associated with the at least one matching allele.

72-116. (canceled)

117. A device for identifying short tandem repeat (STR) regions in a genome, the device comprising:
at least one processor; and
memory for storing computer-executable instructions that, when executed by the at least one processor, perform a method comprising:
receiving a plurality of deoxyribonucleic acid (DNA) sequences from a sample from an individual;
analyzing the plurality of DNA sequences to identify at least one short tandem repeat (STR) region of an allele; and
assigning at least one characteristic to the sample based on the allele of the at least one identified STR region; or
at least one first processor configured to:
control at least one component to sequence a plurality of nucleic acids extracted from a sample from an individual to obtain a plurality of deoxyribonucleic acid (DNA) sequences; and
provide the plurality of DNA sequences to at least one second processor; and the at least one second processor configured to:
receive the plurality of DNA sequences;
analyze the plurality of DNA sequences to identify at least one DNA sequence of the plurality of DNA sequences comprising at least one STR region, the at least one STR region comprising at least two repeat units;
determine a length and an identity of a repeat unit of the at least two repeat units of the at least one STR region;
determine a length and an identity of the at least one STR region, based on an alignment of at least a portion of the at least one DNA sequence to at least one reference DNA sequence;
determine an allele of the at least one STR region;
compare the determined allele to a database comprising a plurality of alleles to identify at least one matching allele of the plurality of alleles that matches the determined allele, wherein the at least one matching allele is associated with information relating to the subject; and
assign at least one characteristic to the sample based on the information relating to the subject associated with the at least one matching allele.

118-162. (canceled)


SEQUENCE LISTING (80 sequences)

SEQ ID NO: 1 - DNA, 15 bp, Artificial Sequence
  Synthetic Polynucleotide
gacgacgacgacgac

SEQ ID NO: 2 - DNA, 30 bp, Artificial Sequence
  Synthetic Polynucleotide
acggctagcgtgtgtgtgtgtgcacagagt

SEQ ID NO: 3 - DNA, 200 bp, Artificial Sequence
  Synthetic Polynucleotide
tcatggtgacgggcaggcagcttgactaatgagtcctcgacgtggccggcgcagctctccaatcgccgggcggcgggccccagtctgaacggcgatggcgggcggcggcggcggcagcagcagcgggggctgcgggcggtcggggctccgggccggggcggcggcgccatcttgtgcccggggccggtggggaggccggg

SEQ ID NO: 4 - DNA, 200 bp, Artificial Sequence
  Synthetic Polynucleotide
atggtgacgggcaggcagcttgactaatgagtcctcggcgtggccggcgcagctctccaatcgccgggcggcgggccccagtctgagcggcgatggcggccggcggcggcggcagcagcagcgggggctgctggcggtcgggggtccgggccggggcggcggcgccatcttgtgcccggggccggtggggaggccgggga

SEQ ID NO: 5 - DNA, 200 bp, Artificial Sequence
  Synthetic Polynucleotide
gacgggcaggcagcttgactaatgagtcctcggcgtggccggcgcagctctccaatcgccgggcggcgggccccagtctgagcggcgatggcggcggcgggcggcagcagcagcgggggctgcgggcggtcggggctccgggccggggcggcggcgccatcttgtgcccggggccggtggggaggccggggagggggccc

SEQ ID NO: 6 - DNA, 200 bp, Artificial Sequence
  Synthetic Polynucleotide
gacgggcaggcagcttgactaatgagtcctcggcgtggccggcgcagctctccaatcgccgggcggcgggccccagtctgagcggcgatggcggcggcgggcagcagcagcgggggctgcgggcggttggggctccgggccggggcggcggcgccatcttgtgcccggggccggtggggaggccggggagggggccccgg

SEQ ID NO: 7 - DNA, 200 bp, Artificial Sequence
  Synthetic Polynucleotide
acgggcaggcagcttgactaatgagtcctcggcgtggccggcgcagctctccaatcgccgggcggcgggccccagtctgagcggcgatggcggcggcggcgcagcagcgggggctgcgggcggtcggggctccgggccggggcggcggcgccatcttgtgcccggggccggtggggaggccggggagggggccccggggg

SEQ ID NO: 8 - DNA, 200 bp, Artificial Sequence
  Synthetic Polynucleotide
cgggcaggcagcttgactaatgagtcctcggcgtggccggcgcagctctccaatcgccgggcggcgggccccagtctgagcggcgatggcggcggcggcggcagcagcgggggctgcgggcggtcggggctccgggccggggcggcggcgccatcttgtgcccggggccggtggggaggccggggagggggccccggggg

SEQ ID NO: 9 - DNA, 200 bp, Artificial Sequence
  Synthetic Polynucleotide
cgggcaggcagcttgactaatgagtcctcggcgtggccggcgcagctctccaatcgccgggcggcggggcccagtctgagcggcgatggcggcggcggcgcagcagcgggggctgcgggcggtcggggctccgggccggggcggcggcgccatcttgtgcccggggccggtggggaggccggggagggggcaccgggggg

SEQ ID NO: 10 - DNA, 200 bp, Artificial Sequence
  Synthetic Polynucleotide
ggcaggcagcttgactaatgagtcctcggcgtggccggcgcagctctccaatcgccgggcggcgggccccagtctgaccggcgatggcggcggcggcggcagcagcgggggctgcgggcggtcggggctccgggccggggcggcggcgccatcttgtgcccggggccggtggggaggccggggagggggccccggggggc

SEQ ID NO: 11 - DNA, 200 bp, Artificial Sequence
  Synthetic Polynucleotide
gcaggcagcttgactaatgagtcctcggcgtggccggcgcagctctccaatcgccgagcggcgggccccagtctgagcggcgatggcggcggcggcggcgggggcggcgggcggtcggggctccgggccggggcggcggcgccatcttctgcccggggccggtggggaggccggggagggggccccggggggcgcagggg

SEQ ID NO: 12 - DNA, 100 bp, Artificial Sequence
  Synthetic Polynucleotide
gcaggcagcttgactaatgagtcctcggcgtggccggcgcagctctccaatcgccgggcggcgggccccagtctgagcggcgatggcggcggcggcggcg

SEQ ID NO: 13 - DNA, 100 bp, Artificial Sequence
  Synthetic Polynucleotide
aggcagcttgactaatgagtcctcggcgtggccggcgcagctctccaatcgccgggcggcgggccccagtctgagcggcgatggcggcggcggcggcggc

SEQ ID NO: 14 - DNA, 100 bp, Artificial Sequence
  Synthetic Polynucleotide
ggcagcttgactaatgagtcctcggcgtggccggcgcagctctccaatcgccgggcggcgggccccagtctgagcggcgatggctgcggcggcggcggcg

SEQ ID NO: 15 - DNA, 100 bp, Artificial Sequence
  Synthetic Polynucleotide
gcagcttgactaatgagtcctcggcggggccggcgcagctctccaatcgccgggcggcgggccccagtctgagcggcgatggcggcggcggcggcggcgg

SEQ ID NO: 16 - DNA, 100 bp, Artificial Sequence
  Synthetic Polynucleotide
gcttgactaatgagtcctcggcgtggccggcgcagctctccaatcgccgggcggcgggcccctgtctgagcggcgatggcggcggcggcggcggcggcgg

SEQ ID NO: 17 - DNA, 100 bp, Artificial Sequence
  Synthetic Polynucleotide
ttgactaatgagtcctcggcgtggccggcgcagctctccaatcgccgggcggcgggccccagtctgagcggcgatggcggcggcggcggcggcggcagca

SEQ ID NO: 18 - DNA, 100 bp, Artificial Sequence
  Synthetic Polynucleotide
gactaatgagtcctcggcgtggccggcgcagctctccaatcgccgggcggcgggccccagtctgagcggcgatggcggcggcggcggcggcggcagcagc

SEQ ID NO: 19 - DNA, 100 bp, Artificial Sequence
  Synthetic Polynucleotide
gctaatgagtcctcggcgtggccggcgcagctctcccatcgccgggcggcgggccccagtctgagcggcgatggcggcggcggcggcggcggcggcggcg

SEQ ID NO: 20 - DNA, 100 bp, Artificial Sequence
  Synthetic Polynucleotide
ctaatgcgtcctcagcgtggccggcgcagctctccaatcgccgggcggcgggccccagtctgagcggcgatggcggcggcggcggcggcggcggcggcgg

SEQ ID NO: 21 - DNA, 100 bp, Artificial Sequence
  Synthetic Polynucleotide
tgagtcctcggcgtggccggcgcagctctccaatcgccgggcggcgggccccagtctgagcggcgatggcggcggcggcggcggcggcggcggcggcagc

SEQ ID NO: 22 - DNA, 100 bp, Artificial Sequence
  Synthetic Polynucleotide
cggcgtggccggcgcagctctccaatcgccgggcggcgggccccagtctgagcggcgatggcggcggcggcggcggcgccagcagcagcgggggctgcgg

SEQ ID NO: 23 - DNA, 100 bp, Artificial Sequence
  Synthetic Polynucleotide
gtggccggcgcagctctccaatcgccgggcggcgggccccagtctgagcggcgatggcggcggcggcggcggcggcagcagcagcgggggctgcgggcgg

SEQ ID NO: 24 - DNA, 100 bp, Artificial Sequence
  Synthetic Polynucleotide
cgcagctctccaatcgccgggcggcgggccccagtctgagcggcgatggcggcggcggcggcggcggcagcagcagcgggggctgcgggcggtcggggct

SEQ ID NO: 25 - DNA, 100 bp, Artificial Sequence
  Synthetic Polynucleotide
cgcagctctccaatcgccgggcggcgcgccccagtctgagcggcgatggcggcggcggcggcggcggcagcagcagcgggggctgcgggcggtcggggct

SEQ ID NO: 26 - DNA, 100 bp, Artificial Sequence
  Synthetic Polynucleotide
agctctccaatcgccgggcggcgggccccagtctgagcggcgatggcggcggcggcggcggcggcagcagcagcgggggctgcgggcggtcggggctccg

SEQ ID NO: 27 - DNA, 100 bp, Artificial Sequence
  Synthetic Polynucleotide
ctctccaatcgccgggcggcgggccccagtctgagcggcgatggcggcggcggcggcggcggcagcagcagcgggggctgcgggcggtcggggctccggg

SEQ ID NO: 28 - DNA, 100 bp, Artificial Sequence
  Synthetic Polynucleotide
atcgccgggcggcgggcctcagtctgagcggcgatggcggcggcggcggcggcggcagcagcagcgggggctgcgggcggtcggggctccgggccggggc

SEQ ID NO: 29 - DNA, 100 bp, Artificial Sequence
  Synthetic Polynucleotide
cgccgggcggcgggccccagtctgagcggcgatggcggcggcggcggcggcgtcagcagcagcgggggctgcgggcggtcggggctccgggccggggcgg

SEQ ID NO: 30 - DNA, 100 bp, Artificial Sequence
  Synthetic Polynucleotide
ccgggcggcggggcccagtctgagcggcgatggcggcggcggcggcggcggcagcagcagcgggggctgcgggcggtcggggctccgggccggggcggcg

SEQ ID NO: 31 - DNA, 100 bp, Artificial Sequence
  Synthetic Polynucleotide
ccgggcggcgggccccagtctgagcggcgatggcggcggcggcggcggcggcagcagcagcgggggctgcgggcggtcggggctccgggcgggggcggcg

SEQ ID NO: 32 - DNA, 100 bp, Artificial Sequence
  Synthetic Polynucleotide
acagtctgagcggcgatggcggcggcggcggcggcggcagcagcagcgggggctgcgggcggtcggggctccgggccggggcggcggcgccatcttgtgc

SEQ ID NO: 33 - DNA, 100 bp, Artificial Sequence
  Synthetic Polynucleotide
agtctgagcggcgatggcggcgtcggcggcggcggcagcagcagcgggggctgcgggcggtcagggctccgggccggggcggcggcgccatcttgtgccc

SEQ ID NO: 34 - DNA, 100 bp, Artificial Sequence
  Synthetic Polynucleotide
gtctgagcggcgatggcggcggcggcggcggcggcagcagcagcgggggctgcgggcggtcggggctccaggccggggcggcggcgccatattgtgcccg

SEQ ID NO: 35 - DNA, 100 bp, Artificial Sequence
  Synthetic Polynucleotide
gcggcgatggcggcggcggcggcggcggcagcagcagcgggggctgcgggcggtcggggctccgggccggggcggcggcgccatcttgtgcccggggccg

SEQ ID NO: 36 - DNA, 100 bp, Artificial Sequence; identical to SEQ ID NO: 35
  Synthetic Polynucleotide

SEQ ID NO: 37 - DNA, 100 bp, Artificial Sequence
  Synthetic Polynucleotide
cggcggcggcggcggcggcggcggcggcagcagcagcgggggctgcgggcggtcggggctccgggccggggcggcggcgccatcttgtgcccggggccgg

SEQ ID NO: 38 - DNA, 100 bp, Artificial Sequence
  Synthetic Polynucleotide
gcggcggcggcggcggcggcggcggcagcagcagcgggggctgcgggcggtcggggctccgggccggggcggcggcgccatcttgtgcccggggccggtg

SEQ ID NO: 39 - DNA, 100 bp, Artificial Sequence
  Synthetic Polynucleotide
gtggcggcggcggcggcggcggcagcagcagcgggggctgcgggcggtcggggctccgggccggggcggcggcgccatcttgtgcccggggccggtgggg

SEQ ID NO: 40 - DNA, 100 bp, Artificial Sequence
  Synthetic Polynucleotide
gcggcggcggcggcggcggcagcagcagcgggggctgcgggcggtcggggctccgggccggggcggcggcgccatcttgtgcctggggccggtggggagg

SEQ ID NO: 41 - DNA, 100 bp, Artificial Sequence
  Synthetic Polynucleotide
gcggcggcggcggctgccgcagcagcagcgggggctgcgggcggtcggggctccgggccggggcggcggcgccatcttgtgcccggggccggtggggagg

SEQ ID NO: 42 - DNA, 100 bp, Artificial Sequence
  Synthetic Polynucleotide
ggcggcggcggcagcagcagcgggggctgcgggcggtcggggctccgggccggggcggcggcgccatcttgtgcccggggccggtggggaggccggggag

SEQ ID NO: 43 - DNA, 100 bp, Artificial Sequence
  Synthetic Polynucleotide
gcggcggcggcagcagcagcgggggctgcgggcggtcggggctccgggccggggcggcggcgccatcttgtgcccggggccggtggggaggccggggagg

SEQ ID NO: 44 - DNA, 100 bp, Artificial Sequence; identical to SEQ ID NO: 17
  Synthetic Polynucleotide

SEQ ID NO: 45 - DNA, 100 bp, Artificial Sequence; identical to SEQ ID NO: 18
  Synthetic Polynucleotide

SEQ ID NO: 46 - DNA, 100 bp, Artificial Sequence; identical to SEQ ID NO: 21
  Synthetic Polynucleotide

SEQ ID NO: 47 - DNA, 100 bp, Artificial Sequence
  Synthetic Polynucleotide
gtcctcggcgtggccggcgcagctctccaatcgccgggcggcgggccccagtctgagcggcgatggcggcggcggcggcggcggcggcggcggcagcagc

SEQ ID NO: 48 - DNA, 100 bp, Artificial Sequence
  Synthetic Polynucleotide
gtcctcggcgtggccggcgcagctctccaatcgccgggcggggggccccagtctgagcggcgatggcggcggcggcggcggcggcggcggcggcagcagc

SEQ ID NO: 49 - DNA, 100 bp, Artificial Sequence; identical to SEQ ID NO: 22
  Synthetic Polynucleotide

SEQ ID NO: 50 - DNA, 100 bp, Artificial Sequence; identical to SEQ ID NO: 23
  Synthetic Polynucleotide

SEQ ID NO: 51 - DNA, 100 bp, Artificial Sequence
  Synthetic Polynucleotide
ccggcgcagctctccaatcgccgggcggcgggccccagtctgagcagcgatggcggcggcggcggcggcggcggcggcggcagcagcagcgggggctgcg

SEQ ID NO: 52 - DNA, 100 bp, Artificial Sequence; identical to SEQ ID NO: 24
  Synthetic Polynucleotide

SEQ ID NO: 53 - DNA, 100 bp, Artificial Sequence; identical to SEQ ID NO: 25
  Synthetic Polynucleotide

SEQ ID NO: 54 - DNA, 100 bp, Artificial Sequence; identical to SEQ ID NO: 26
  Synthetic Polynucleotide

SEQ ID NO: 55 - DNA, 100 bp, Artificial Sequence; identical to SEQ ID NO: 27
  Synthetic Polynucleotide

SEQ ID NO: 56 - DNA, 100 bp, Artificial Sequence
  Synthetic Polynucleotide
atcgccgggcggcgggccccagtctgagcggcgatggcggcggcggcggcggcggcggcggcggcagcagcagcgggggctgcgggcggtcggggctccg

SEQ ID NO: 57 - DNA, 100 bp, Artificial Sequence; identical to SEQ ID NO: 28
  Synthetic Polynucleotide

SEQ ID NO: 58 - DNA, 100 bp, Artificial Sequence; identical to SEQ ID NO: 29
  Synthetic Polynucleotide

SEQ ID NO: 59 - DNA, 100 bp, Artificial Sequence; identical to SEQ ID NO: 30
  Synthetic Polynucleotide

SEQ ID NO: 60 - DNA, 100 bp, Artificial Sequence
  Synthetic Polynucleotide
gggcggcgggccccagtctgagcggcgatggcggcggcggcggcggcggcggcggcggcagcagcagcgggggctgcgggcggtcggggctccgggccgg

SEQ ID NO: 61 - DNA, 100 bp, Artificial Sequence
  Synthetic Polynucleotide
gcggcgggccccagtctgagcggcgatggcggcggcggcggcggcggcggcggcggcagcagcagcgggggctgcgggcagtcggggctccgggccgggg

SEQ ID NO: 62 - DNA, 100 bp, Artificial Sequence
  Synthetic Polynucleotide
gggccccagtctgagcggcgatggcggcggcggcggcggcggcggcggcggcagcagcagcgggggctgcgggcggtcggggctccgggccggggcggcg

SEQ ID NO: 63 - DNA, 100 bp, Artificial Sequence
  Synthetic Polynucleotide
cccagtctgagcggcgatggcggcggcggcggcggcggcggcggcggcagcagcagcgggggctgcgggcggtcggggctccgggccggggcggcggcgc

SEQ ID NO: 64 - DNA, 100 bp, Artificial Sequence; identical to SEQ ID NO: 32
  Synthetic Polynucleotide

SEQ ID NO: 65 - DNA, 100 bp, Artificial Sequence; identical to SEQ ID NO: 33
  Synthetic Polynucleotide

SEQ ID NO: 66 - DNA, 100 bp, Artificial Sequence; identical to SEQ ID NO: 35
  Synthetic Polynucleotide

SEQ ID NO: 67 - DNA, 100 bp, Artificial Sequence; identical to SEQ ID NO: 35
  Synthetic Polynucleotide

SEQ ID NO: 68 - DNA, 100 bp, Artificial Sequence
  Synthetic Polynucleotide
ggcgatggcggcggcggcggcggcggcggcggcggcagcagcagcgggggctgcgggcggtcggggctccgggccggggcggcggcgccatcttgtgccc

SEQ ID NO: 69 - DNA, 100 bp, Artificial Sequence
  Synthetic Polynucleotide
tggcggcggcggcggcggcggcggcggcggcagcagcagcgggggctgcgggcggtcggggctccgggccggggcggcggcgccatcttgtgcccggggc

SEQ ID NO: 70 - DNA, 49 bp, Artificial Sequence
  Synthetic Polynucleotide
cgggatctatctatctatctatctatctatctatctatctatctcccca

SEQ ID NO: 71 - DNA, 45 bp, Artificial Sequence
  Synthetic Polynucleotide
cgggatctatctatctatctatctatctatctatctatctcccca

SEQ ID NO: 72 - DNA, 41 bp, Artificial Sequence
  Synthetic Polynucleotide
cgggatctatctatctatctatctatctatctatctcccca

SEQ ID NO: 73 - DNA, 37 bp, Artificial Sequence
  Synthetic Polynucleotide
cgggatctatctatctatctatctatctatctcccca

SEQ ID NO: 74 - DNA, 33 bp, Artificial Sequence
  Synthetic Polynucleotide
cgggatctatctatctatctatctatctcccca

SEQ ID NO: 75 - DNA, 29 bp, Artificial Sequence
  Synthetic Polynucleotide
cgggatctatctatctatctatctcccca

SEQ ID NO: 76 - DNA, 37 bp, Artificial Sequence
  Synthetic Polynucleotide
cggcggcggcagcagcagcagcagcaggcggcagcct

SEQ ID NO: 77 - DNA, 46 bp, Artificial Sequence
  Synthetic Polynucleotide
cggcggcggcagcagcagcagcagcagcagcagcaggcggcagcct

SEQ ID NO: 78 - DNA, 69 bp, Artificial Sequence
  Synthetic Polynucleotide
aactgactgatctcactagctgcggcggcggtgtgtgtgtgtgtgtggcggcagcctctcgatcggtca

SEQ ID NO: 79 - DNA, 71 bp, Artificial Sequence
  Synthetic Polynucleotide
aactgactgatctcactagctgcggcggcggtgtgtgtgtgtgtgtgtggcggcagcctctcgatcggtca

SEQ ID NO: 80 - DNA, 73 bp, Artificial Sequence
  Synthetic Polynucleotide
aactgactgatctcactagctgcggcggcggtgtgtgtgtgtgtgtgtgtggcggcagcctctcgatcggtca